(19) United States
(12) Patent Application Publication
(10) Pub. No.: US 2018/0278600 A1
(43) Pub. Date: Sep. 27, 2018

(54) MULTI-FACTOR MASKED ACCESS CONTROL SYSTEM

(71) Applicant: REGWEZ, INC., Foster City, CA (US)

(72) Inventor: Ragy Farouk Eleish, San Diego, CA (US)

(21) Appl. No.: 15/952,533

(22) Filed: Apr. 13, 2018

Related U.S. Application Data
(63) Continuation-in-part of application No. 15/410,648, filed on Jan. 19, 2017.
Application No. 15/410,648 is a continuation-in-part of application No. 15/410,654, filed on Jan. 19, 2017.
Application No. 15/410,654 is a continuation-in-part of application No. 15/410,658, filed on Jan. 19, 2017.
Application No. 15/410,658 is a continuation-in-part of application No. 15/410,660, filed on Jan. 19, 2017.
Application No. 15/410,660 is a continuation-in-part of application No. 15/410,666, filed on Jan. 19, 2017.
Application No. 15/410,666 is a continuation-in-part of application No. 15/410,668, filed on Jan. 19, 2017.
Application No. 15/410,668 is a continuation-in-part of application No. 15/410,671, filed on Jan. 19, 2017.
Application No. 15/410,671 is a continuation-in-part of application No. 15/410,675, filed on Jan. 19, 2017.
Application No. 15/410,675 is a continuation-in-part of application No. 15/410,679, filed on Jan. 19, 2017.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.
(60) Provisional application No. 62/280,653, filed on Jan. 19, 2016.
(60) Provisional application No. 62/280,671, filed on Jan. 19, 2016.
(60) Provisional application No. 62/280,674, filed on Jan. 19, 2016.
(60) Provisional application No. 62/280,647, filed on Jan. 19, 2016.

(51) Int. Cl. H04L 29/06

(52) U.S. Cl. CPC H04L 63/083; H04L 2463/082; H04L 63/0861; H04L 63/06

(57) ABSTRACT

A multi-factor authentication system supports a variety of password entry mechanisms (e.g., alphanumeric, visual, voice, etc.) that can be used to authenticate a user to access multiple application/website destinations. Example methods and systems include a real-time password generator that creates unique and complex passwords independent of Internet connectivity for multiple different service providers (e.g., third party applications, cloud services, websites, etc. that include user authentication) without storing the passwords in local or network memory (e.g., a password vault). In response to receiving a login request, a user device prompts the user to provide an access code, and generates a destination key based on a securely stored identifier code. The destination key can be re-generated using the stored identifier code and the access code. The same stored identifier code and the received access code can be used to regenerate different destination keys for different applications or services.

### CROSS-REFERENCE TO RELATED APPLICATIONS

This application is continuation-in-part of non-provisional U.S. patent application Ser. No. 15/410,648, filed on Jan. 19, 2017, U.S. patent application Ser. No. 15/410,654, filed on Jan. 19, 2017, U.S. patent application Ser. No. 15/410,658, filed on Jan. 19, 2017, U.S. patent application Ser. No. 15/410,660, filed on Jan. 19, 2017, U.S. patent application Ser. No. 15/410,666, filed on Jan. 19, 2017, U.S. patent application Ser. No. 15/410,668, filed on Jan. 19, 2017, U.S. patent application Ser. No. 15/410,671, filed on Jan. 19, 2017, U.S. patent application Ser. No. 15/410,675, filed on Jan. 19, 2017, U.S. patent application Ser. No. 15/410,679, filed on Jan. 19, 2017, which all claim priority to provisional U.S. Provisional Patent App. No. 62/280,647, filed on Jan. 19, 2016, U.S. Provisional Patent App. No. 62/280,653, filed on Jan. 19, 2016, U.S. Provisional Patent App. No. 62/280,671, filed on Jan. 19, 2016, U.S. Provisional Patent App. No. 62/280,674, filed on Jan. 19, 2016, all of which are incorporated herein by reference.

### BACKGROUND

### 1. Technical Field

The various embodiments described herein are related to user authentication and more specifically to systems and methods for a visual access code.

### 2. Related Art

Conventional media object indexing techniques are limited. For example, a library of media objects may be organized according to a tree hierarchy (e.g., folders and sub-folders, or albums and sub-albums) where each node corresponds to a separate label. Membership of a media object at a node in the tree (e.g., folder or album) is maintained manually. Thus, reclassifying media objects from one type of classification (e.g., location) to another (e.g., event) requires reclassification of every media object in the library.

Keyword based classifications (e.g., textual tagging) may be better adapted to creating and maintain dynamic albums or folders. However, keyword based classifications technique involve manual input of addition of every possible tag permutation. Thus, a multitude of tags may have to be added for just a single location (e.g., nature, park, tree, grass). Moreover, some tags tend to be ambiguous (e.g., “Paris” could be a city name or a person name).

Classification based on direct attributes (e.g., Apple® iPhoto®) allows a user to create dynamic albums that are based on direct attributes associated to the constituent media object. For example, an album can include all photos from a certain timeframe (e.g., from Apr. 11, 2013 to May 5, 2014). However, direct attribute systems offer poor user interface (UI) and impose significant limitations on searches conducted based on direct attributes.

Limited semantic tagging (e.g., Facebook® tagging) provides dynamic classification of media objects based on a limited set of indirect attributes. Specifically, tags do not distinguish between different types of relationships that may exist with respect to the media object. For example, a person who was tagged in a photo can appear in the photo, have an interest in the content of the photo, or is a creator of the photo.

Fully-automated media object indexing techniques are generally inaccurate. For example, image recognition systems have only a 70% success rate at identifying even a generic object (e.g., a shoe) depicted in a media object. These systems further are not able to determine relationships with respect to the media object (e.g., an owner, designer, and/or retailer for the shoe). By contrast, manual methods to index media objects tend to be tedious and error prone while offering little user incentive.

What is needed are systems and methods for indexing media objects that can supports advanced searching and browsing capabilities.

### SUMMARY

Systems and methods for authentication using visual access code are provided. According to various embodiments, a system for registering and authenticating a user is based on a visual access code. The method includes presenting, to the user, images, receiving a selection of a first image, receiving a selection of at least a first set of hotspots from a plurality of hotspots included in the first image; and generating a visual access code based at least in part on the selection of the first image and the first set of hotspots.

Other features and advantages of the present inventive concept should be apparent from the following description which illustrates by way of example aspects of the present inventive concept.

### BRIEF DESCRIPTION OF THE DRAWINGS

The above and other aspects and features of the present inventive concept will be more apparent by describing example embodiments with reference to the accompanying drawings, in which:

FIG. 1 is a network diagram illustrating a network environment various embodiments;

FIG. 2 illustrates semantic indexing according to various embodiments;

FIG. 3 illustrates a stamping user interface according to various embodiments;

FIG. 4 is a flowchart illustrating a process for stamping according to various embodiments;

FIG. 5 illustrates a process for adding an association to a stamp according to various embodiments;

FIG. 6 illustrates an object selector according to various embodiments;

FIG. 7A illustrates an association selector according to various embodiments;

FIG. 7B illustrates single and multiple association selection according to various embodiments;

FIG. 8 illustrates a visual interface according to various embodiments;

FIG. 9 illustrates a visual browsing menu according to various embodiments;

FIG. 10 illustrates selection criteria according to various embodiments;

FIG. 11 illustrates a process for adding a new search selector according to various embodiments;

FIG. 12 illustrates a facet navigation interface according to various embodiments;

FIG. 13 illustrates a facet display section according to various embodiments;

FIG. 14 illustrates facet representations according to various embodiments;

FIG. 15 illustrates a limited discrete index according to various embodiments;

FIG. 16 illustrates a simple derived index according to various embodiments;

FIG. 17 illustrates a fuzzy derived index according to various embodiments;

FIG. 18 illustrates a multi-mode control switch according to various embodiments;

FIGS. 19A-C illustrate a multi-mode UI according to various embodiments;

FIG. 20 illustrates data access computation according to various embodiments;

FIG. 21 illustrates a process for enforcing access control according to various embodiments;

FIG. 22 illustrates an automatic change to access control rule status according to various embodiments;

FIG. 23 illustrates a manual change to access control rule status according to various embodiments;

FIG. 24 illustrates central server based synchronization according to various embodiments;

FIG. 25 illustrates peer-to-peer synchronization according to various embodiments;

FIG. 26 illustrates hierarchical synchronization according to various embodiments;

FIG. 27 illustrates access control rule cascade according to various embodiments;

FIG. 28 illustrates a peer-to-peer browsing session according to various embodiments;

FIG. 29 illustrates a process for initiating a peer-to-peer browsing session according to various embodiments;

FIG. 30 illustrates a process for configuring a visual access code according to various embodiments;

FIG. 31 illustrates an example lock code management interface for use with visual access codes;

FIG. 32 illustrate an example flow for configuring visual access codes according to an exemplary embodiment;

FIG. 33 illustrates an example process for mapping a user identifier to photo selection mapping according to various embodiments;

FIG. 34 illustrates an example unique user hex digest, according to various embodiments;

FIG. 35 illustrates an example registration process for assigning a visual access code according to an example embodiment;

FIG. 36 illustrates an example process for encoding a visual access code with a password according to an example embodiment;

FIG. 37 illustrates an example mobile interface in accordance with various embodiments;

FIG. 38 illustrates an example implementation of entering a visual access code according to an example embodiment;

FIGS. 39A-C illustrate an example implementations of the virtual input method on a website according to various embodiments;

FIG. 40 illustrates an image blending process in accordance with various embodiments;

FIG. 41 illustrates an example implementation of hotspot position shifting in accordance with various embodiments;

FIG. 42 is a block diagram illustrating wired or wireless system according to various embodiments;

FIG. 43 illustrates example identity establishment process in accordance with various embodiments;

FIG. 44 illustrates example default key generator process in accordance with various embodiments;

FIG. 45 illustrates example ghostPassword keyboard interface in accordance with various embodiments;

FIG. 46 illustrates example username entry process in accordance with various embodiments;

FIG. 47 illustrates example defining moments interface in accordance with various embodiments;

FIG. 48 illustrates example browser ghostPassword entry process in accordance with various embodiments;

FIG. 49 illustrates example ghostPassword administration process in accordance with various embodiments;

FIG. 50 illustrates example flow of the ghostPassword elements in accordance with various embodiments.

### DETAILED DESCRIPTION

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

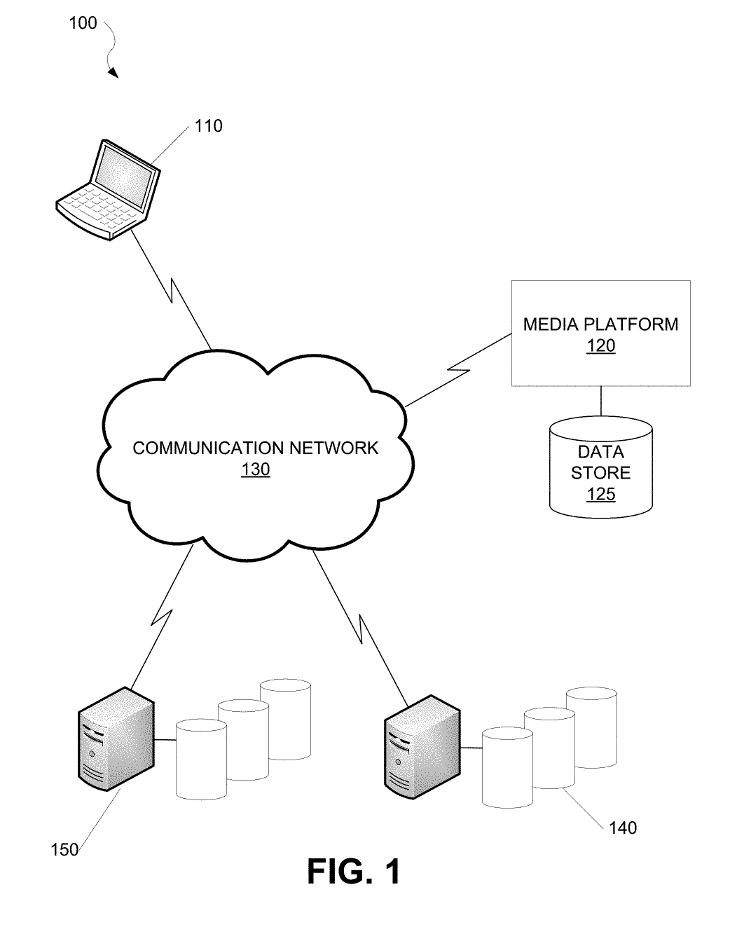

FIG. 1 is a network diagram illustrating a network environment 100 according to various embodiments. Referring to FIG. 1, a user device 110 communicates with a media platform 120. The user device 110 may be any device that is capable of communication with or causing communication with the media platform 120 through a wired or a wireless connection. For example, the user device 110 may be a wired or wireless communication device including, for example, but not limited to, a smartphone, a wearable device, a tablet personal computer (PC), a laptop, a desktop PC, a personal entertainment system, and an embedded processing system.

The user device 110 may communicate with the media platform 120 via a communication network 130. In various embodiments, the communication network 130 represents one or more wired and/or wireless connections. For example, the communication network 130 may include, for example, but not limited to, a wired and/or wireless local area network (LAN), a wired and/or wireless wide area network (WAN), and any combinations thereof.

The media platform 120 may be communicatively coupled with a local data store 125. In addition, the media platform 120 may further communicate with a plurality of remote and/or third party data sources including, for example, but not limited to, a first data source 140 and a second data source 150.

Association Model

Semantic Indexing

In various embodiments, the media platform 120 can associate a media object with semantic information that includes, for example, but not limited to, attributes, relationships, and classifications. The semantic information can be inherited from one or more other objects (i.e., including other media objects) that each provides an individual set of attributes, relationships, and/or classifications.

For example one media object (e.g., a photo) can depict a smiling Bill Gates. The media object can inherit all attributes of Bill Gates as a person and the relationships Bill Gates has with other people (e.g., age, an entrepreneur, an influencer, a billionaire, a philanthropist, a father, a family man, a techie, an American, etc.). Smiling implies that Bill Gates appeared in the photo and was in a good mood.

John Smith may be interested in the contents of the media object (e.g., the photo) depicting Bill Gates. Thus, the media object can further inherit all attributes of John Smith as a person and the relationships John Smith has with other people although John Smith is not depicted in the photo.

As another example, a media object (e.g., a video) can depict a vehicle belonging to Alice after an accident. The media object can inherit all attributes of Alice's car (e.g., make, model, year, mileage, and maintenance records), which can be determined via a third party source (e.g., Carfax®). The media object can further inherit all attributes about Alice including, for example, but not limited to, Alice's driving records, professional activities, and biographic information. In addition, the media object can also inherit all attributes about the particular accident (e.g., classification as a minor or a major accident).

In various embodiments, the media platform 120 can allow the media object to be searched via any of corresponding semantic information. For example, the media object depicting Bill Gates may be found through a search for photos of 50-year old men who are smiling. Similarly, the video of Alice's car accident may be found through a search for videos of cars owned by women that are involved in accidents.

It is to be understood that the media object may be any kind of computer stored file including, for example, but not limited to, a text and a multimedia (e.g., photograph, video) file.

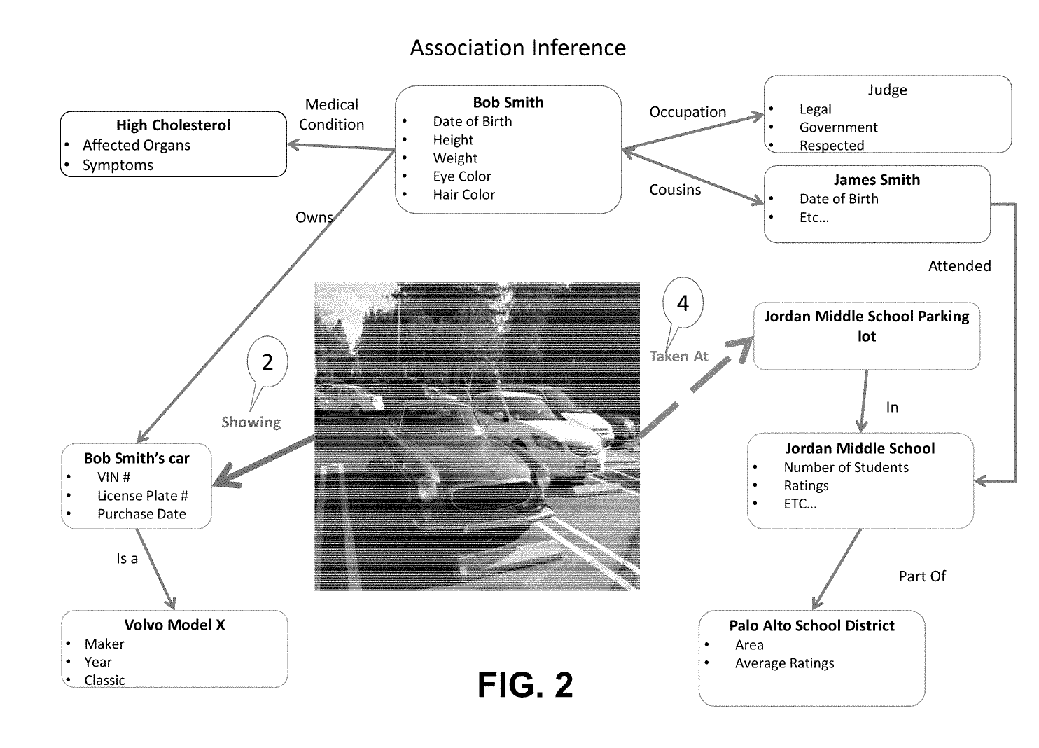

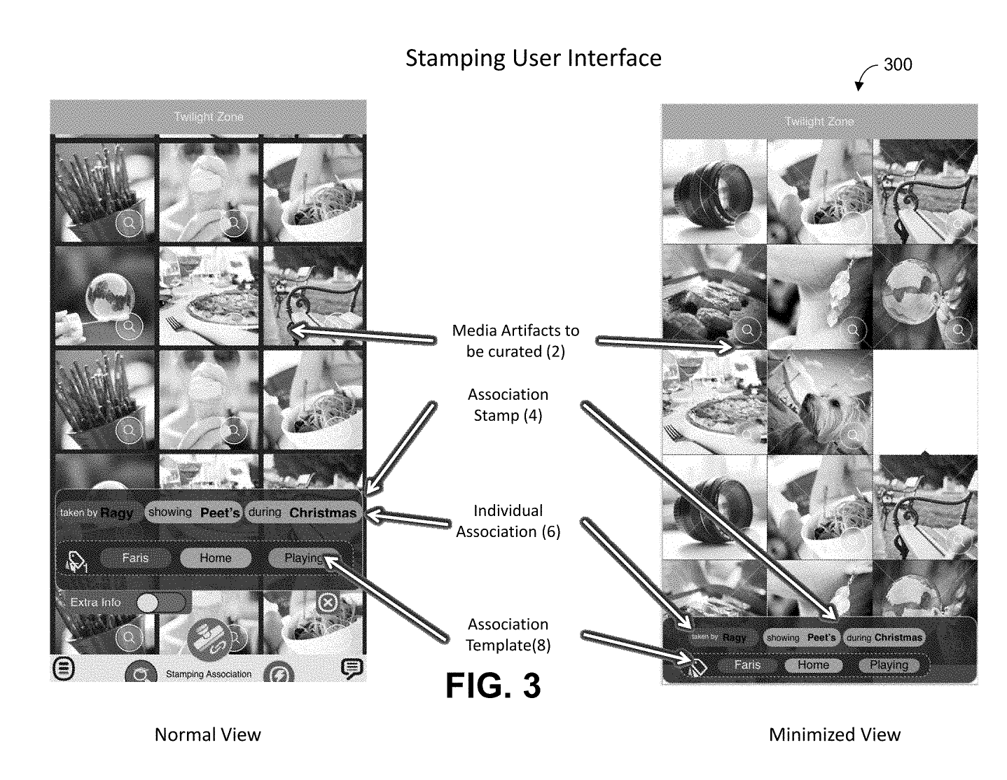

FIG. 2 illustrates semantic indexing according to various embodiments. Referring to FIG. 2, a media object (e.g., a photo of a vehicle) can be associated with a plurality of semantic information including, for example, but not limited to, a manual association 2 and an automatic association 4. In various embodiments, the media platform 120 can generate and add the automatic association 2 based on geolocation information included in the media object's meta-data. Based on the manual association 2 and the automatic association 4, the media object can inherit a plurality of other relationships including, for example, but not limited to, ownership (e.g., Bob Smith) and location (e.g., Jordan Middle School parking lot).

Automatic Association Model

In various embodiments, automatic associations can be added to a media object. For example, automatic associations can be generated based on a geolocation and/or timestamp. Automatic associations can also be generated and added to the media object based on current events (e.g., fairs, holidays, private birthdays, etc.) and weather (e.g., rain, snow, storm). In some embodiments, if the certainty of the automatic association is below a certain threshold, the automatic associations can be presented to a user for confirmation.

Augmented Semantic Information

In various embodiments, the media platform 120 can add new semantic information to a media object, which allows the media object to be searched based on the new semantic information. For example, if Bob Smith retires, then the media object depicting Bob Smith's vehicle is searchable as “photos of cars owned by retired people.”

A media object can further be searchable based on new semantic information that has been added to objects having existing associations with the media object. For example, if Bob Smith's son Charlie Smith is added as an object and Charlie Smith is a student at Jordan Middle School, then the media object depicting Bob Smith's vehicle is also searchable as “photos of cars owned by a student's parents.”

A system for semantic indexing includes a media platform. In various embodiments, the media platform may comprise one or more hardware processors configured to: receive a first media object associated with a first set of semantic information; and associate the first media object with a second media object associated with a second set of semantic information.

According to an example implementation, the first media object inherits the second set of semantic information associated with the second media object. The first set and second set of semantic information can each includes at least one of attributes, relationships, and classifications. The one or more hardware processors can be configured to automatically generate additional semantic information and associate the automatically generated semantic information with the first media object. The one or more hardware processors can be configured to automatically generate the additional semantic information based at least in part one or more of a geolocation and a timestamp associated with the first media object.

According to another example implementation, the one or more hardware processors are configured to receive additional semantic information from a user and associate the additional semantic received from the user with the first media object. For example, the user can provide the additional semantic information at least in part by indicating an association between the first media object and a third media object associated with a third set of semantic information. In another example, the user provides the additional semantic information at least in part by indicating an association between the first media object and one or more of an attribute, relationship, and classification.

Human-Centric Association Interface

In various embodiments, the media platform 120 presents a user interface (UI) that allows the user to quickly attach semantic information to a media object.

Stamping User Interface

The media platform 120 allows the user to assign semantic information to media content using the stamping UI 300. In various embodiments, the stamping UI 300 allows the user assign semantic information to multiple media object using a single click. The stamping UI 300 provides a stamp area 4 displaying the categories, sources, or values of semantic information to be added. In one example implementation, the user clicks on a target media object from a list 2, the stamp are 4 recommends a list of semantic information based on analysis of the target media object. Analysis of the target media object can include object recognition, metadata analysis, as well as, inspecting semantic information of other media items associated with the target media item. The user has the option to edit the recommended list of semantic information in the stamp area 4 or can accept an entire set of recommendations. For example, a single click by the user can stamp the target media object with the set of semantic information shown in the stamp area 4.

The stamp area 4 can include individual associations 6, which may be added independent of other associations. The stamp area 4 can further include association templates 8. A stamp association template 8 can include a group of semantic categories configured based on commonly used associations. Selecting a stamp association template 8 assigns a set of semantic information for each of the categories in the template. For example, a home stamp associate template can associate the target media object with other media objects associated with home, add semantic information for the geographic location of the home, add relationships to people that are also part of the home category, etc. The stamp association template 8 can be pre-configured for repeated use for commonly used associations.

According to an example embodiment, a system for semantic indexing can include a media platform with one or more processing device configured to: index media objects of the media platform to identify semantic information of each media object; and associate a plurality of media objects based on matching semantic information. In an example, the processing device searches the index of media objects for semantic information in common with the stamp template and based on the search, the processing device sorts the corresponding media objects based on common semantic information; and present the sorted media objects for curation by a user. In some embodiments, the processing device generates a stamp template of the association comprising the common semantic information for applying the association to one or more media object. For example, curation can include applying the stamp template or one or more other associations. The stamp template can be editable to modify semantic information of the association and include multiple associations. In some embodiments, the system includes an interface with stamp templates that allow a user to curate media objects of the media platform by applying an association from a selected stamp template to multiple media objects based on a single selection. In an example, the processing device receives additional semantic information from user input to associate with one or more media object.

Stamping Workflow

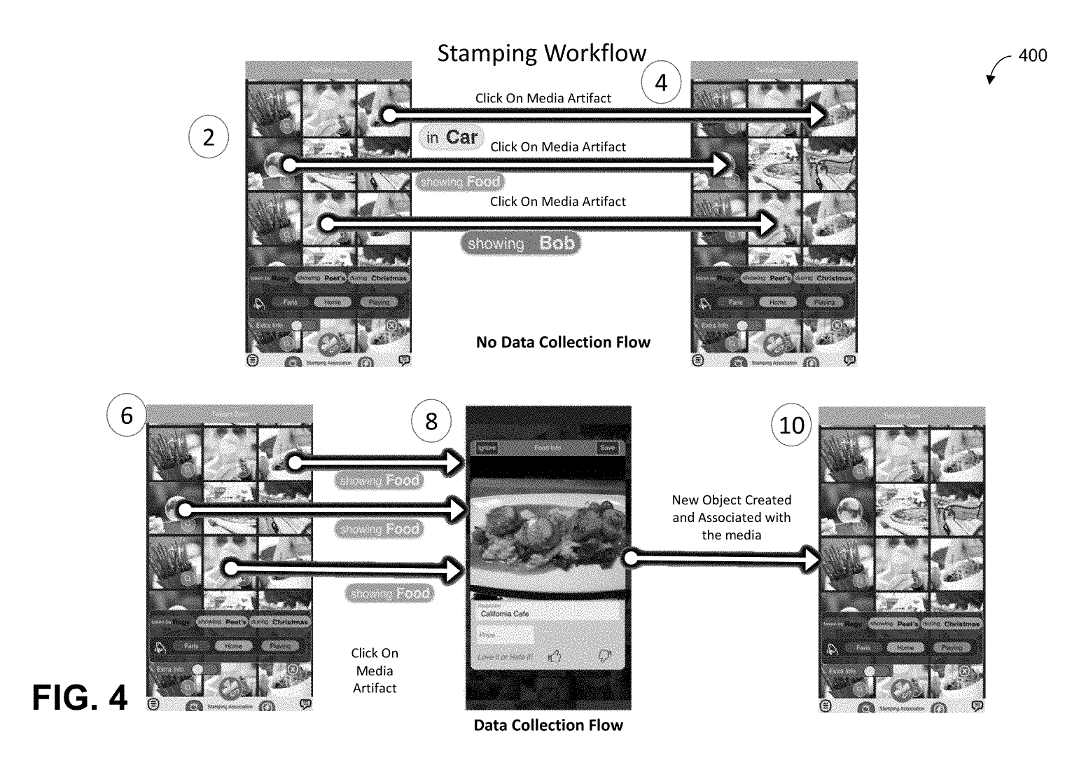

FIG. 4 is a flowchart illustrating a process 400 for stamping according to various embodiments. Referring to FIG. 4, in various embodiments, the process 400 can be performed by the media platform 120.

In various embodiments, the process 400 is performed when a data collection mode is selected. As such, the media platform 120 can collect additional information for at least some specific associations in a stamp. That is, objects with common semantic information are identified and the common semantic information can be grouped as an association. The groupings of common semantic information can form a template. When a grouping of semantic information is attached via the stamping action and an actual media object is defined in the system. An association can also form a relationship between objects with common semantic information that allows modifications to propagate.

For example, when the user clicks on a media object shown in a screen display 6, a screen display 8 appears in response to determining that the stamp includes a food item association. In the screen display 8, the UI allows for collecting information about the food. The screen display 8 is object template type specific. After the user activates a save feature, a new object is created (or stored) and the association is assigned to that object.

Alternately, if the data collection mode is not selected, the user can click on a media object and other objects in the stamp area 4 are assocaited with the media object.

In various embodiments, the two workflows are part of an overload approach of the media platform 120. The media platform 120 can collect information incrementally as specified by the user. Advantageously, the user is incentivized to expend effort to input extra information because of an enhanced ability to search based on that information using a visual search.

Association Selection Interface

In various embodiments, the user may identify content of a media object, associate the semantic information with the media object, and select a type of the association. Once the user associates content of another media object with the target media object, the target media objects inherits the other associations of the contents of the other media object. Advantageously, the user can efficiently identify and associate content with media object with high accuracy. FIG. 4 illustrates a flowchart for an example data collection process for associating world objects with media content.

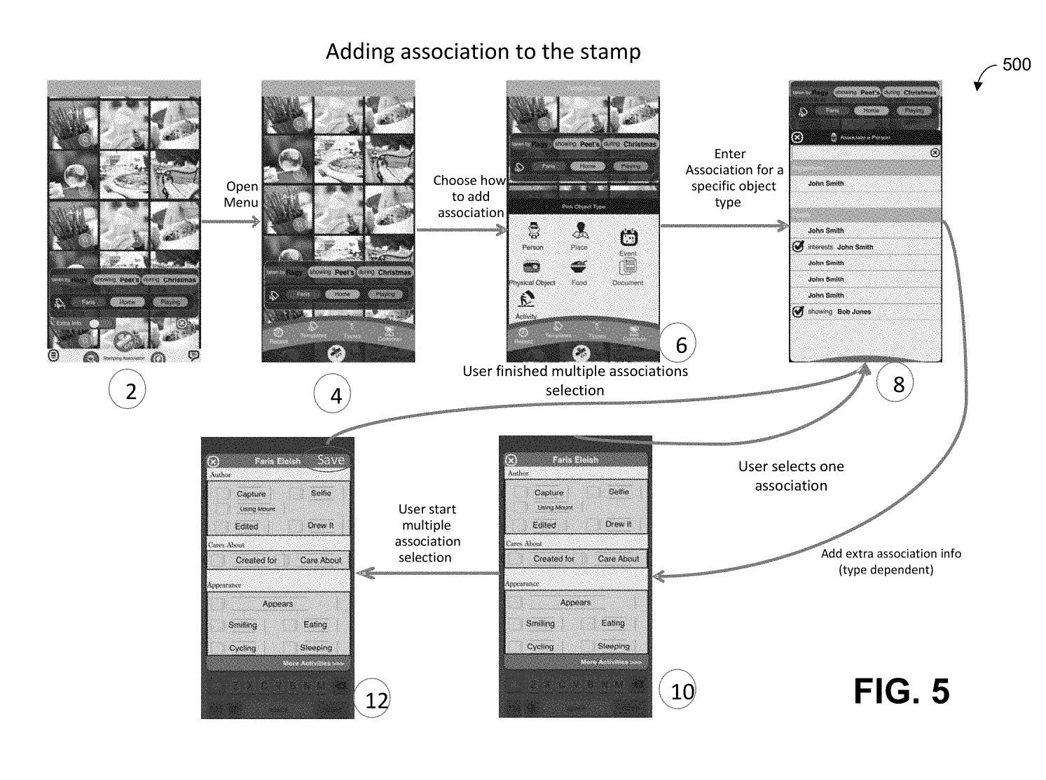

FIG. 5 illustrates a process 500 for adding an association to a stamp according to various embodiments. Referring to FIG. 5, the process 500 may be performed by the media platform 120. In a screen display 2, the user can examine media objects to be curated. From the stamp view, the user can see the associations to be added. At the stamp view, the user can stamp the media object by selecting (e.g., clicking, touching, etc.) a photo and all the associations in the stamp will be added to the photo. Alternately, the user can select to add new associations to the stamp.

In response to the user clicking on a stamping mode button, the process advances to a present a screen display 4 where the menu allows the user to select from different processes to add new associations. For example, in some embodiments, the user can add a new association by selecting object types via the screen display 6. When the user selects an object type, the UI switches to screen display 8 (i.e., an object selection screen) that presents a searchable list of possible objects based on the selected object type. The user can search for an object to add. In some embodiments, the screen display 8 includes the stamp icon to provide for easy navigation.

Upon selecting a specific object, an association selection screen display 10 is presented to allow the user to further select an association for the object. The user has the option to can cancel and return without completing the association operation. Alternately, the user can select one or more associations on an association selection screen display 10 to complete the stamping operation. Subsequently or alternatively to the association selection screen 10, the UI provides additional confirmation controls (e.g., save, cancel, etc.) to complete the association, such as depicted on a screen display 12.

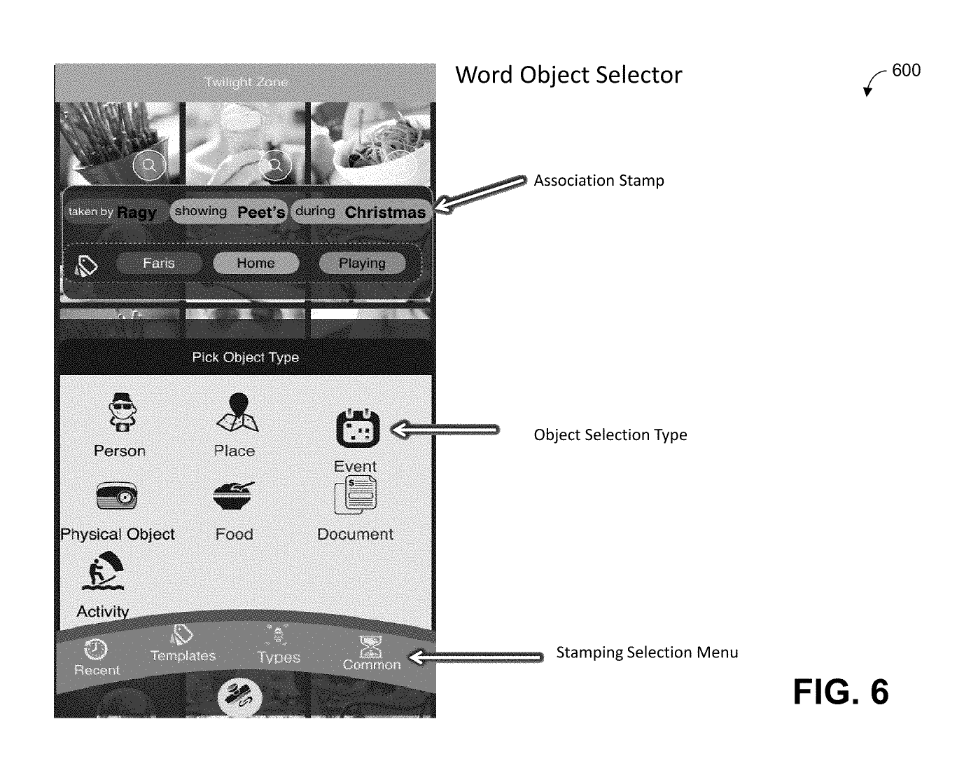

FIG. 6 illustrates an object selector 600 according to various embodiments. The user can select the object type and start a search for various objects to associate. The UI 600 displays the association stamp that displays existing stamps to communicate to the users the objects are already loaded into the stamp.

Association Selection

When the user clicks the menu button to start the association editing mode, the user can select to add the association to the stamp in multiple ways. For example, the user can select from a list of recent associations. In another example, the user can select from a previously configured association template. Each template is a group of associations input by the user. For example, a template can include “baby Jim playing”, “Project X”, or “expense receipts for project Y.” In some embodiments, the media platform 120 allows the user to define and edit a fixed number of templates. Having a limited number of configurable templates allows the user to easily access preconfigured templates without a template management system.

Alternately, the user can select a world object type that allows the user to browse object types to select an association. Additionally, the user can select from common associations, such as general associations configured by an application author. For example, an application that employs thumbnails may use a temporary photo association.

Association Picker Flow

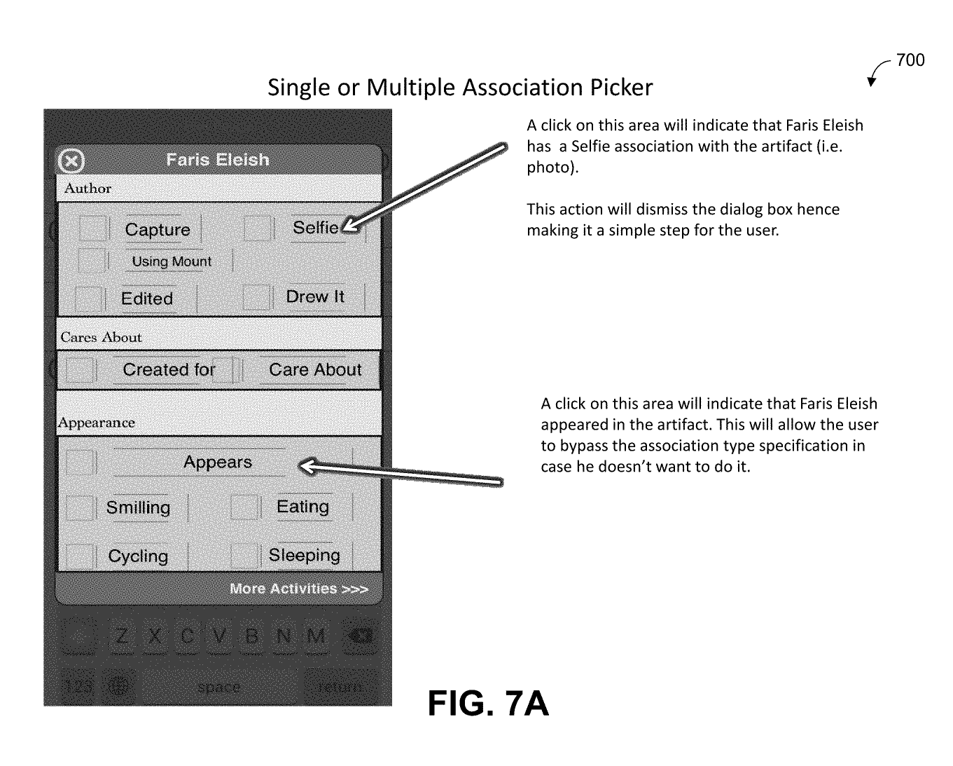

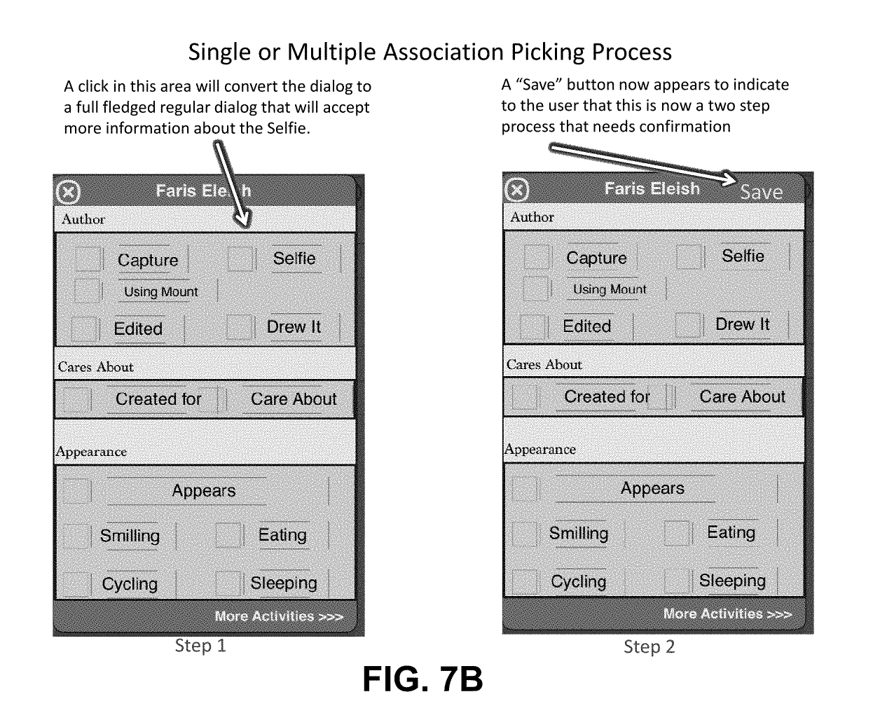

To streamline the association type selection between the world object and a media object, the media platform 120 provides an optimized association selector that allows the user to pick one or more associations. FIG. 7A illustrates an association selector 700 according to an example embodiment.

For example, to select one association, the user can click on the association button or checkbox (e.g., selection), which completes the association selection. To select multiple associations, the user can click the checkbox (e.g., selection) and the association dialog box performs as a multiple selection dialog box. FIG. 7B illustrates single and multiple association selection according to an example embodiment.

Association Search

The media platform 120 enables the user add associations incrementally. Moreover, the media platform 120 allows the user to quickly group the artifacts with common parameters together for faster association. In various embodiments, the media platform 120 links the association process with the search process via the multi-mode user interface. Using the multi-mode user interface, the user can quickly switch between association and search and vice-versa. This quick switching allows the following scenarios:

While the user is adding association, the user can switch to search mode to limit or filter the number of available media objects. As such, the user searches on the already added semantic information or on simple attributes such as timestamp.

While the user is searching, the user may determine that some semantic information is missing. Then the user can quickly switch to the stamping mode via the first level menu and start adding more associations to the media object.

The interface enables the user to add as much information as desired in an incremental fashion, which reduces the perceived amount of work and effort. Moreover, the user can immediately appreciate the benefits of the newly added information because the UI allows the user to start searching using the new added semantic information.

Hierarchical Visual Faceted Search

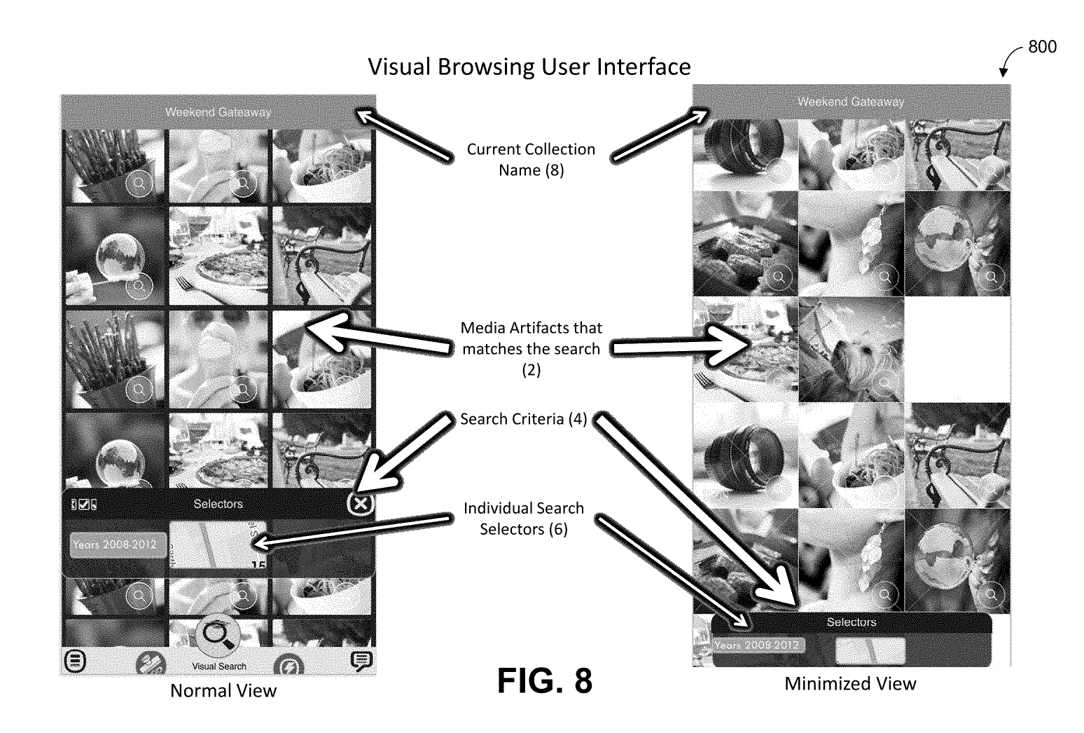

In various embodiments, the media platform 120 provides a visual interface that allows the user to quickly glance at the criteria the presented media meet. The selection criteria can be displayed in a specific area. In addition, the interface can have a normal mode and a minimized mode to provide more space to the user. FIG. 8 illustrates a visual interface 800 according to various embodiments. In minimized mode, the user is in a read-only mode and cannot interact with various selectors.

In various embodiments, presenting the query as a group of selectors simplify the concept to the end users. Furthermore, the position of the selectors relative to each other is important and the user is able to reorder them.

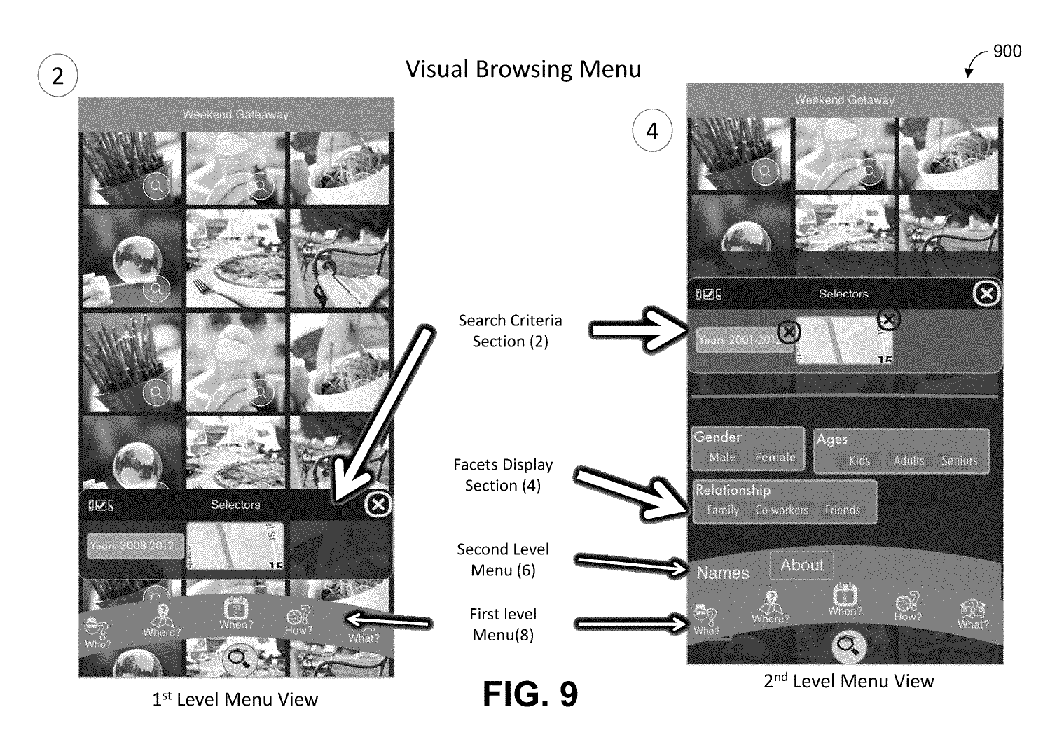

FIG. 9 illustrates a visual browsing menu 900 according to various embodiments. Referring to FIG. 9, in various embodiments, when the user clicks the central menu button in the normal mode, the media platform 120 presents a first level menu view 2. This menu enables the user to browse the two level hierarchical facets classification. A single click on the menu button presents the first level facet categories, which allows the user to navigate to a second level menu view 4. In the second level menu view 4, the user is provided with information about various media objects. The user can determine whether multiple media objects from multiple years (e.g., 2008, 2010 and 2012 but not 2011) are present and filter to see the media objects from the month of March through August. In parallel, the interface displays the selectors used to pick the data.

Selector

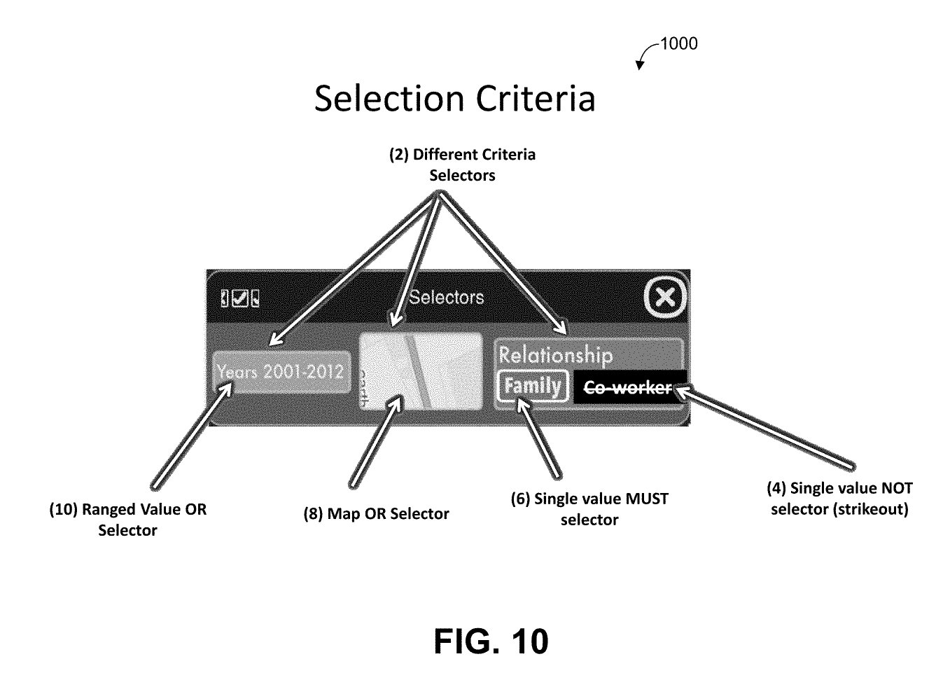

FIG. 10 illustrates selection criteria 1000 according to various embodiments. Referring to FIG. 10, the selection criteria 1000 can be built by a user. As shown in FIG. 10, there can be multiple selectors 2 for each facet. The selectors 2 can specify what facets values are used for searching. The selection criteria 1000 can include a NOT criterion 4 and a MUST criterion 6, both of which can be single value selectors. The selection criteria 1000 can further include a map location criterion 8 and a value range criterion 10, both of which can be an OR criterion (i.e., at least one of the map location criterion 8 and the value range criterion 10 has to be true). Advantageously, the user can glance quickly and understand the criteria that is being used for the search.

Adding New Search Selector

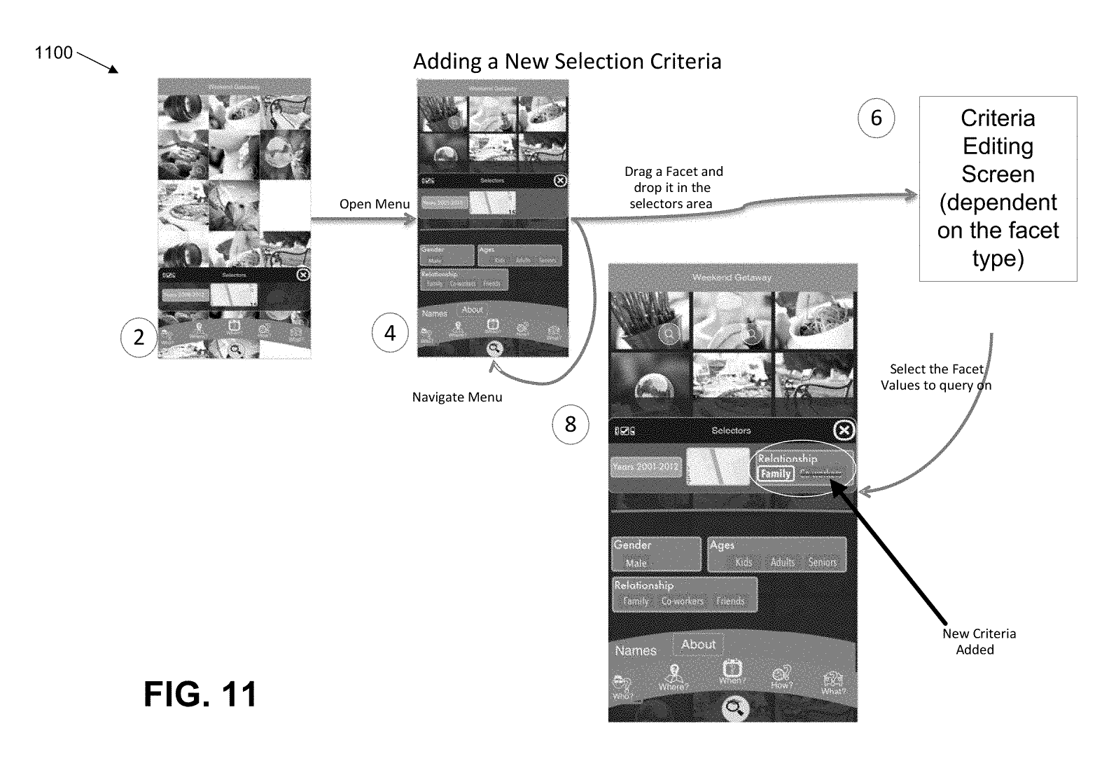

FIG. 11 illustrates a process 1100 for adding a new search selector according to various embodiments. Referring to FIG. 11, the user clicks an open menu 2, which leads the user to facets browsing mode 4. When the use decides to search using a specific facet, the user can drag that facet to the selector area. The dragging action is important because it allows the user to position the selector relative to the already existing ones. Once the selector is dragged and dropped, a dialog box 6 is displayed to allow the user to edit the selections in more details. The dialog box 6 may show an UI that differs from one facet type to another. The purpose of displaying a large interface is to give the computer application designer more space to display various options to the user. Furthermore, the large interface saves the user the frustration of having to deal with small spaces. In the dialog box 6, the user can specify AND, OR and MUST criteria to different facet values or range of values. Once the user clicks accept, the newly added selectors are presented in screen display 8.

Facet Navigation

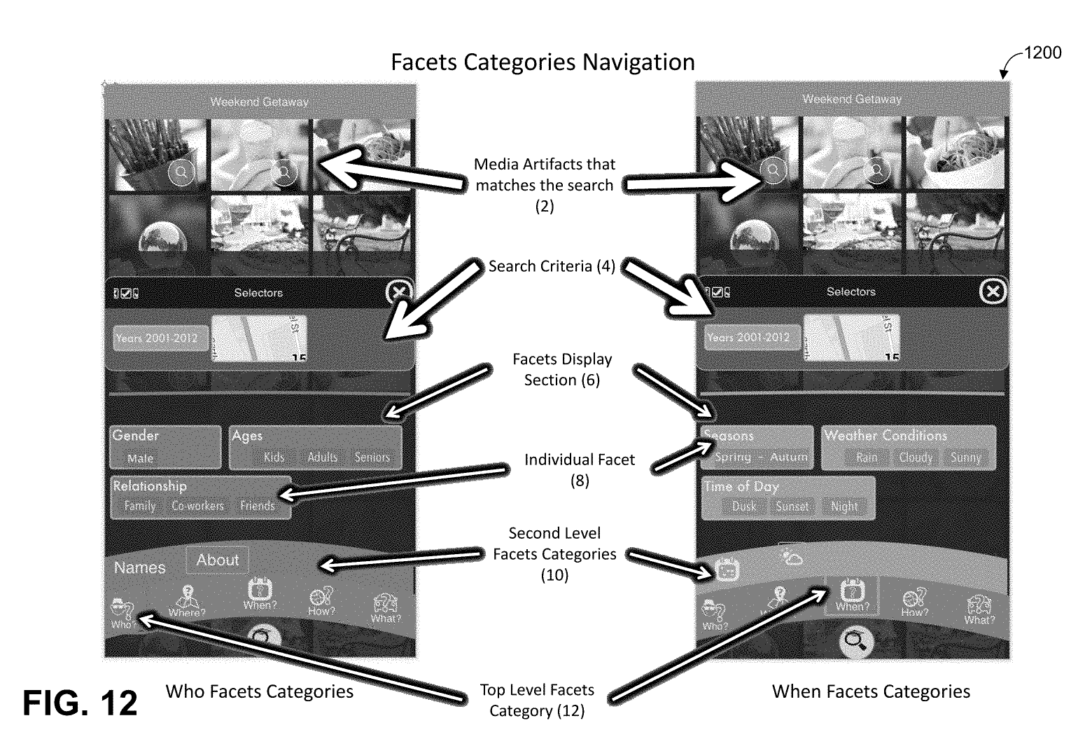

FIG. 12 illustrates a facet navigation interface 1200 according to various embodiments.

The user can navigate between facets by selecting one of first level facet categories. For example, the first level of facet categories can be divided into several (e.g., 5) main groups. The groups are specific to media objects to be searched on, e.g., who, what, when, where, and how. When the user clicks on one of the first level facet categories, the second level facet categories can be displayed to simplify the user's search. For example, under the “when” first level facet category, there can be multiple second level facet categories including, for example, but not limited to, specific dates, weather conditions, event types, and event names. In one exemplary embodiment, each top level category has a different color to highlight and help identify the category.

When the user clicks on a second level facets category, the interface displays the available facets and the facet values that exist in the user's media objects. In some embodiments, a second level facets category can include a single facet with unlimited values. Advantageously, the facet navigation interface provides a way to quickly glance at the media objects' meta-data. The facet navigation interface allows the user to explore the media collection based on the meta-information driven by curiosity. The user can be further encouraged to identify missing meta-information (e.g., the user can switch to the stamping mode and add the missing information). Moreover, the facet navigation interface provides a unified interface for the user to start requesting media that is not available in the media library. For instance, if a user discovers that the media library is missing a certain media object (e.g., a photo from the user's cousin's birthday last year), the user can use that interface to initiate a request for the missing media object.

Facet Display Section

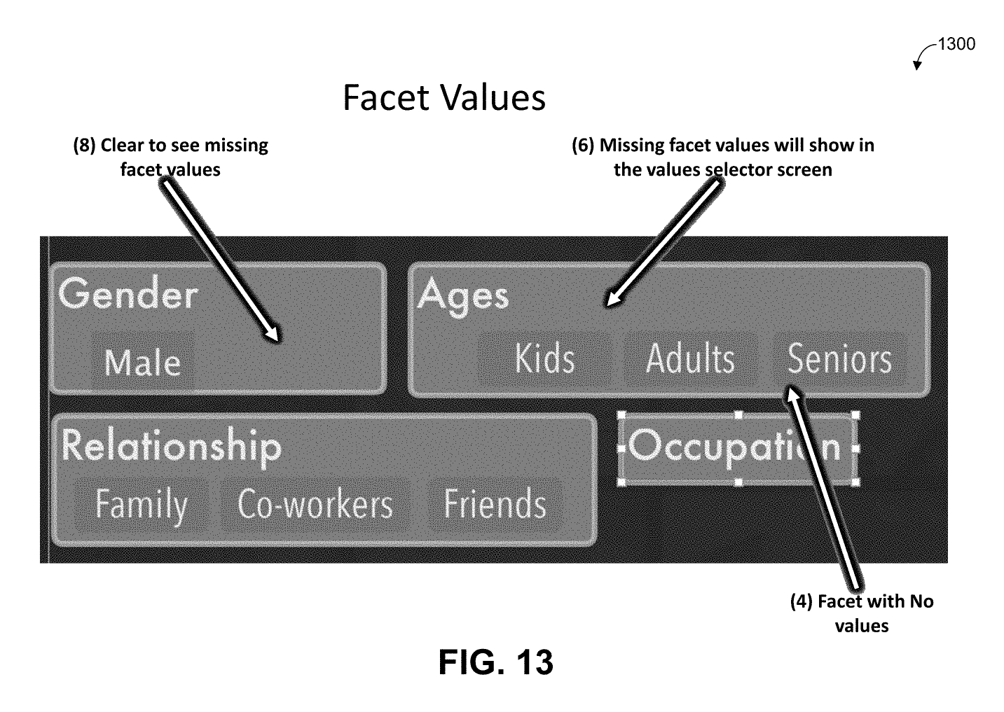

FIG. 13 illustrates a facet display section 1300 according to various embodiments. Referring to FIG. 13, the facet display section 1300 displays the facets in a particular facet category whether or not the facets have corresponding values. By showing facets having absent values, the user can become aware of what is missing about the collection of media objects the user is currently viewing. For example, the user can observes from the facet display section 1300 that neither the occupation facet nor the gender facet has been provided any values.

The system may display the facets in response to determining that there are no values associated with the facets. Presenting facets with empty values or no search hits communicates to the user that a background search has determined that the facet is not useful on the data set. Empty facets may also communicate to the user that semantic data is missing from one or more data objects or the data object is unavailable. Then the user can locate the media object to add missing the meta-data or acquire an unavailable media object.

Facet Representation

In various embodiments, the media platform 120 displays facets to the user in different ways based on a type associated with the facet's values. Advantageously, displays facets based on a type associated with the facet's values improves communication to the user regarding the available types of data.

Discrete values are individual values. There are two types of discreet values: limited discreet values and unlimited discreet values. Limited discrete values (e.g., gender) are values having a limited number of possible values. Facets having limited discrete values are part of a second level facet category. By contrast, unlimited discrete values (e.g., humans, events) are displayed as an individual second level facet category.

Range values are values that can be grouped into a range. Some range values are a continuous range which includes an unlimited number of possible values (e.g., timestamp). Continuous range values are always displayed in a range or group of ranges. By contrast, an integer range is made up of discrete values (e.g., days of the week). Integer ranges can be displayed as groupings of discreet values. Map values can be displayed in a special map presentation where the map values are special values.

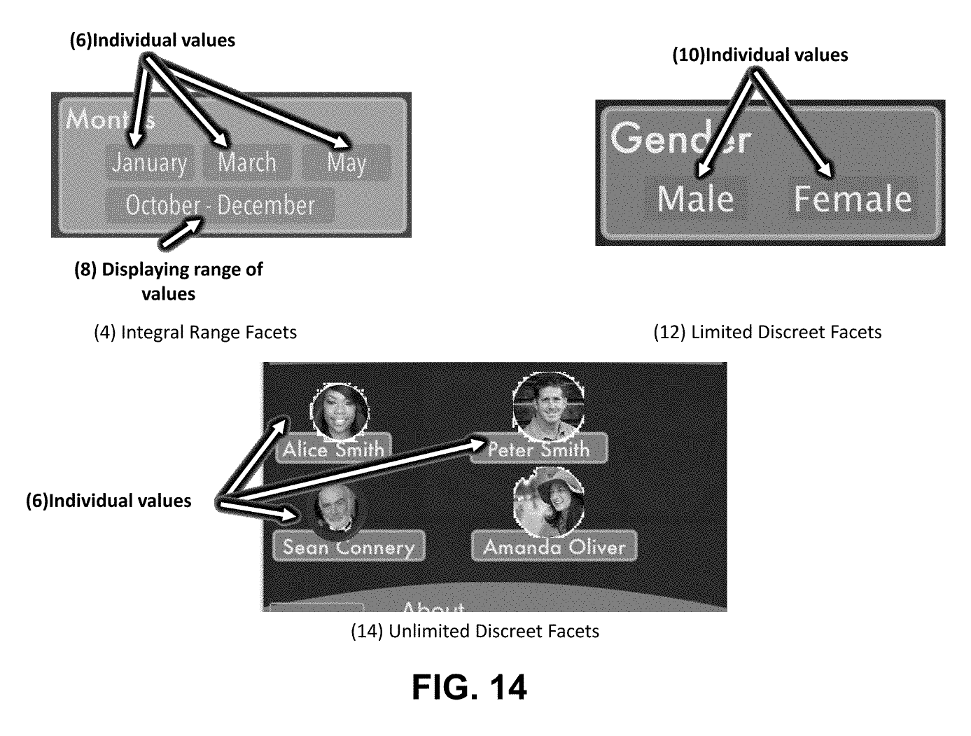

FIG. 14 illustrates facet representations according to various embodiments. As shown in FIG. 14, facet representations can include representation of limited discreet facets 12, integer range facets 4, and unlimited discreet facets 14. The unlimited discreet facet 14 can require an entire subcategory to display where other facet representations (e.g., the limited discreet facets 12 and the integer range facets 4) can be grouped together.

Hierarchical Facets for Media Content

In various embodiments, facets can be organized into a two level hierarchy. The hierarchy is stored into a data structure (e.g., tree). Each leaf node of the tree can point to an individual facet value's index. As such, the media platform 120 can handle different facet hierarchies based on the user. For example, the facet hierarchies may be established based on the user level of expertise or interests.

For example, a hierarchy can include:

1) Who?

a. Name

b. Relationship

c. Interests

d. Profession

2) When?

a. Dates

b. Events

c. Event Types

d. Weather Conditions

3) Where?

a. Place Name

b. Map

c. Place Type

4) How?

a. Photographer

b. Camera Type

c. Media Type

5) What?

a. Objects

b. Types of Objects

Appendix B further illustrates the hierarchical faceted search engine according to various embodiments.

According to various embodiments, a system for performing a hierarchical visual faceted search for one or more media objects includes a media platform. In various embodiments, the media platform may comprise one or more hardware processors configured to: provide, to a user device, a selector user interface (UI) adapted to receive a plurality of selection criteria; provide, to the user device, a first level menu comprising a plurality of first level selection criteria that includes a first selection criterion; receive, from the user device, an indication to add at least the first selection criterion to the selector UI; provide, to the user device, a second level menu comprising a plurality of second level selection criteria corresponding to the first selection criterion, wherein the plurality of second level selection criteria includes a second selection criterion; receive, from the user device, an indication to add at least the second selection criterion to the selector UI; add the first selection criterion and the second selection criterion to the selector UI; and execute a search to identify one or more media objects satisfying the first selection criterion and the second selection criterion based at least in part on a content of the selector UI.

In example implementations, the first selection criterion can include an identity criterion, a location criterion, and the second selection criterion can include one of a name, relationship, interest, and profession of an individual associated with a media object. For example, the first selection criterion can include a time criterion and the second selection criterion comprises one of a date, event, event type, and weather conditions associated with a media object. In another example, the first selection criterion comprises a location criterion and the second selection criterion can include one of map coordinates, location name, and location type associated with a media object. In another example, the first selection criterion comprises a manner or means criterion, and the second selection criterion can include one of a photographer, camera type, and media type associated with a media object. In another example, the first selection criterion comprises an identification criterion, and the second selection criterion can include one of an object and object type associated with a media object.

Hybrid In-Memory Faceted Engine

In various embodiments, a faceted search engine may be deployed on the user device 110. As such, the faceted search engine can rely on in-memory search indices that can be loaded on-demand based on the facets being searched. The search indices are built on top of real objects attribute values.

A facet is a way to search for one or more media objects. A facet can be associated with various facet values. Moreover, each facet corresponds to a specific field in the data being indexed. Fields have data types and expected values. To perform a search, the faceted search engine can build an index of all the values in each filed. Advantageously, the faceted search engine can very quickly execute any query. By contrast, conventional faced search engines depend on pre-calculated views of fixed queries and cannot handle dynamic complex queries.

In an example embodiment, a system performs a hybrid in-memory faceted search for one or more digital objects. The system can include a media platform with one or more processing device configured to: store an index for a data set generated using one or more indexing processes, where the index includes a mapping of values to identifiers for each digital object in the data set; receive an update for the index; store the index update with a timestamp independent from the stored index; and in response to a request for the stored index, apply the index updates to the index. In an example, the processing device determines a characteristic associated with the data set; and the index is processes based on the characteristic of the data set, where the index includes a mapping of values to identifiers for each digital object in the data set.

For example, the data set can include discrete data and the index includes multiple arrays for each digital object including at least one of sorted values of the discrete data and identifiers. For example, the identifiers can be grouped in ordered groups. In an example embodiment, the data set includes continuous data and each digital object is mapped to a unique timestamp.

When the mapping of values to identifiers for each digital object in the data set includes overlapping values, the processing device can determine a certainty factor associated with each value for each digital object and rank the identifier based on the certainty factor.

The request for the stored index can be a search request with query criteria, the processing device can generate a selector object to match query criteria to identifiers of the index; calculate a count of the unmodified identifiers associate with each query criteria based on the selector object; and execute the search starting with the query criteria associated with the most unmodified identifiers of the query criteria.

Types of Indices

To index data, the faceted search engine can use different types of indices depending on the type and nature of data being indexed. Each index type is built differently and has a specific purpose.

An index can be a basic index or a derived index. While each index type is implemented in a different way, all indices have the function of mapping real world values to certain rows of the media object they are indexing.

Basic Indices

Basic indices are directly calculated from the world object's raw values. Different types of basic indices may be calculated depending on the nature of the raw value as each type of raw value is handled differently.

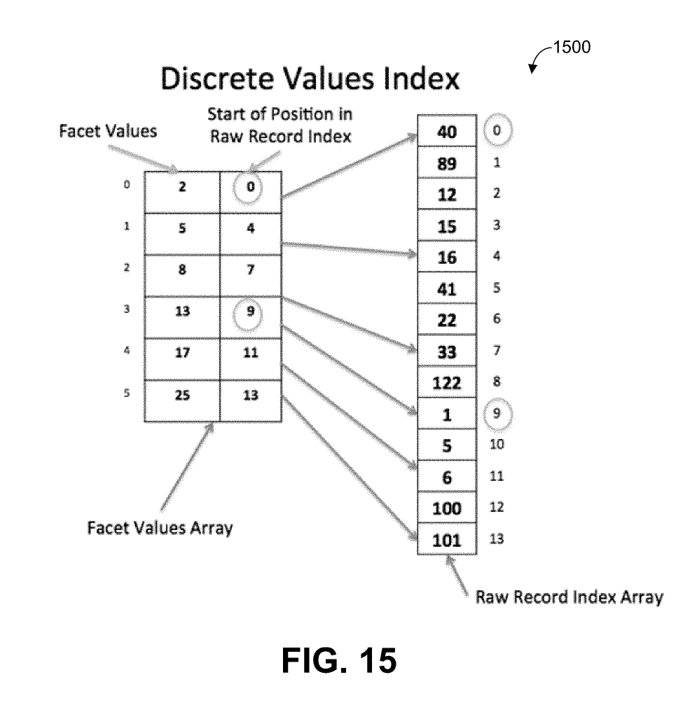

FIG. 15 illustrates a limited discrete index 1500 according to various embodiments. Referring to FIG. 15, the limited discrete index 1500 is a basic type of index that includes discrete an unlimited. The limited discrete index 1500 is kept in memory (e.g., of the user device 110) at all times and is deployed whenever the limited discrete index 1500 is needed. In various embodiments, the limited discrete index 1500 can be implemented as two arrays. The first array can hold the values indexed in an ascending sorting order and the starting position into the second index. The second array can hold the media row identifiers, which are grouped according to the raw values and are in a sorted order in each group. Advantageously, storing the limited discrete index 1500 requires a small amount of memory.

A large discrete index includes very large number of discrete values.

A continuous index contains an unlimited number of possible values that have almost one-to-one mapping with values (e.g., timestamp). Almost every single photo, for example, can have a different timestamp. Continuous range values can be handled by special index structure. For example, continuous indices may be handled using a regular B-Tree similar to the database indices.

A map index includes geolocation data. Geolocation data can be three dimensional data (e.g., longitude, latitude, and altitude) that are handled as a whole. In some embodiments, map indices may be handled using a database engine (e.g., SQLite®).

Derived Indices

Derived indices are based on other indices (e.g., basic or derived) and provide classifications and/or implications. In various embodiments, a derived index can be a simple derived index or a fuzzy derived index.

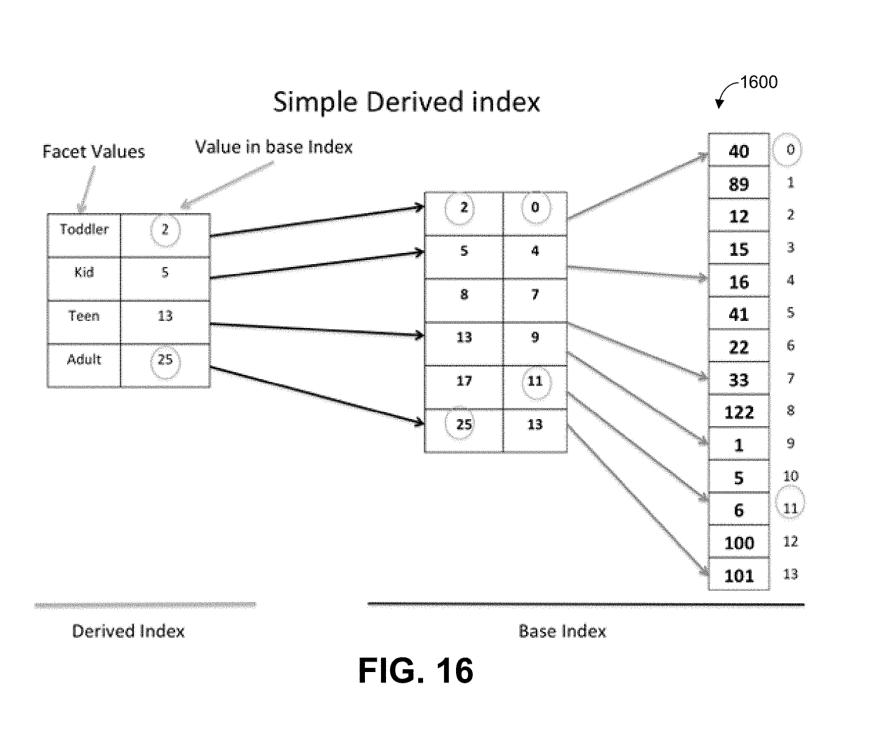

FIG. 16 illustrates a simple derived index 1600 according to various embodiments. Referring to FIG. 16, the index values of the simple derived index 1600 are based on values indexed by another index. For example, age groups may be indexed into a plurality of facet values including, for example, but not limited to, baby, toddle, kid, teenager, young adult, adult, middle age, and senior. The actual indexed values are derived from age raw values, e.g., a toddler is a person whose age is between 2 and 5. In various embodiments, the simple derived index 1600 is built using a single array that holds the values and the corresponding raw value in the based index. As such, the simple derived index 1600 occupies very limited space in memory and can easily accommodate changes to the base index.

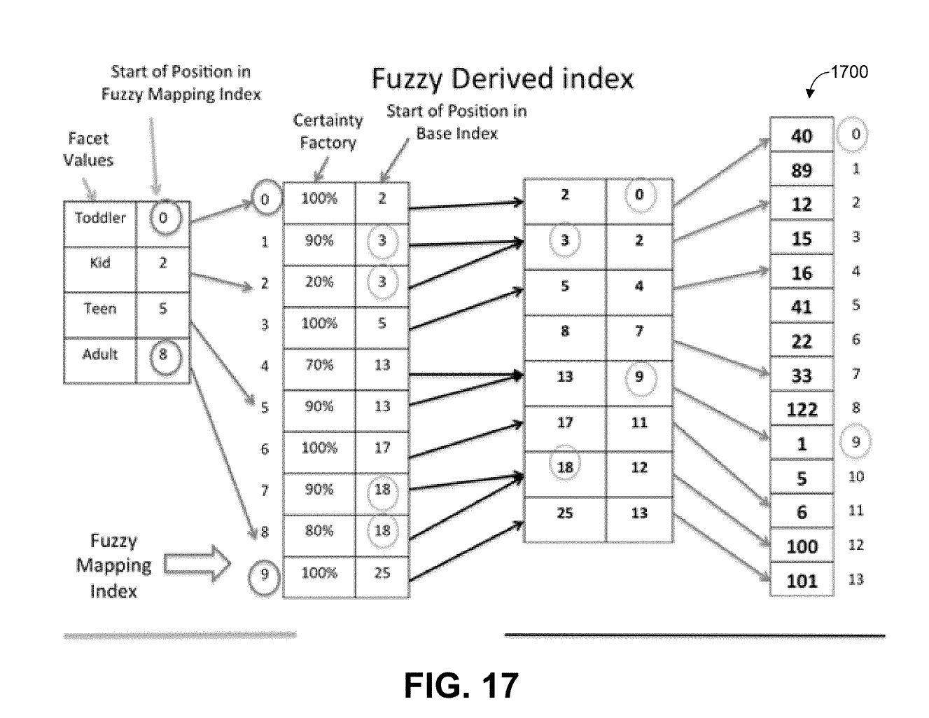

FIG. 17 illustrates a fuzzy derived index 1700 according to various embodiments. Referring to FIG. 17, the fuzzy derived index 1700 can include multiple indexed values that overlap with raw values. Thus, each mapping has a certainty factor associated with it. For example, if age group has a fuzzy index, then a person who is 1.8 years old can be both a baby and a toddler. However, the person is more likely to be a toddler. As such, the certainty factor for toddler is 90% while the certainty factor for baby is 15%. The certainty factor is selected to be suitable for each value. The benefit of such fuzzy indexing is to enable us to find the same information in different way and use the certainty to rank the search results.

Index Life Cycle

The index can be created in memory by iterating through the raw data. The index is kept in the most compact form in memory. By contrast, raw data is accessed differently in an orthogonal operation. In order to keep memory usage small, raw data may be iterated in batches in instances where the volume of raw data is large. The process may include multiple iteration passes (e.g., one pass for each index) since the data is to be loaded in a sorted order. Thus, if the volume of raw data is small, the raw data can be loaded in to memory at once and sorted during the creation of the index.

Once the index is created in the most compact form, the index is saved to a file in that form. For indices that have two or more arrays, the individual arrays are saved in the same file in a specific order, e.g., the indexed data array before the row id array.

The index can also be updated including by adding or deleting values to and from the index. In various embodiments, if the index is already in memory, the updates are applied to the index and the index saved to disk once the update is complete.

If the index is on disk, then the updates are appended to an update file for that particular index. The update file contains all the updates sorted by the timestamp. The index is not uploaded for an update operation. Instead of loading an index to apply one or more updates, the faceted search engine stores the changes that are to be made to the index. When the index is required for a search, the index is loaded to memory from the disk, the stored updates are loaded and applied to the index, and the index is saved to memory and can be used in a search.

Advantageously, the update process reduces unnecessary calculations that from being performed each time the index is updated. The update process preserves computational power for the index that is not being used between the updates. The index is updated when the index is called (e.g., for performing a search).

Querying Model

The faceted search engine affords the user the power and control of an enterprise search interface but in an easy to understand way that does not have a steep learning curve. To perform a query, the user selects one or more facet values and indicates if results must, can, or should not have the selected facet values. For example, suppose the user wants to find media objects taken during a holiday that is not Thanksgiving and depict a shoe, a dress, a bag, or sunglasses. The user can define the following query:

MUST: event type holiday

NOT: event Thanksgiving

OR: object shoe appear

OR: object dress appear

OR: object bad appear

A user can also specify a complex query for the user's son's photo around the house during autumn alone while my wife took the photo. The query can be specified as follows:

MUST: person son appear

MUST: person wife photographer

MUST: At house location

MUST: event autumn

NOT: At inside house

NOT: person any appears

Querying Mechanism

For each criteria defined by the user, the faceted search engine can create a selector object that operates on the facet index. The selector's purpose is to match the criteria to the raw media object identifiers. It also can return the number of possible media object identifiers that match the given criteria, which in turn returns the possible matches. The faceted search engine sorts the indices by the possible matches in an ascending order. As such, the index with the least number of matches is executed first, and the faceted search engine iterates over the list of indices and calculates the values that match the entire criteria.

```
MustSelectors[ ]
CanSelectors[ ]
NotSelectors[ ]
mustSelectorsIdx = 0
canSelectorsIdx = 0
notSelectorsIdx = 0
For each user criteria
      If criteria is MUST
            MustSelectors[mustSelectorsIdx] = new Selector(criteria)
            mustSelectorsIdx++
      else If criteria is CAN
            CanSelectors[canSelectorsIdx] = new Selector(criteria)
            canSelectorsIdx ++
      else If criteria is NOT
            NotSelectors [notSelectorsIdx] = new Selector(criteria)
            notSelectorsIdx ++
For each MustSelectors
      calculate the number of resulting row ids
Sort the MustSelectors selectors by the number of resulting row ids in
ascending order
Result = MustSelectors[0].rowIds
For each mustSeletor in MustSelectors<1 to mustSelectorsIdx−1>
      Result = Result AND mustSeletor.rowIds
For each NotSelectors
      calculate number of possible row ids
Sort the NotSelectors by the number of row ids in ascending order
For each notSeletor in NotSelectors <0 to notSelectorsIdx −1>
      Result = Result NOT notSeletor.rowIds
ORResult = CanSelectors[0].rowId
For each canSeletor in CanSelectors <1 to canSelectorsIdx−1>
      ORResult = ORResult OR canSeletor.rowIds
Result = Result AND ORResult
```

Advantageously, multiple query algorithms can be executed in parallel. Thus, each selector is independent and avoids race conditions. The selectors are further executed in order from the strictest to the least strict (e.g., AND followed by NOT followed by OR). The selector order provides the functionality to skip the execution of the lesser strict selectors if the result set will be empty.

In addition, the algorithm may be optimized as follows:
Perform the AND and NOT part of the query using criteria that have indices in memory
If the results has row ids
Perform the query on the criteria that have unmodified indices
If the results has row ids
Perform the query on the remaining criteria

The above optimization reduces the need for unnecessary loading of indices if it is know that the query result contains zero records.

Selection Operation

Selection operations are performed to select matching row identifiers for a certain selection criteria. Each index type implements the selector in a specific way that corresponds to that particular index type's structure.

Discrete Value Indices

Discrete value indices can be numeric or non-numeric. A numeric discrete value index affords mathematical operations including, for example, but not limited to, range selection, greater than, and less than.

Less Than X:
Binary search the facet values array and find the position of greatest value in the index that is less than X. The position of greatest value indicates the position in the Raw record Ids Array. Then, the preceding row ids before the position of greatest value position can be collected.

Greater Than X:
Binary search the facet values index and find the position of the least value that is larger than X. The position of the least value indicates the position in the Raw record Ids Array. Then, the row ids after position of the least value can be collected.

Equals to X:
Binary search the facet values index and find the position where the value is equal to X. The position where the value is equal indicates the position in the Raw record Ids Array. The Raw record Ids array has the starting position. The ending position is determined from the following index in the facet values index.

Derived value indices can also be either numeric or non-numeric, where numeric derived value indices are able to support mathematical operations.

Less Than X:
Binary search the facet values array and find the position of greatest value in the index that is less than X. The position of greatest value indicates in the based index values arraRaw record Ids Array. Then the row ids before position of greatest value are collected.

Greater Than X:
Binary search the facet values index and find the position of the least value that is larger than X. The position of the least value indicates the position in the Raw record Ids Array. Then the row ids after the position of the least value position are collected.

Equals to X:
Binary search the facet values index and find the position where the value is equal to X. The position where the value is equal indicates the position in the Raw record Ids Array. The Raw record Ids array has the starting position. The ending position is taken from the following index in the facet values index.

Query Basic Operations

Query operations (e.g., AND, NOT and OR) may be performed in multiple embodiments. For large arrays, compressed bit vector arrays are used to store the row identifiers (e.g., roaring array) and a binary bitmask is used to perform the operations that are suitable to such data structure. For small sized arrays, the algorithms are applied such as:

The AND operation works on two arrays of row identifiers: rowIDs1 and rowID2. The results are included in resultingIDs. The algorithm for an AND operation operates in linear time (i.e., O(n)) and includes:

```
Sort rowIDs1 and rowIDs2 in an ascending order. Using radix sort
Assign rowIDs1 to the array of fewer elements
Pointer1 = 0
Pointer2 = 0
ResultsPointer = 0
while Pointer1< number of count rowIDs1 && Pointer2< number of count
rowIDs2
      if rowIDs1[Pointer1] == rowIDs2[Pointer2]
            resultingIDs[ResultsPointer] = rowIDs1[Pointer1]
            ResultsPointer++
            Pointer1++
            Pointer2++
      else if rowIDs1[Pointer1] > rowIDs2[Pointer2]
            Pointer2++
      else
      Pointer1++
```

The NOT operation is akin to a set subtraction operation. One set of row identifiers are subtracted from the result. The algorithm for a NOT operation also operates in linear time (i.e., O(n)) and includes:

```
Sort rowIDs1 and rowIDs2 in an ascending order. Using radix sort
Pointer1 = 0
Pointer2 = 0
ResultsPointer = 0
while Pointer1< number of count rowIDs1 && Pointer2< number of count
rowIDs2
      if rowIDs1[Pointer1] == rowIDs2[Pointer2]
            Pointer1++
            Pointer2++
      else if rowIDs1[Pointer1] > rowIDs2[Pointer2]
            Pointer2++
      else
            resultingIDs[ResultsPointer] = rowIDs1[Pointer1]
            ResultsPointer++
            Pointer1++
while Pointer1< number of count rowIDs1
      resultingIDs[ResultsPointer] = rowIDs1[Pointer1]
      ResultsPointer++
      Pointer1++
```

The OR operation works on two arrays of row identifiers: rowIDs1 and rowID2; the result is called resultingIDs. The results are included in resultingIDs. The algorithm for an AND operation operates in linear time (i.e., O(n)) and includes:

```
Sort rowIDs1 and rowIDs2 in an ascending order. Using radix sort
Assign rowIDs1 to the array of fewer elements
Pointer1 = 0
Pointer2 = 0
ResultsPointer = 0
while Pointer1< number of count rowIDs1 && Pointer2< number
of count rowIDs2
      if rowIDs1[Pointer1] == rowIDs2[Pointer2]
            resultingIDs[ResultsPointer] = rowIDs1[Pointer1]
            ResultsPointer++
            Pointer1++
            Pointer2++
      else if rowIDs1[Pointer1] > rowIDs2[Pointer2]
            if resultingIDs[ResultsPointer] < rowIDs2[Pointer2]
                  resultingIDs[ResultsPointer] = rowIDs2[Pointer2]
                  ResultsPointer++
            Pointer2++
      else
      if resultingIDs[ResultsPointer] < rowIDs1[Pointer1]
            resultingIDs[ResultsPointer] = rowIDs1[Pointer1]
            ResultsPointer++
      Pointer1++
```

Multi-Mode User Interface

In various embodiments, the media platform 120 supports a multi-mode UI that is adaptable to various major activity types. For example, the UI can be in the visual search mode, the object association mode, or the object manipulation mode. As such, the UI can focus on the major activity without cluttering the screen with an endless set of options. In various embodiments, the commands are positioned in substantially the same relative place or region in the screen, allowing users access them by memory. The UI can be controlled by a mode switching control that indicates to the user which mode the UI is in and allows the user to quickly switch to other modes.

In an example embodiment, a system for interacting with a media platform that includes a media platform with a processing device configured to: provide, to a user device, a user interface (UI) to control a multi-mode application of the media platform, where the user interface comprises multiple mode navigation regions and each mode navigation region is associated with a mode of the multi-mode application, where each mode navigation region comprises a specific set of functions for controlling the mode associated with the mode navigation region. The UI is to present the navigation region for an active mode based on detecting device activity, where the UI includes a global navigation menu for switching to non-active modes and suppresses functions associated with the non-active modes.

For example, each mode navigation region can include a specific set of functions for controlling the mode associated with the mode navigation region; and when the navigation region is presented, the specific set of functions are maintained in the mode navigation region. In an example embodiment, the global navigation menu is controllable by a gesture input of the user. To present the specific set of functions, the UI can include one or more expandable sub-mode navigation regions. The one or more expandable sub-mode navigation regions can be presented based on the detected device activity while the UI suppresses functions associated with the non-active sub-modes.

The UI can include an active mode indicator on the global navigation menu. In some embodiments, the processing device detects device activating by tracking a user's activity pattern to suggest a next mode by highlighting a shortcut on the global navigation menu. The multi-mode application can include at least one of a visual search mode, object manipulation mode, or data entry mode.

Multi-Mode Control Switch

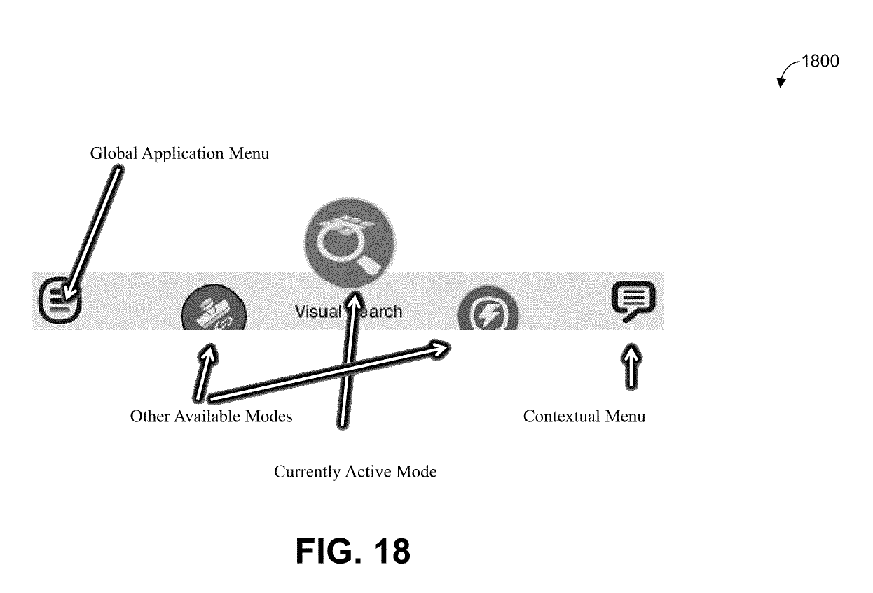

FIG. 18 illustrates a multi-mode control switch 1800 according to various embodiments. Referring to FIG. 18, the multi-mode control switch 1800 can be displayed on the user device 110 (e.g., a smartphone). The multi-mode control switch 1800 displays the current mode “Visual Search” as well as additional modes the user can switch to. Alternatively the user can use a swipe gesture (e.g., on a touch screen) to switch between different modes and/or reveal additional modes.

Multi-Mode Overview

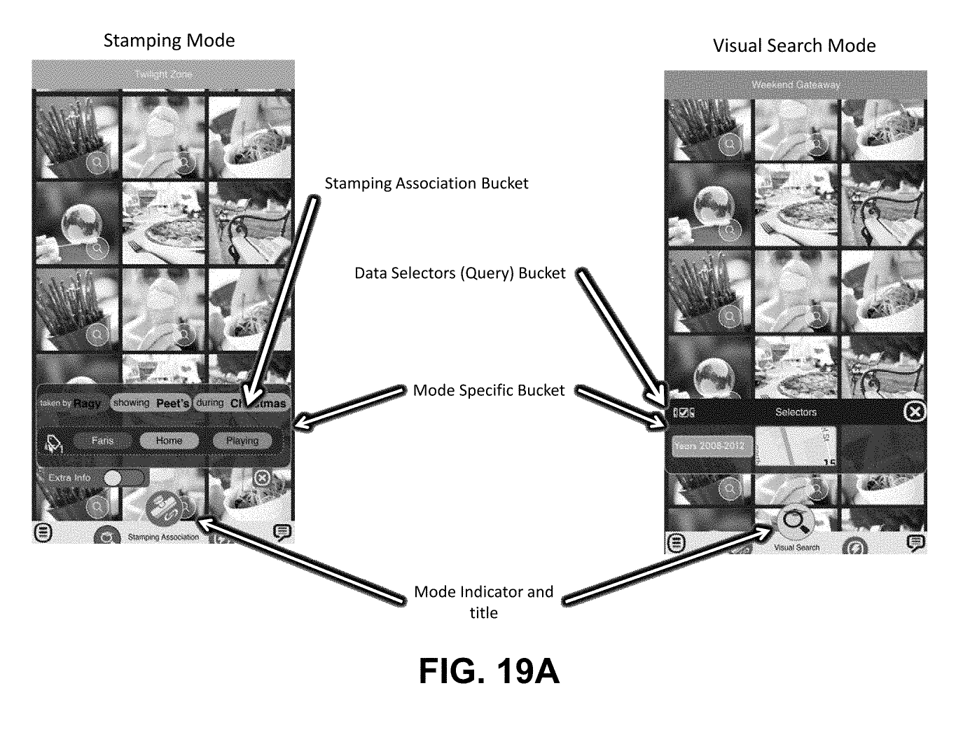

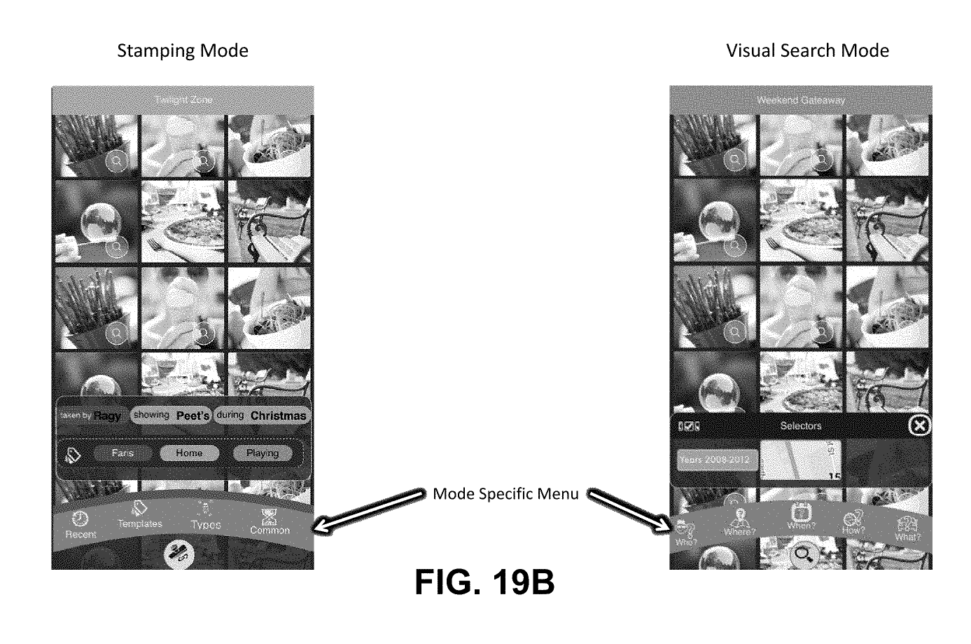

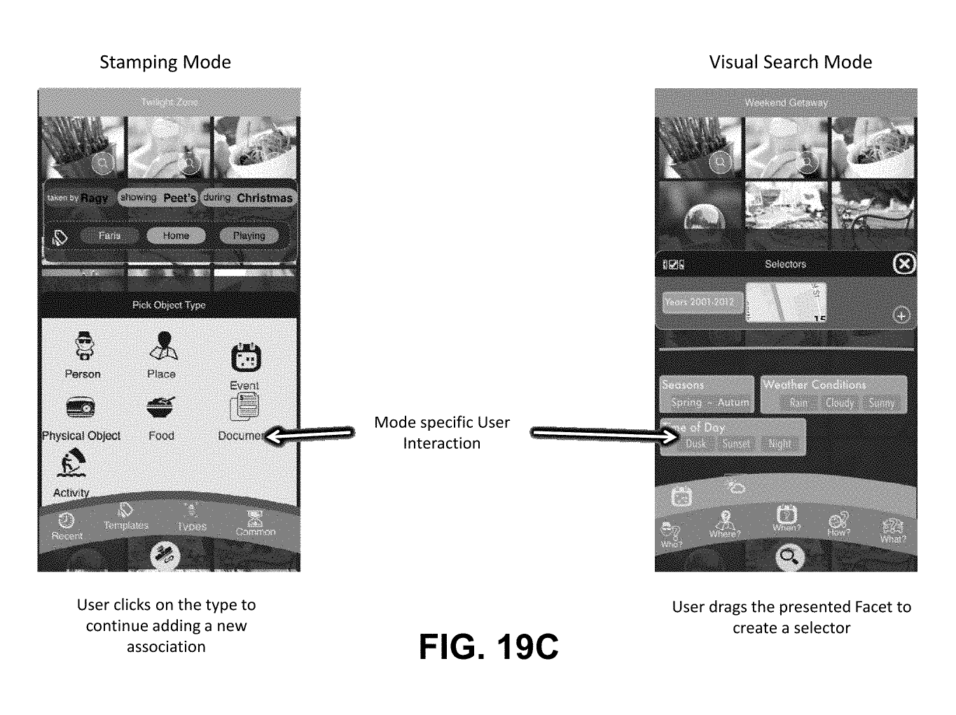

FIGS. 19A-C illustrate a multi-mode UI according to various embodiments. Referring to FIGS. 19A-C, the multi-mode UI can be used for associating semantic information to media objects and for searching for media objects. The stamping mode provides an interface from determining associations for media objects. The UI is constructed to allow efficient searching of the media objects that can be associated in a very effective way that allows the user to perform batch association. The controls in the stamping UI are related to association functions. To search, the user can switch to the visual search mode (on the right side). The multi-mode control switch, as described in FIG. 18, allows for quick navigation between modes. In search mode the visual search UI presents control options focused on searching the media library.

Advantageously, the multi-mode UI frees the user from guessing what actions are available for different activities (e.g., search, stamping, sharing, etc.). The multi-mode UI efficiently categorizes and presents the actions which are related to each activity mode. The UI commands are placed in the same location or region of the screen for a given mode. Thus, the multi-mode UI reduces the cognitive requirements for individual users without reducing functionality of the application.

Masking Access Control

In various embodiments, the media platform 120 controls access to stored data objects (e.g., media objects stored in the data store 125) in a manner that does not require user accounts. By contrast, access is controlled based on automatic or manual data object protection rules that are orthogonal to user account mechanisms. Each data protection rule selects specific data objects to be protected and can be turned on and off to make the objects inaccessible or accessible respectively. Data protection rules statuses are combinable to compute an effective data-masking layer. The data-masking layer determines if a given data object is accessible or not. Presenting data protection as simple data selection rules simplifies complex access control mechanisms.

Data Access Computation

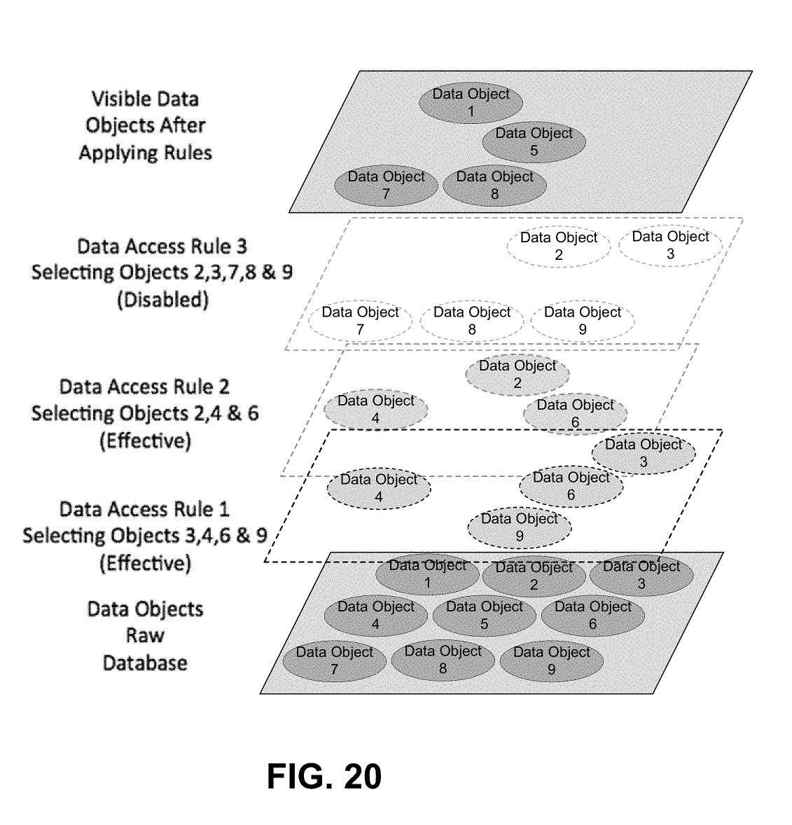

FIG. 20 illustrates data access computation according to various embodiments. In various embodiments, the media platform 120 can calculate data object visibility by performing an effective data masking computation. Access control rules are combinable to create a masking mechanism. Each rule identifies data objects that are to be inaccessible (e.g., hidden). When multiple rules are combined, the data objects that have not been obscured by any rule are left visible to the user.

In some embodiments, the media platform 120 implements the masking mechanism by creating a lock count and attaches the lock count to each data object. When an access control rule is activated, the rule identifies the data objects associated with the rule, determines a corresponding lock count incremented (e.g., by one), and restricts access to the associated data objects. When a user performs a search, the system restricts access (e.g., hides the data objects from the search results, or prevents accessing the data object) to data objects that have a lock count greater than zero. By contrast, data objects with a lock count of zero are displayed and accessible to the user. In some embodiments, the media platform 120 can implement the masking mechanism by performing a check on whether a data object selected is associated with any active access control rules.

Access Control Workflow

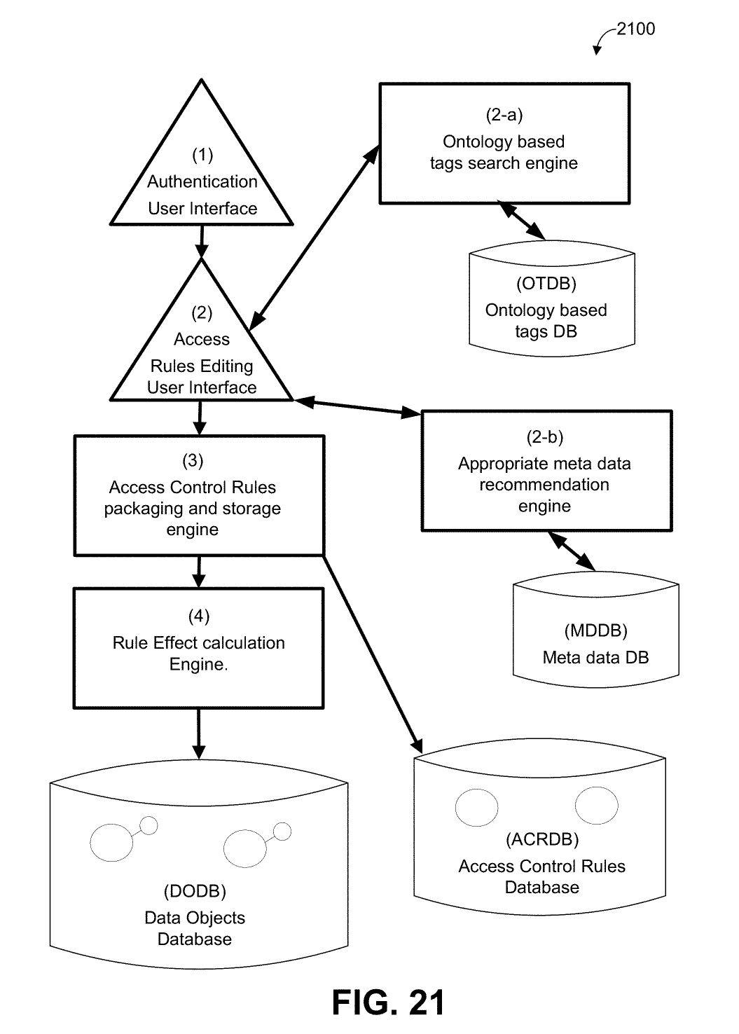

FIG. 21 illustrates a process 2100 for enforcing access control according to various embodiments.

Referring to FIG. 21, a first UI is presented to challenge the user to re-establish the user identity before editing the rules (1). A second UI is presented to enable the user to create a new access control rule or edit an existing one (2). The second UI is a dynamic UI based on the available meta data to pick from and the relevant tags. Moreover, the second UI consults with two services. First, the second UI may consult with an ontology based tag search engine service to assist in the access control editor interface to facilitate the addition of relevant tags by the user. For example, the user may wish to pick tags for cities in Italy and the ontology based tag search engine helps the user find them efficiently.

Second, the second UI may consult with an appropriate metadata recommendation engine, which indicates what kind of metadata is available for a particular object type. For example, videos may have duration as metadata while text documents may have a word or character count. The engine assists in narrowing down the selection to the user for easy editing.

After the user confirms the final version of the access control rule, the access control rule is packaged for efficient storage and transportation (3). The rule is made ready for execution by the media platform 120. The access control rule is then stored (e.g., in a rules databased with existing rules).

The effect of the rule is pre-calculated for efficient enforcement at runtime and such effect is stored with each data object (4).

Alternately, access control rules can be symbolic link access control rules, where the rules are a simple group of hand selected data objects. In one embodiment, symbolic links are used to identify files in a file system to be locked. As such, when a group of symbolic links are locked the actual files are also locked. Data control locks implemented using symbolic links are separate from organizational structure.

The access control rules can also be meta-data access control rules where the access control rules are based on meta-data instead of tags.

The access control rules can also be keyword based tags access control rules where the tags are keyword matching tags and not ontology based tags

The access control rules can also be ontology based tags access control rules.

Changing Access Control Rule Status

Access control rule status can be changed either manually or automatically.

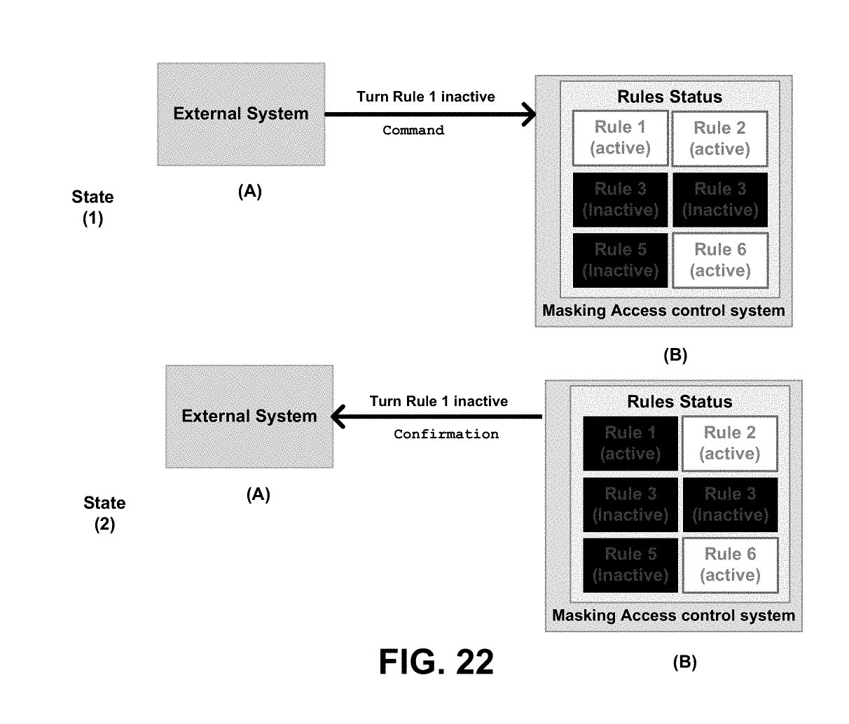

FIG. 22 illustrates an automatic change to access control rule status according to various embodiments. Referring to FIG. 22, an external system may be working in conjunction with the masking access control system. The external system is responsible for controlling which access control rules are effective which access control rules are not. For example, an operating system can control the access control rules implemented in physical storage system controller (e.g., hard drive or solid state drive (SSD) controller). In this case, the operating system can add an extra level of protection that works in conjunction with the underlying operating system level. As shown in FIG. 22, in state 1, the external system sends a command to the described system where the command instructs to turn off one or more of the rules. The system responds in state 2 by confirming the new status of the access control rule after changing that rule status.

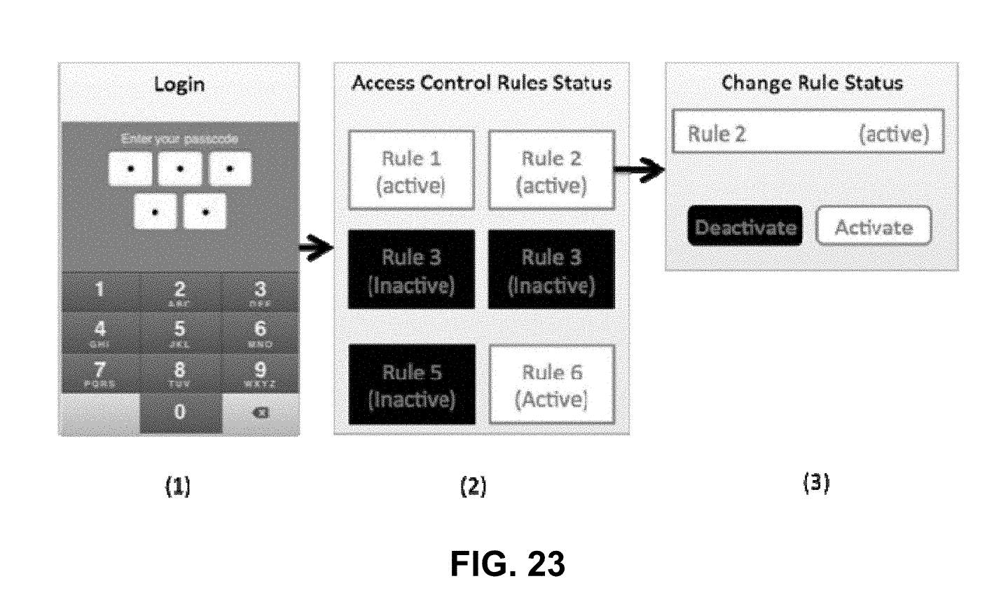

FIG. 23 illustrates a manual change to access control rule status according to various embodiments. Referring to FIG. 23, in a manual mode, the user controls the status of the access control rules. When the user wants to change the access control rule status, the system presents a UI enabling the user to edit access control rules. For example, if the user is challenged for authentication with a login screen to confirm the user identity, the login screen can take a password form, a picture code form, a lock key form, or any other authentication form. The UI can be presented that lists the access control rules and the status (e.g., enabled, disabled, active, deactivated, etc.) of each access control rule. When the user clicks on one of the rules, the user is presented with a UI that allows the user to change the status (e.g., enabled, disabled, active, deactivated, etc.) of the rule.

According to various embodiments, a system for enforcing restrictive access control with respect to a set of media objects includes on a single device. The single device may be configured to: determine, based at least in part on a first access control rule, to block access to at least a first media object included in the set of media objects; determine, based at least in part on a second access control rule, to block access to at least a second media object included in the set of media objects; and provide, to a user of the single device, at least a third media object included in the set of media objects but not the first media object and the second media object. The device can be configured to provide the third media object but not the first media object and the second media object based at least in part on the lock count associated with each of the first media object, the second media object, and the third media object.

Restrictive Access Control in Independent and Distributed Multi-System Environments

In some embodiments, data may be dispersed across multiple independent systems including, for example, but not limited to, the user device 110, the data store 125, the first data source 140, and the second data source 150. The media platform 120 can synchronize access control rules on separate systems on a separate and a higher priority synchronization channel than for data synchronization. Additionally, data objects metadata can also use a separate synchronization mechanism and/or channel, thereby allowing each system to enforce the rules independently of a centralized system.

Synchronization

In a multi-system ecosystem, different systems (e.g., the data store 125, the first data source 140, and the second data source 150) are linked together to enable the user to reuse the same access control rules for any one system. The media platform 120 synchronizes access control rules, data objects, and metadata for data objects to enable each system to operate independently. Multiple synchronization networks can operate independently. For example, the access control rules synchronization network can operate in a substantially real time fashion on a high priority level. The metadata synchronization network can also work on a high priority level. The data object synchronization network may be a third independent network.

According to an example implementation, the system can enforce restrictive access control with respect to a set of digital objects accessible by a first device and second device of a user. The system includes the first device of the user configured to detect an update associated with a first system access control rule, wherein the first system access control rule is to block access to at least a first digital object included in the set of digital objects on the first device; determine, based at least in part on the update to the first system access control rule, to block access to at least a second digital object included in the set of digital objects on a second device; and provide, to the second device, the update associated with a first system access control rule to maintain restrictive access control over the set of digital objects on a second device.

According to an example implementation, the system for enforcing restrictive access control with respect to a set of media objects includes on multiple devices device for a single user. A first device may be configured to: determine, based at least in part on a first access control rule, to block access to at least a first media object included in the set of media objects; determine, based at least in part on a second access control rule, to block access to at least a second media object included in the set of media objects; and provide, to a user of the first device, at least a third media object included in the set of media objects but not the first media object and the second media object. The system can include a second device of the user and the first access control rule can include a universal rule applicable to the first device and the second device and the second access control rule can include a device specific rule applicable to the first device but not the second device.

According to an example implementation, the first device and the second device are configured to engage in a browsing session wherein a user of the second device browses the set of media objects via the first device. For example, the first device and the second device can be configured to conduct the browsing session based on a third access control rule that is applicable to the browsing session between the first device and the second device for the user. The third access control rule can block access to the third media object included in the set of media objects. For example, the first device can be configured to provide to the user of the second device at least the second media object but not the first media object and the third media object.

Central Server

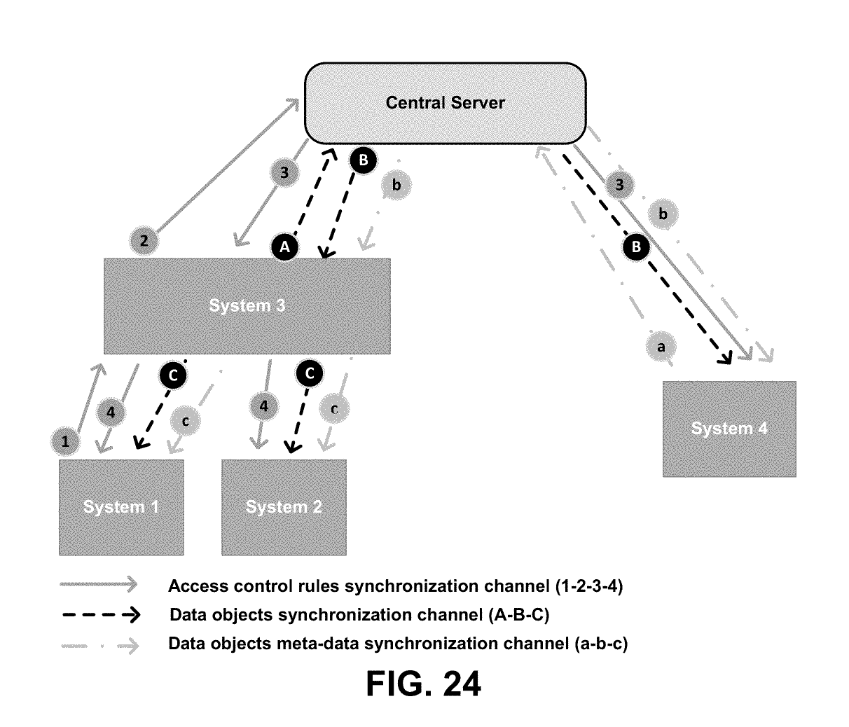

In some embodiments, synchronization can take place with a central server or cloud acting as a maestro. All changes are first transmitted to the central server or the cloud before the changes are propagated to other systems. FIG. 24 illustrates central server based synchronization according to various embodiments.

Peer to Peer

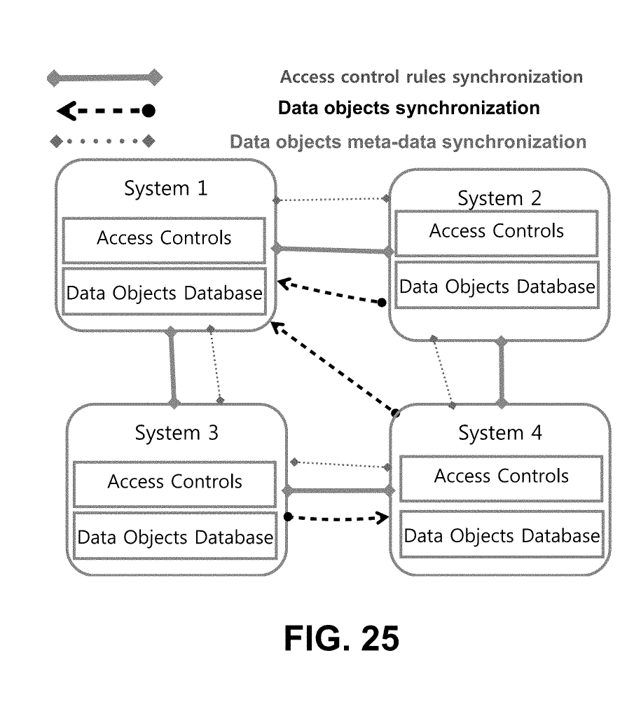

In some embodiments, a peer-to-peer paradigm is applied in synchronizing multiple systems. For example, peer-to-peer synchronization can use independent versioning to track the latest updates. FIG. 25 illustrates peer-to-peer synchronization according to various embodiments.

Hierarchical Synchronization Network

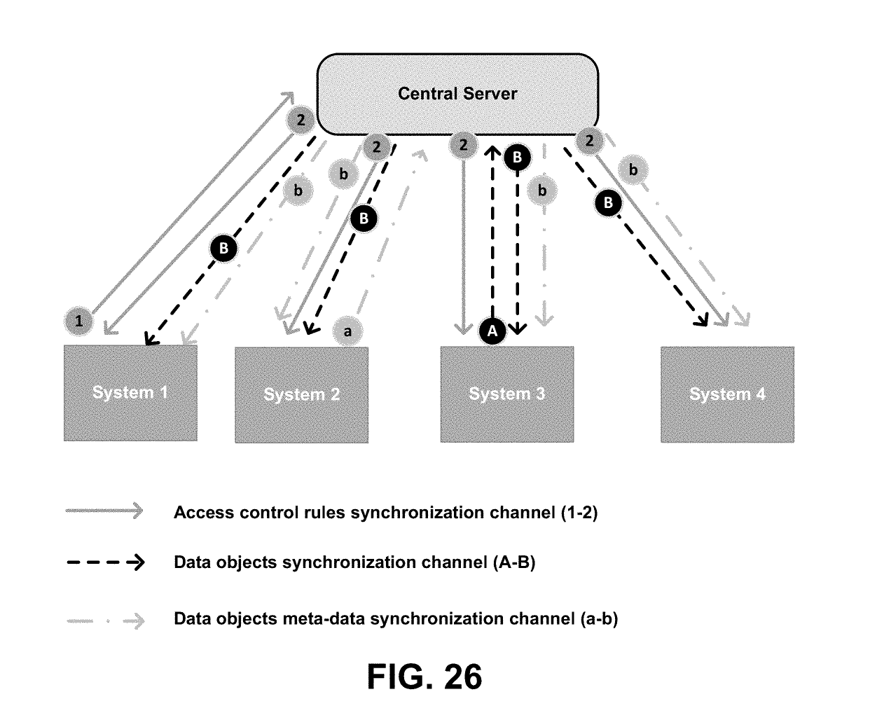

In some embodiments, some systems may act as a local synchronization server orchestrating the status between local devices. The local synchronization server is responsible for communication with a centralized server. For example, in the absence of a mobile network, a WiFi hotspot could host a server that orchestrates the synchronization between various systems connected to the hotspot as well and communicates with a central server. FIG. 26 illustrates hierarchical synchronization according to various embodiments.

Data Access Computation

In various embodiments, data object visibility is calculated by access control rule status cascade and effecting data masking computation.

Access Control Rule Status Cascade

To support access control rule distribution and peer-to-peer browsing, multiple layers can be defined at which access control rules may be turned on or off. The layers can include, for example, but not limited to, a universal layer (i.e., for the whole ecosystem), a system or device layer (i.e., for each individual device or system), an application layer (i.e., for systems implemented at a platform level), and a session layer (i.e., for peer-to-peer or temporary changes).

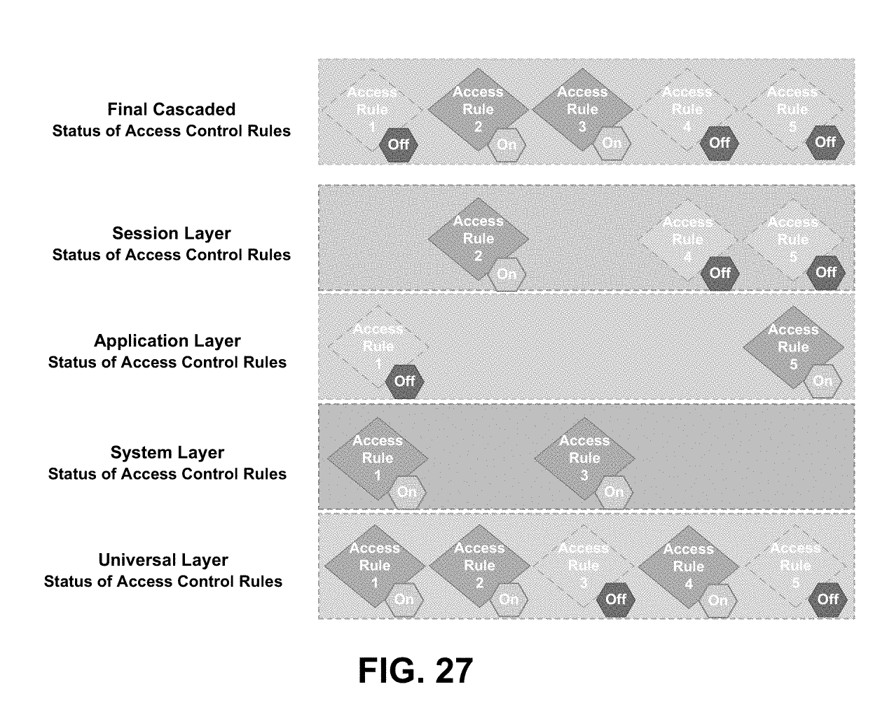

In various embodiments, access control rules can be turned on or off at each layer. To calculate the status of each rule, rule status is cascaded from the least specific (i.e., universal) layer to the most specific (i.e., session) layer. The status of each rule is computed by allowing a rule status at a more general layer override the rule status at a more specific layer. FIG. 27 illustrates access control rule cascade according to various embodiments.

Effective Data Masking Computation

The effective data masking computation is conducted in a similar manner as described above, but the process is repeated for each target session.

Peer-to-Peer Browsing Session with Access Control

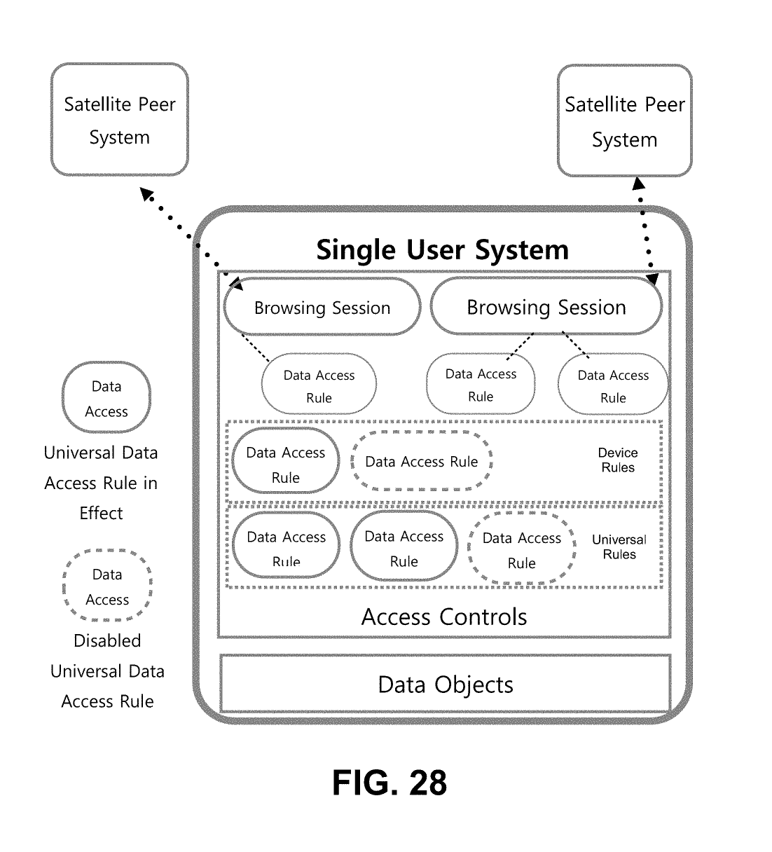

In peer-to-peer browsing mode, other systems are able to browse data objects stored in the host device, in an ad-hoc fashion, while maintaining access control rules. For each satellite system that request to browse the hosting, system can create a browsing session and change the status of access control rules for a particular browsing session. The session rules can be included in the computation of the rule status cascade, as described above. In some embodiments, peer-to-peer browsing converts the host device into an ad-hoc server for the purpose of data browsing. FIG. 28 illustrates a peer-to-peer browsing session according to various embodiments.

Browsing Session Initiation

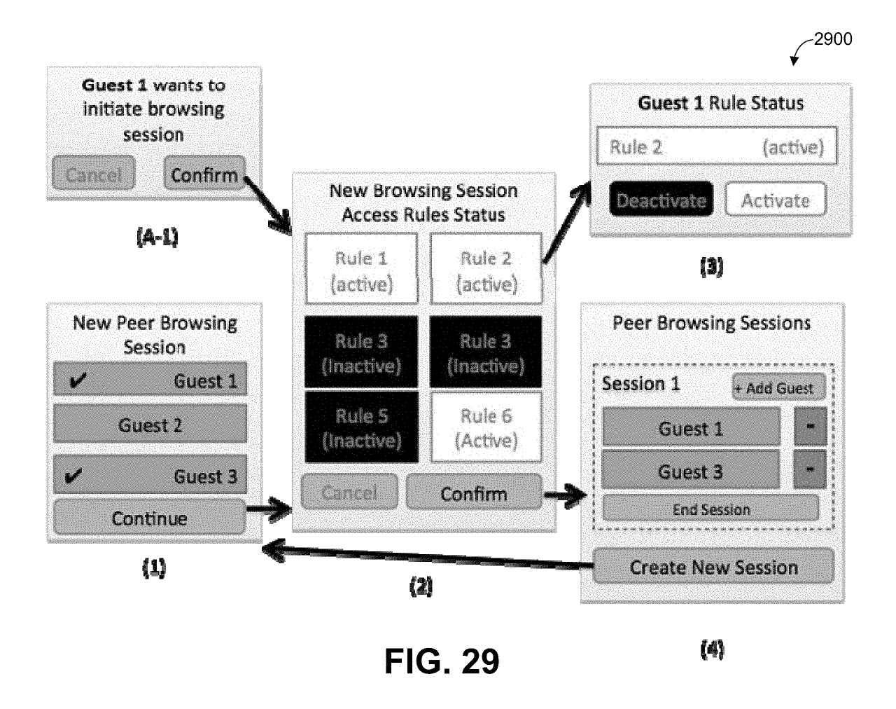

FIG. 29 illustrates a process 2900 for initiating a peer-to-peer browsing session according to various embodiments. For a user to initiate a peer-to-peer browsing session, the user is presented with the set of guests the user can invite to browse the user's own device (1). The user selects the desired guests then continues to examine the access control rules. The effective status of the access control rules for the new session is presented to the user allowing the user to change the effective status of each rule for that particular session (2). The user can active and deactivate each access control rule for that particular guest session (3). The user is presented with a UI allowing the user to see the currently active browsing sessions along with the guests participating in each session (4). The user can add guests, remove guests, and/or terminate the session via the UI.

According to an example implementation, the system can enforce restrictive access control for a user while browsing another user's device.

Visual Access Codes

In various embodiments, access may be controlled via a visual access code mechanism that makes it easier for the user to remember while providing enhanced security by increasing the possible combinations. The visual access code mechanism is presented via a UI having two entry phases. The first entry phasesrequests the user to select one photo from a set of photos or images, which can be preconfigured by a system administrator. The photo set can be the same for all users or be user-specific. Moreover, the photo set can be the same for all devices or be device-specific.

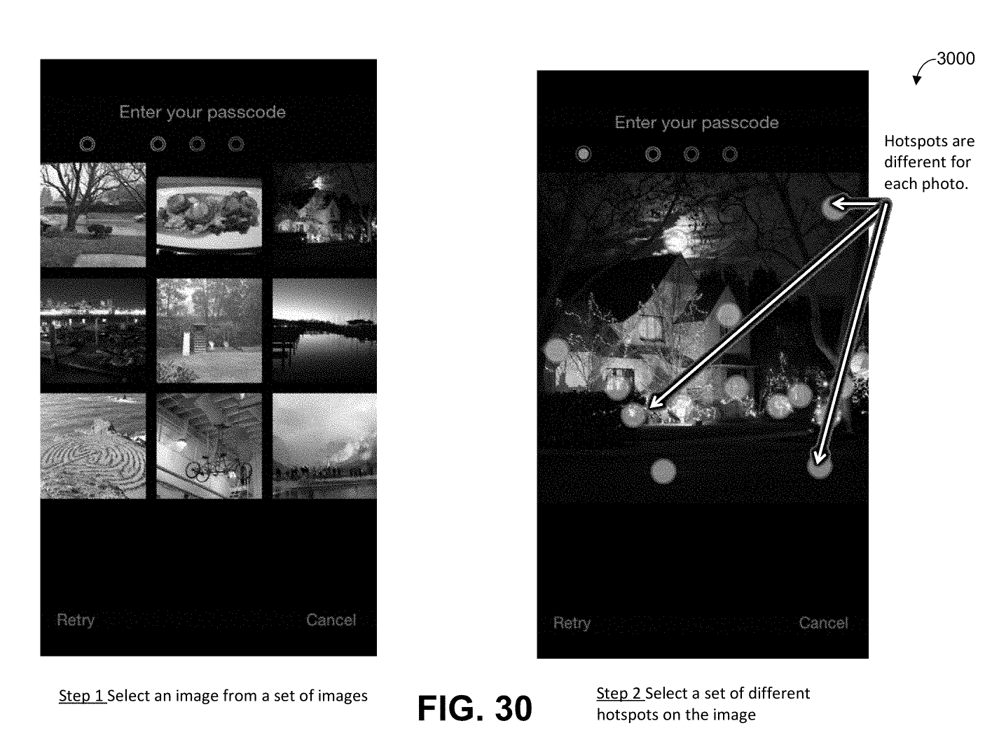

FIG. 30 illustrates a process 3000 for configuring a visual access code according to various embodiments. The user can be presented with an image (e.g., photo) in step 1. In step 2, the user is required to select (e.g., by clicking, touching, gesturing, etc.) a subset of (e.g., four, five, etc.) hotspots from a group of possible (e.g., 16, 25, 36, etc.) hotspots. For example, the user can select a subset of 4 hotspots from 16 hotspots marked on the photo by touching the hotspots in any order. In some embodiments, the image can have an overlay or marking to make the hotspots visible and aid the user in selecting and recalling the selected hotspots. The visual access code is composed of the photo index associated with the photo selected at step 1 and the subset of hotspots values selected at step 2. The photo index and coordinates associated with the subset of hotspots can be stored as an encrypted digest.

A user's visual memory is employed to store and recall the registered image and the hotspots by using visual cues in the image. Visual memory is a form of memory which preserves some characteristics of our senses pertaining to visual experience. Visual memory describes the relationship between perceptual processing and the encoding, storage and retrieval of the resulting neural representations. Visual memory occurs over time ranges from eye movements in order to visually navigate to a previously visited location. Visual access codes including a subset of hotspots on a registered image can stored longer and more readily recalled for providing authentication. Further, selecting trivial visual access codes is less likely than trivial alphanumeric passcodes (e.g., “1111,” “1234,” “password,” etc.) since available hotspots are different for each photo. The user can place in memory visual information which resembles objects, places, animals or people as a mental image of the visual access code. The user can recall the visual access codes as patterns from long term visual memory using different areas of their prefrontal cortex and the anterior cingulate cortex.

According to various embodiments, a system for visual access code process can include a first device configured to: present, to a user of the first device or service, a plurality of images; receive, from the user, a selection of a first of the plurality of images; receive, from the user, a selection of at least a first of a plurality of hotspots included in the first images; and generate a visual access code based at least in part on the selection of the first images and the first hotspot.

According to an example implementation, a registration process of the visual access process may include a first selection from a grid of images (e.g., photographs, pictures, complex shapes, images, etc.) and a second selection for a series of hotspot locations of the first selected image (e.g., pixel location, screen coordinates, overlay point, etc.) For example, the user may be presented with a grid of photographs depicting various landmarks, select a picture depicting a landmark from the grid. Then from the selected landmark picture, the user can select a series of hotspot locations on the selected picture. For example, the selected hotspot locations may be locations on the picture or image that correspond to different parts of a landmark, the background, border of the picture, etc. The depicted features in the picture or image serve as visual clues to the user where the visual cues correspond to the selected hotspot locations. Accordingly, depicted features in the picture may be more readily stored in the user's memory than traditional alphanumerical combinations

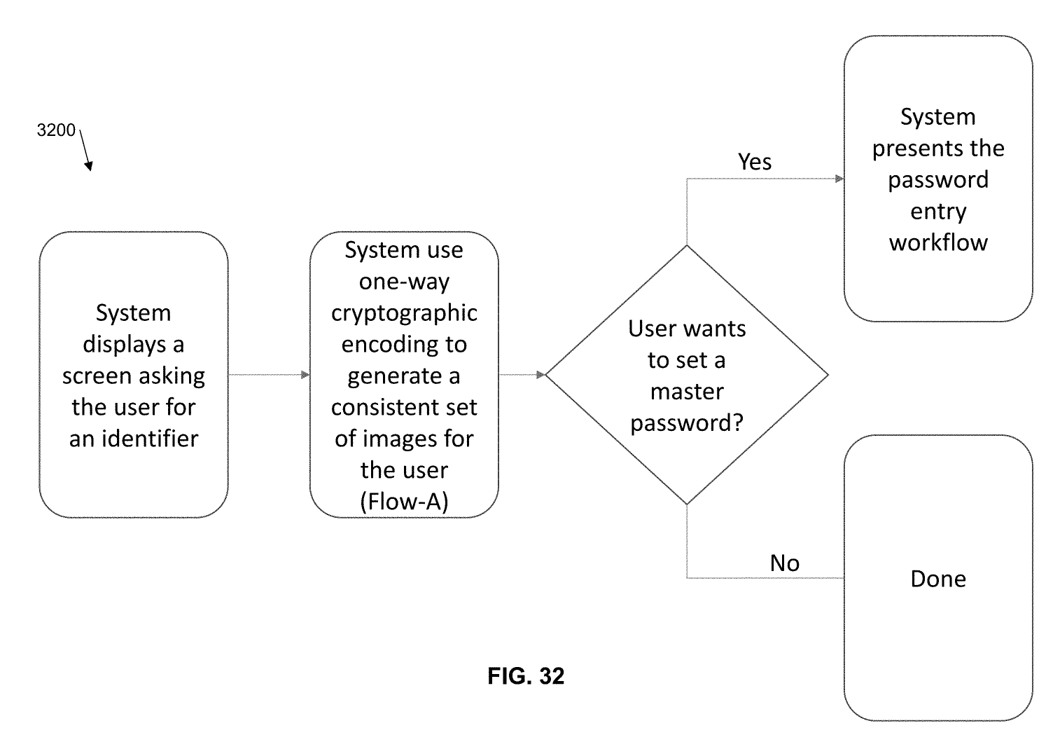

The system can efficiently store the user selection of the picture and set of hotspots during the registration process, as described in greater detail with reference to FIGS. 32-41. For example, each of the plurality of photographs can be associated with a corresponding index number. For example, each index number can include a globally unique photo identifier. In an embodiment, the first phase selection of the image from a grid of images can include additional pages of grids of multiple images. The user can scroll through multiple pages of grids of images to identify the registered image for the first phase image selection. Each of the images in the multiple grids of images can include an index number based on the globally unique photo identifier of each image.

Each image can include a number of predefined hotspots for the user to select a subset of for the second phase set of hotspots. According to an example implementation, each of the plurality of hotspots is associated with a corresponding hotspot identifier that can be cryptographically stored with the image index number. According to another example implementation, each of the plurality of hotspots can be associated with a two dimensional coordinate of a corresponding pixel in the photograph.

According to an embodiment, the visual access code can be implemented by an authentication service, for example, on a destination device or service. In an example, a website can replace a traditional alphanumeric login form with a visual access code two phase input method to authenticate the user. After the user register's a visual access code with the authentication service, the authentication service (e.g., the mobile device or website) can user various techniques for securely storing the user's visual access code to match subsequent entry of the visual access code to the stored registered access code. For example, after the user register's a visual access code, the authentication service can transform an identifier associated with the first phase and coordinates associated with the second phase into a text string and cryptographically store the string. Then, when the user re-visits the destination and enters the visual access code, the authentication service can decrypt the stored string to verify the user's authorization to access the destination.

According to another embodiment, the visual access code can be implemented by a client side visual authorization interface (VAI) that receives from the user a visual access code and outputs an alphanumeric password to various destinations. In this embodiment, the VAI includes an algorithm that recreates the alphanumeric password based on the destination. In an example, a user can access a website that uses a traditional alphanumeric login form with the VAI. To use the VAI with the destination, the user employs the VAI to set-up or registers the alphanumeric password.

The visual access code system can further include a system and method for entering visual access codes through on-screen virtual input mechanisms or visual authorization interface (VAI). The VAI acts as a client side visual password entry software that does not require support from other applications or websites. The VAI present to the user a user interface that allows him to enter the password visually and then the software encodes such visual access code into regular alpha-numeric characters that are suitable for current websites and applications. The system does not store the passwords anywhere and generates consistently them every time the user enters a visual access code.

For example, a virtual keyboard may be VAI dedicated for entering visual access codes. The VAI can perform client-side authentication for entry of visual passwords via the visual access code process. The VAI presents the user with an interface to input the visual access code independent of the device hardware. That is, the VAI provides compatibility for secure authentication that does not require hardware, such as a fingerprint reader, and maintains integrity of the visual access codes independent of locally stored passwords.

The user may navigate to a reset my password form and launch the VAI to populate the alphanumeric password in the destination's password form. As described below, the VAI will consistently regenerate the alphanumeric password for the destination based on the visual access code entered by the user. Moreover, when the same visual access code is entered into the VAI for a different destination, the VAI generates a different alphanumeric password. Accordingly, the VAI can authenticate a user using a visual access code compatible with the traditional destination login method. After the user uses the VAI to register with a destination, the destination stores the output of the VAI (e.g., an alphanumeric password). The output of the VAI serves as a destination side authentication key while the visual access code is a client side authentication key.

For example, after the destination records the output of the VAI, the user can re-visits the destination, launch the VAI, enter the user's visual access code, and the VAI will output a passcode that matches the passcode previously stored by the destination. In various embodiments the output of the VAI can be based a hex digest that uses a user's unique identifier, selection of a first image, a unique identifier of the first image, an image blending algorithm, selection of hotpots, shifting of hotspot coordinates, and/or one or more one-way cryptographic algorithms.

After the user registers a series or set of hotspots of a selected image, the user can be presented with the visual access code process for authenticating the user to the device or service. For example, the user may navigate to an access interface of the device or service, be presented with multiple photographs or image during a first phase of the visual access process. The user must recall the correct photograph previously selected during the registered process among multiple photographs presented. For example, the user may be presented with a grid of pictures depicting various famous landmarks. The user's registered image may be grouped with the same plurality of photographs from during the registration process or grouped with photographs that are different from the images presented during the registration process. The user first selects the registered image from the plurality of images. For example, the user selected image can be matched to the index number of the photograph's globally unique photo identifier.

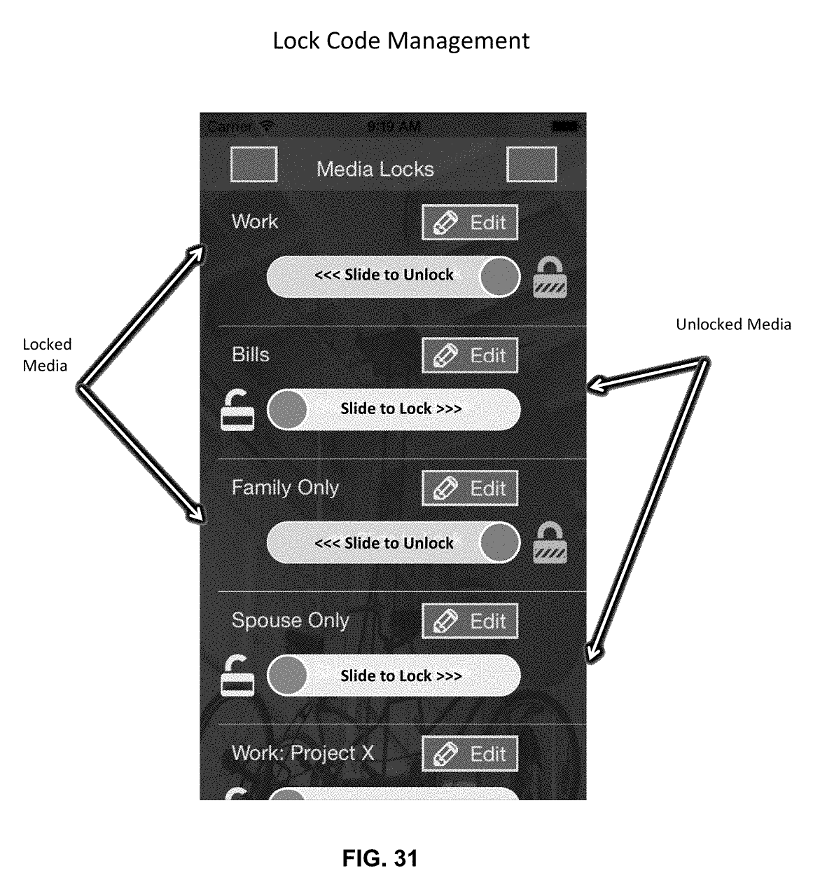

FIG. 31 illustrates an example lock code management interface for use with visual access codes. The lock code management interface 3100 allows the user to manage visual access codes, configure visual access code preferences, assign user profiles, etc. In an example embodiment, the lock code management interface allows the user to configure different visual access codes based on an application category, such as media applications, financial applications, work applications, etc. A master user can configure multiple visual access codes for different sub-users of a service or device. For example, a parent may configure guest visual access codes that allow children to access gaming applications. In another example, a spouse may configure a partner visual access code that allows the spouse's partner to access financial accounts but not social media or messaging accounts of the spouse.

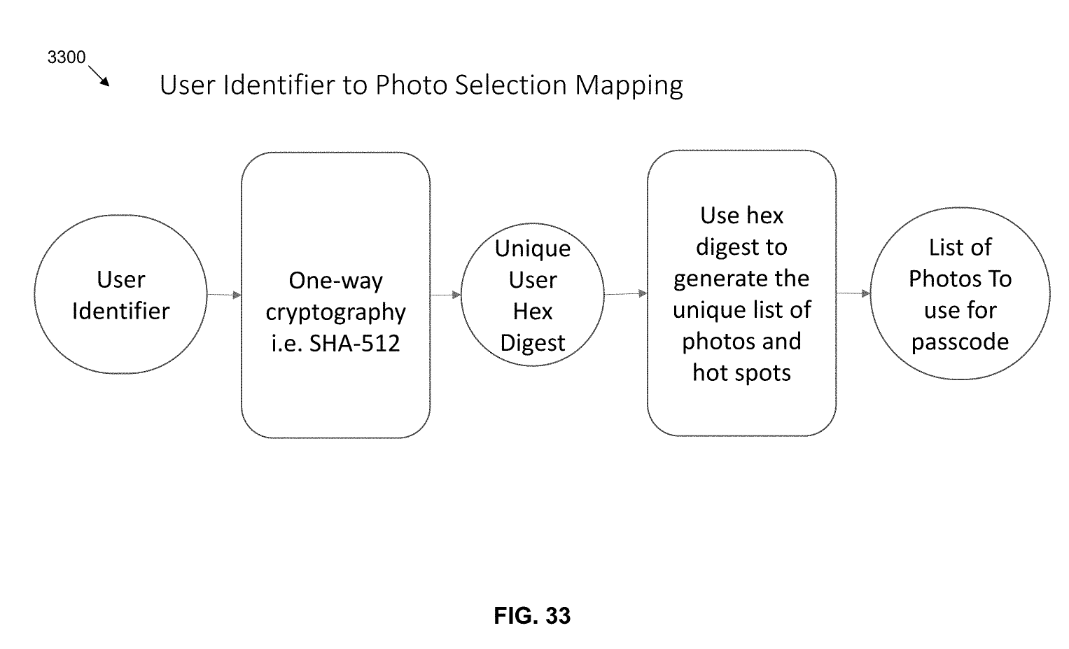

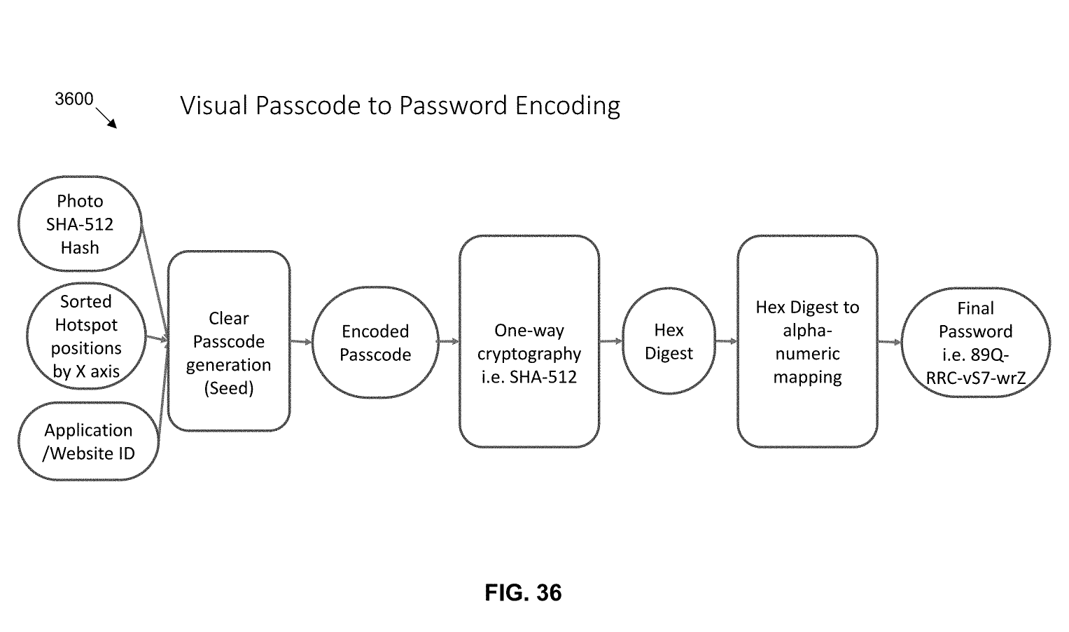

FIG. 32 illustrates an example flow 3200 for configuring visual access codes according to an exemplary embodiment. The process begins with gathering a unique identifier from the user. The process 3200 uses a one-way cryptographic encoding to generate a consistent set of images for the user, as further described in reference to FIG. 33. The workflow 3200 proceeds to determine whether the user wants to set a master password, as further described in reference to FIG. 36.

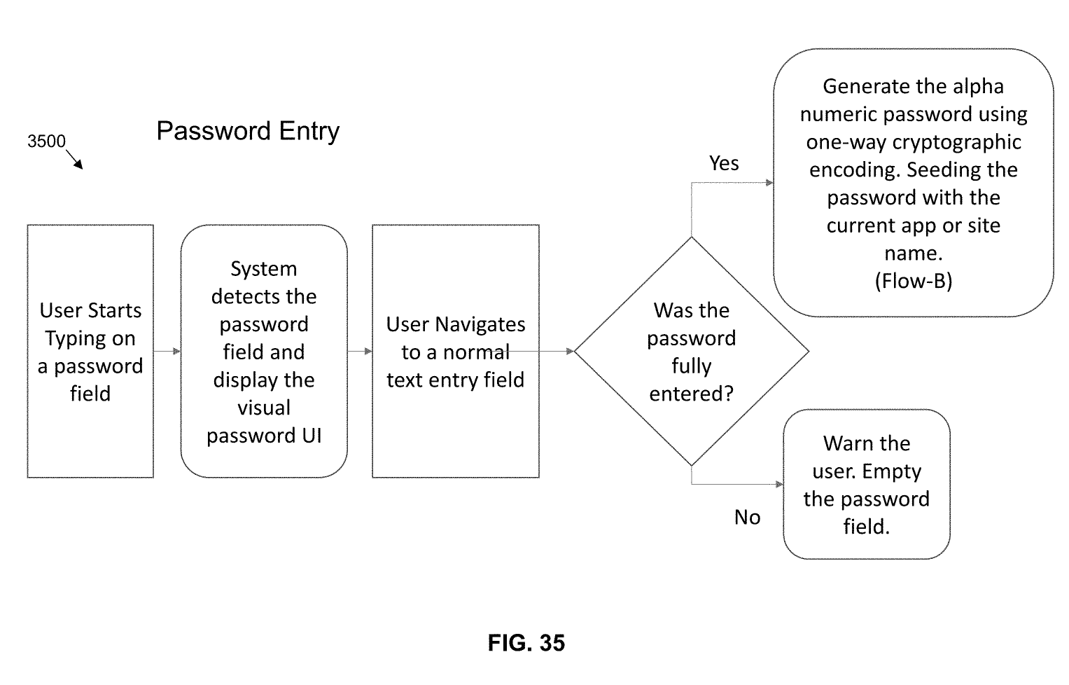

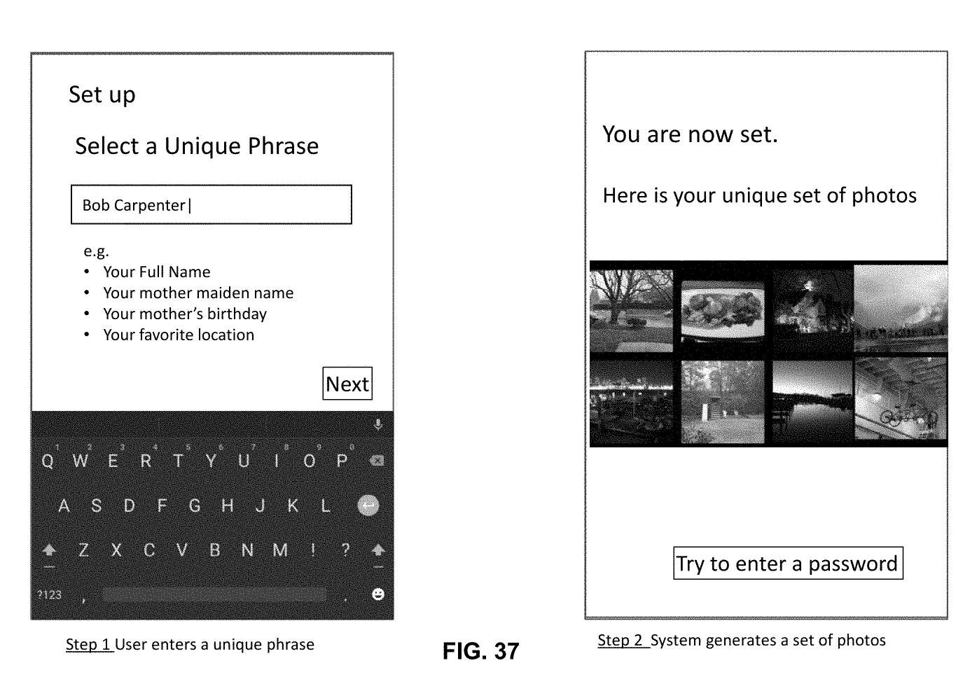

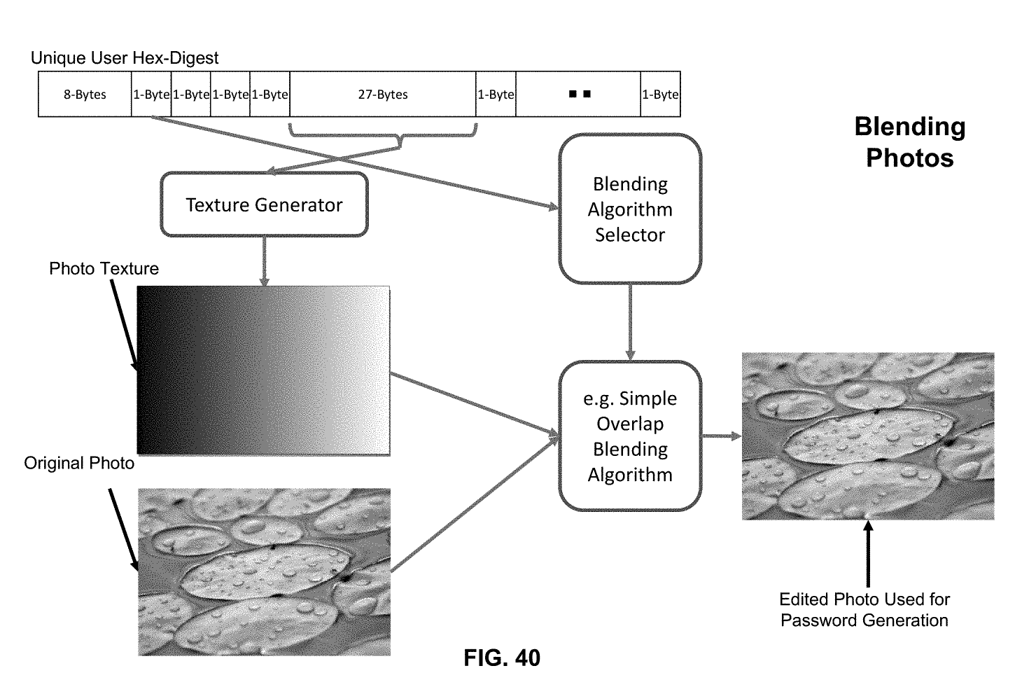

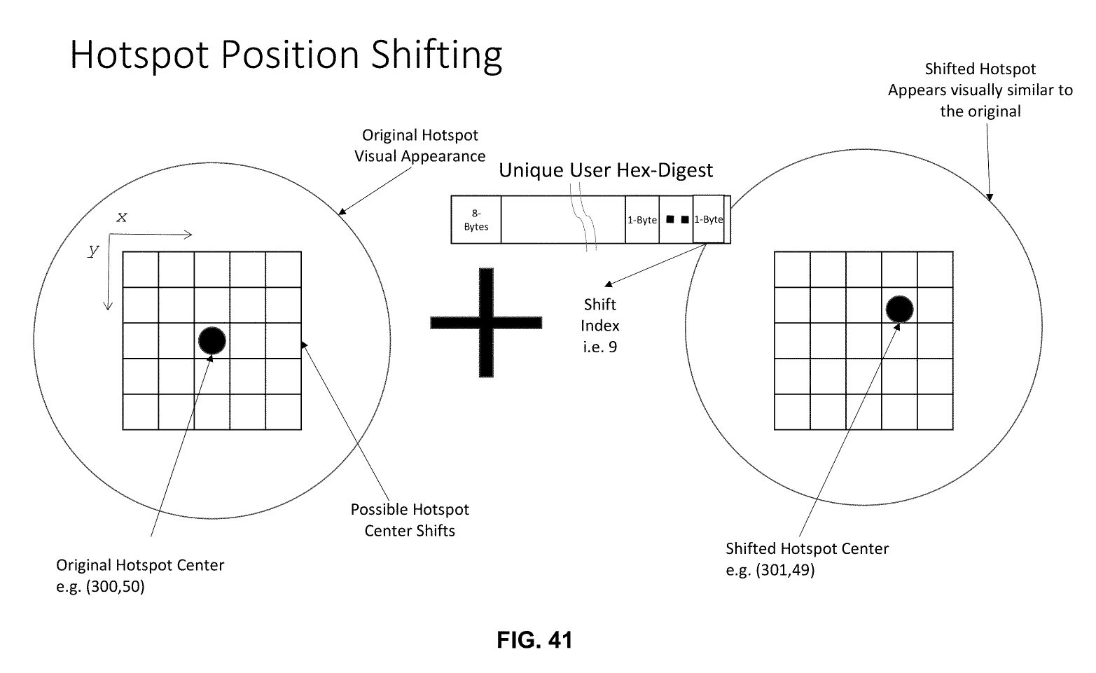

FIG. 33 illustrates an example process 3300 for mapping a user identifier to photo selection mapping according to various embodiments. Process 3300 may begin with the user providing a unique identifier. Process 3300 may determine a one-way cryptographic code and generate a unique user hex digest, as described in more detail in reference to FIGS. 35-36. Then, unique user hex digest can be used to generate a unique list of photos and hotspots, as described in more detail in reference to FIGS. 40-41. Then process 3300 presents the list of photos to the user to register a passcode, as described in more detail in reference to FIGS. 37-39.

Compact Encoding

In some embodiments, the visual access code may be encoded using compact encoding. For example, in compact encoding, each photo can have an index from 0 to 8 while each hotspot has an index from 0 to 15. There may be no fixed correlation between an index that is assigned to a hotspot and the hotspot's position in the photo. The correlation between the index that is assigned to the hotspot and the hotspot's position in the photo is photo dependent. In an embodiment, the index value associated with the hotspot is assigned randomly. Accordingly, random index assignments for the hotspot create secure access passcode.

In the example above, compact encoding creates 16 possible values. Four of the values are selected in any order any number of times, giving rise to 3,876 possibilities. Since there are further 9 different photos, the number of possible combinations increases to 9×3,876=34,884, which is more than 3 times the number of possibilities afforded by a conventional 4-digit numeric passcode.

Positioned Encoding

In some embodiments, the visual access code may be generated using positioned encoding based on each chosen hotspot's coordinates. For the same photo, the coordinates of each hotspot may be fixed but those coordinates are not transportable from one photo to another. Table 1 shows how a simple hotspot index encoding as described in the previous section is mapped to coordinate indices. For example, hotspot index 2 corresponds to values (140 and 59) in Photo 1 and (89 and 147) in Photo 2. With compact encoding the value 2 is shared between photos but coordinate values for the same hotspot is not shared between photos. Moreover, the number of stored digits is also increased (e.g., 8 instead of 4 values). Thus, positioned encoding generates even more possibilities and renders the corresponding visual access code even harder to break.

In some embodiment, the visual access code can depend on the size and/or resolution of the photo. For instance, in a 500×500 pixel photo, each hotspot can generate a code from 0 to 499 in the horizontal axis and from 0 to 499 in the vertical axis. As such, 4 hotspots is equivalent to 8 digits, which gives 1.02432860e+17 possibilities. That number is further multiplied by the number of photos (e.g., 9), which yields ˜9e+17 possibilities for a much stronger password than a conventional 8-character long alphanumeric case sensitive password with special characters (i.e., 2.02095455e+11 possibilities).

TABLE 1

| hotspot Index | Photo 1 Coordinates | Photo 2 Coordinates |
|---|---|---|
| 0 | (0, 0) | (100, 100) |
| 1 | (40, 50) | (24, 135) |
| 2 | (140, 59) | (89, 147) |
| 3 | (240, 15) | (29, 225) |
| 4 | (370, 50) | (54, 135) |
| 5 | (140, 150) | (214, 335) |
| 6 | (78, 150) | (334, 235) |
| 7 | (67, 20) | (344, 185) |
| 8 | (80, 500) | (124, 195) |
| 9 | (90, 310) | (249, 435) |
| 10 | (140, 240) | (214, 235) |
| 11 | (400, 150) | (314, 135) |
| 12 | (230, 60) | (245, 135) |
| 13 | (312, 70) | (124, 235) |
| 14 | (32, 80) | (274, 535) |
| 15 | (42, 98) | (214, 335) |

Positioned Encoding with Unique Photo Identifiers

In some embodiments, every photo can be associated with a globally unique identifier. As such, storing the passcode is dependent on the system or on the user. The user cannot select the same password for the two different systems. For example, a passcode of (0,100,101,200,201,300,301,400,401) that has been encoded using positioned coding corresponds to the first photo (i.e., photo 0). But incorporating a unique photo identifier generates a password of (38A52BE4-9352-453E-AF97 5C3B448652F 0,100,101,200,201,300,301,400,401), where ‘38A52BE4-9352-453E-AF97-503B448652F0’ is the photo globally unique identifier. In various embodiments, the globally unique identifier could be a length value (e.g., a 16 characters long number) that is hard to guess.

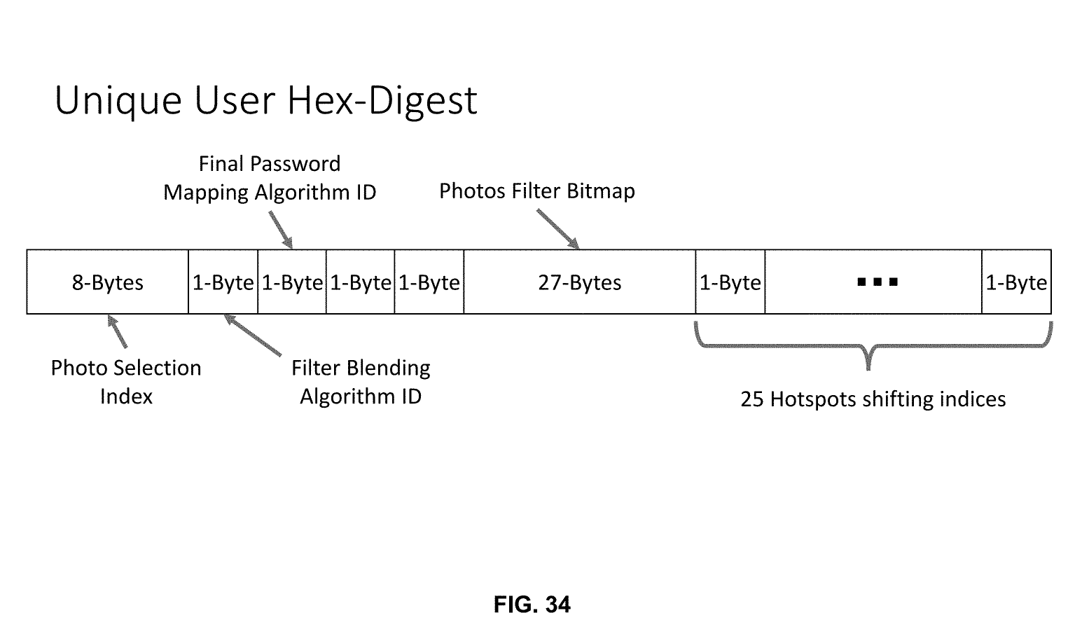

FIG. 34 illustrates an example unique user hex digest, according to various embodiments. The hex digest can include a photo selection index, a filter blending algorithm identifier, a final password mapping algorithm identifier, photo filter bitmap, and hotspot identifiers. For example a unique user hex digest may begin with eight bytes designated for the photo selection index, followed by a one byte filter blending algorithm identifier, and an indicator for the final password mapping algorithm. In an example embodiment the photo filter bitmap may consist of 27 bytes. According to an example embodiment, the unique user hex digest can include 25 bytes for indicating hotspot shifting indices.

FIG. 35 illustrates an example registration process for assigning a visual access code according to an example embodiment. The registration process 3500 may begin with a user navigating to a destination that requires authentication. A virtual input (e.g., VAI) method may detect a traditional login form requiring a username and password. After the user types a username into a traditional login form, the registration process 3500 method may present a registration interface for assigning a visual access code to the destination using a hex digest. The user may proceed via the VAI with selecting a first image and series of hotspots to register a new visual access code for the destination, as described above.

Based on the provided username and destination identifier, the VAI can regenerate a password based on the hex digest to match a stored password with the destination.

The registration process 3500 may proceed to completing the traditional login form with the password based on the hex digest. For example, registration process 3500 can generate the alphanumeric password using one-way cryptographic encoding and seeding the password with a destination identifier. A password seed is used to feed the one-way cryptographic algorithm prior to generating an alphanumeric password, as described in reference to FIG. 36. The seed has a direct one-to-one mapping between the user's selected hotspots and the seed. The process generates a password seeded with the application/website destination name before the one-way cryptographic such that different application/websites destinations have different passwords even when the same visual passcode is used. Therefore, the user's system does not need to store the passwords for each site since the access code process consistently replicates generation of the password based on the user input.

According to an exemplary embodiment, the algorithm for setting up a visual access code can include

```
Encode the phrase with one-way cryptography i.e. sha-512
let uniqueUserHexDigest = onewayCryptography(user phrase)
save uniqueUserHexDigest to hostsystem Keystore
Use the cryptography to generate the list of photos
      let basePhotoIndex = getByteAtIndex(0,8, uniqueUserHexDigest)
Repeat index i 0 to (number of Photos to use for key) − 1
Let photoIndex = (basePhotoIndex + i)modulus (total number of photos
in the system)
let photo = getPhotoWithIndex(photoIndex)
let blendingAlgorithmIndex= getByteAtIndex(8, uniqueUserHexDigest)
let photoFilterBitmap = getNumberOfBytesFromPosition(27,12,
uniqueUserHexDigest)
let photoBlendingFilter =
generateFullPhotoFromBitmap(photoFilterBitmap)
let finalPhoto = blendPhotoWithFilterUsingAlgorithm(photo,
photoBlendingFilter, blendingAlgorithmIndex)
let hotspots = getPhotoHotSpotsForIndex(photoIndex)
let h=0
let shiftedHotSpots = Array of size of 25
for each hotspot
      let hotspotShift = getByteAtIndex (h+38, uniqueUserHexDigest)
      let adjustedHotSpot = adjustHotSpotCenterByShift(hotspots[h],
hotspotShift)
      shiftedHotSpots.add(adjustedHotSpot)
```

When the destination is visited, the VAI may determine the associated visual access code and present the user with the virtual input method to authenticate the user. In response to a successful visual access code authentication via the virtual input method, the system may populate the traditional login form with the assigned alphanumeric password to complete destination authentication.

FIG. 36 illustrates an example process 3600 for encoding a visual access code with a password according to an example embodiment. The process 3600 may input photo SHA-512 has, sorted hotspot positions by the X axis, and an application/website destination identifier to generate a passcode seed. The process 3600 uses the encoded passcode with a one-way cryptographic algorithm to generate the hex digest that is used to map an alphanumeric password. In an example embodiment, the resulting password will generate a secure ASCII password that can include upper case and lower case English alphabet and numbers as well as special characters. According to an example embodiment the algorithm can include:

```
input passwordHexDigest
let passwordBytes = getNumberOfBytesFromPosition(0,16,
passwordHexDigest)
let finalPassword = “”
For each byte in passwordBytes
If ( byte == 45 OR
(byte >=48 AND byte <=57) OR
(byte >=65 AND byte <=90) OR
(byte >=97 AND byte <=122)){
// take the value as is
finalPassword.append(byte)
continue to next byte
}
      let modByte = byte modulus 63
      if(modByte == 0){
            modByte += 45
      } else if (byte >=1 AND byte <=11){
            modByte += 47
      } else if (byte >=12 AND byte <=37){
            modByte+= 53
      }else{
            modByte+= 59
      }
finalPassword.append(modByte)
```

FIG. 37 illustrates an example mobile interface in accordance with various embodiments. To set up a visual access code for the virtual input method, the user begins by selecting a unique passphrase such as their name, a mother's maiden name, birthdate, or favorite location, etc. Step two the system generates a set of images for the user to select a registration image. According to an example embodiment the algorithm can include:

```
Let photoHexDigest = generateOneWayCryptographyFrom(photoBitmpa)
Let selectedHotspotsXY = “”
For each selected hotspot
      Let hotspotXY=getXYForHotspot
      selectedHotspotsXY.append(hotspotXY)
End
Let siteOrAppId = collectCurrentSiteOrAppId
Let finalPasswordSeed = concat(photoHexDigest, selectedHotspotsXY,
siteOrAppId)
Let passwordHexDigest =
generateOneWayCryptographyFrom(finalPasswordSeed)
Let passordMappingAlgorithmIndex=
getByteAtIndex (9, uniqueUserHexDigest)
let asciiPassword=
generateAsciiPasswordWithAlgorithm(passwordHexDigest,
passordMappingAlgorithmIndex)
```

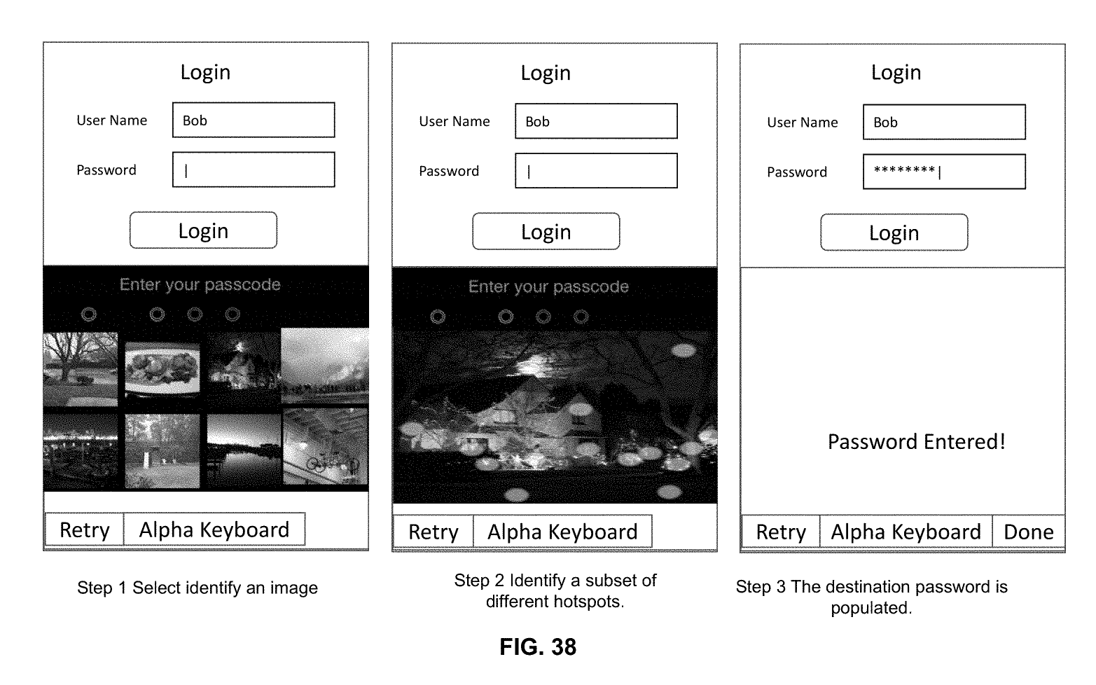

FIG. 38 illustrates an example implementation of entering a visual access code according to an example embodiment. At step one, the user navigates to a destination website or application or login screen that requires authentication. The VAI can detect the destination's authentication form and retrieves the visual access code associated with the destinations identifier. The VAI presents the user with a set of images that includes the image previously registered by the user for the destination. In response to the user selecting the image matching the registered image, the VAI proceeds to step two to present the user hotspots of the registered image. For example, the registered image may be of a house in include 16 possible hotspots.

In response to the user selecting a series of hotspots that match previously registered hotspots, the visual input method proceeds to step three. For example, the user may identify four hotspots by touching different locations on the image that correspond to different parts of the house depicted that match the hotspots user selected during the registration process. At step three, the virtual input method inputs the alphanumeric password stored with the visual access code into the destination's authentication form. In some example embodiments, the virtual input method may present a confirmation message that the user has successfully input the visual access code. The user may proceed by clicking on the destination's authentication form to complete logging in without having to type an alphanumeric password.

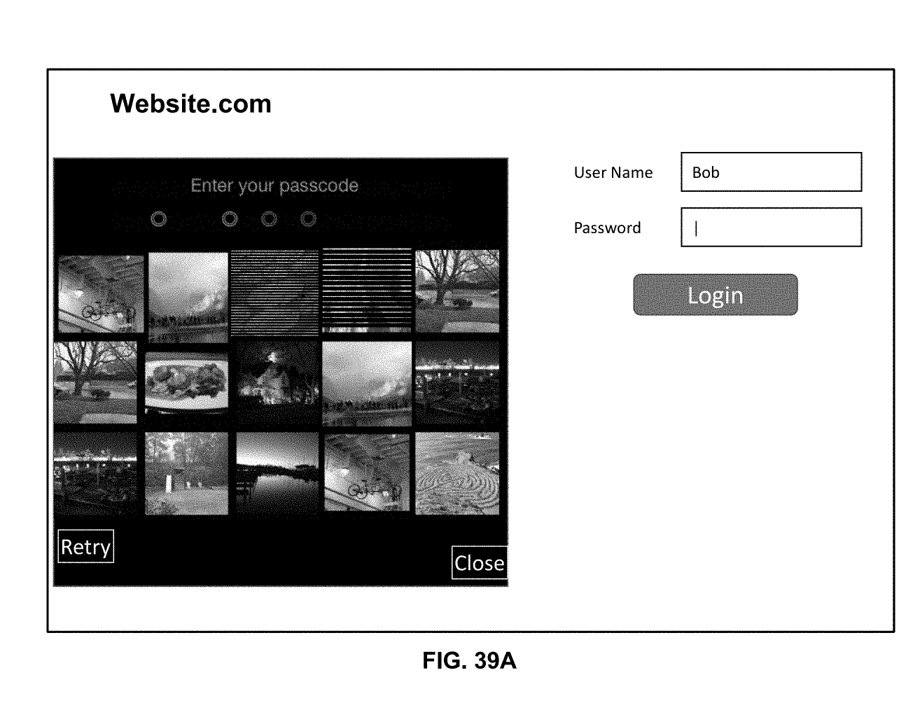

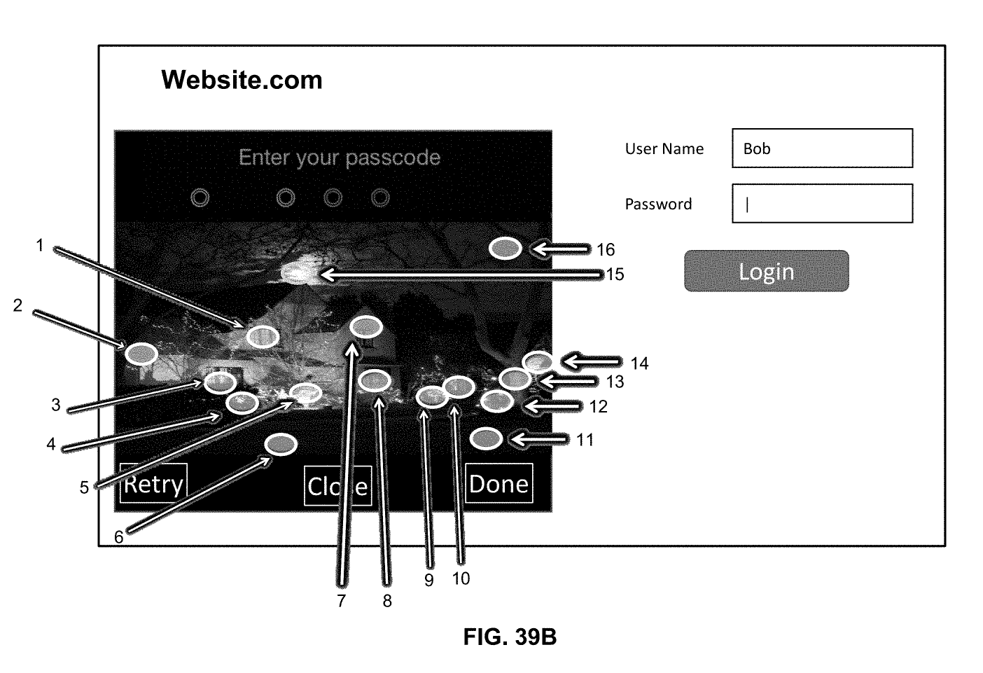

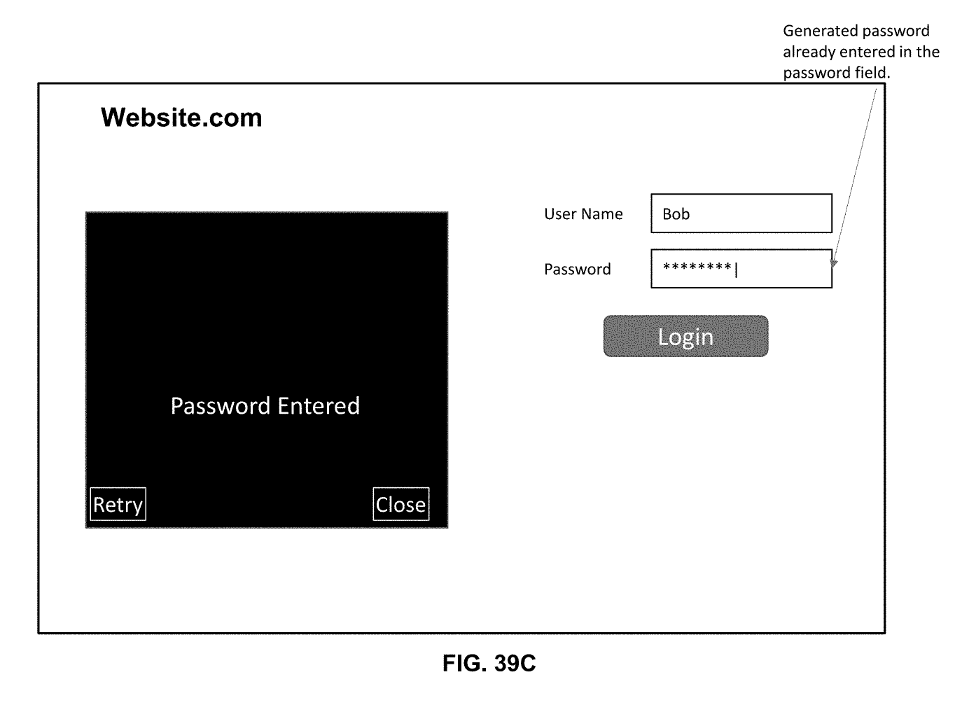

FIGS. 39A-C illustrate an example implementations of the virtual input method on a website according to various embodiments. FIG. 39A illustrates a first phase for the virtual input method that present the user with several images that include a previously registered image. The user may identify the previously registered image by clicking or touching the registered image. In response to the user selecting the image that matches the registered image, the user may be presented with the registered image and instructed to identify a series of hotspots the registered image

At FIG. 39B the user is presented a hotspot selection screen for the virtual input method. The interface can present the user with several hotspots for the selected image. In response to the user selecting the series of hotspots the registered image that match the registered series of hotspots, the visual access code process may authenticate the user to the device or service. For example, the user can click or touch four locations on the picture that correspond to the hotspot locations the user selected during the registration process. For example, the visual access process determines if the user selected locations satisfy the corresponding index numbers stored during the registration process. According to another example implementation, the visual access process determines if the user selected locations satisfy the two dimensional coordinate of a corresponding pixel in the photograph from the registration process.

In an example implementation, to satisfy the second phase of the visual access code process for authenticating the user, the series of hotspots on the registered image may be identified in the same order as the hotspots were selected during the registration process. In another example implementation, the series of hotspots on the registered image may be identified in the any order to satisfy the second phase of the visual access code process for authenticating the user. Since permutations of locations and visual cues are greatly increased over traditional alphanumerical combinations, the user first recalling the correct image and then identifying the series of hotspot locations on the correct image may be sufficient for authenticating the user.

In response to the user selecting the image that does not match the registered image, the user may be presented with a non-matching image and instructed to identify a series of hotspots the non-matching image. To authenticate the user, the visual access code process can provide or suppress feedback to the user regarding the first selection of an image from the plurality of images. Accordingly, an unauthorized user may not be notified whether the first selection of an image or second identification of the series of hotspots failed to satisfy the visual access code process. Repeated attempts indicating a guessing of different combinations of images from the group of images and hotspot locations may be then be detected as a brute force attack.

If the correct hotspots are selected, the virtual input method can proceed to FIG. 39C to present the user with a confirmation and populate an alphanumeric final password in the destination's login form

To create secure visual access codes for each user, the process can employ modified images that are unique for each user that appear visually indiscernible. In an embodiment, the process can include shifting center point of the original image to modify the coordinates of the hotspots and add a blended texture secure the image data

FIG. 40 illustrates an image blending process in accordance with various embodiments. Blending photos for each user provides different password for each user that are not detectable by simply looking observing a user's image selection. In an embodiment, the system combines a texture masking with an original photo via a blending algorithm creates a modified photo for generating secure visual access codes. An example phot blending algorithm can include:

```
Let resultingPhoto = copyPhoto(originalPhotoSize)
For each x in 0 to photoWidth
      For each y in 0 to photoHeight
            resultingPhotoPixelAt(x,y) = resultingPhotoPixelAt(x,y) +
setTransparencyTo(photoBlendingFilterPixelAt(x,y),20%)
      End
End
```

In an example embodiment, the system selects a blending algorithm and the photo filter bitmap based on data stored in the unique user hex digest. For example, the hex digest can include value to indicate a simple overlap blending algorithm for creating the modified photo. Multiple blending and password mapping algorithms improves security of the access code.

FIG. 41 illustrates an example implementation of hotspot position shifting in accordance with various embodiments. By shifting the center point of the original photo coordinates, the location values of the hotspots the image can be changed to generate different passwords for each user using the same visual image and maintaining the visual appearance of the image

An example hotspot shifting algorithm can include:

```
Input hotspotShiftingIndex
For each hotspot
      hotspot.x = (hotspot.x − 2) + (hotspotShiftingIndex remainder 5)
      hotspot.y = (hotspot.y − 2) + (hotspotShiftingIndex modulus 5)
End
```

For example, based on the unique user phrase provided by during the registration phase, the hex digest can provide a shift value for shifting the hotspot center and thereby differentiating the hotspot coordinates for the image for the user. For example, an original hotspot center with location coordinates 30, 50 when shifted based on a shift value of 9 in the unique user hex digest shifts the hotspot center to location coordinates 301, 49.

According to another example implementation, a multi-factor authentication system (MFA) supports a variety of password entry mechanisms (e.g., alphanumeric, visual, voice, etc.) that can be used to authenticate a user to access multiple application/website destinations. MFA includes a real-time password generator that creates unique and secure passwords independent of Internet connectivity for multiple different service providers (e.g., third party applications, cloud services, websites, etc. that include user authentication) without storing the passwords in local or network memory (e.g., a password vault).

MFA creates the unique and complex passwords, registers the passwords with a service provider and associates them with personalized recall tools accessible by the user. For example, the personalized recall tools can be based on the user's own private memories rather than traditional passwords and/or recovery questions that are generally susceptible to hacking from a user's publicly available or surreptitiously obtained information (e.g., social media, public records, etc.).

MFA is compatible and scalable for personal and enterprise systems (e.g., financial institutions, universities, health insurance institutions, hospitals, etc.) to reduce direct cost associated with password reset, as well as in-direct cost associated with legal and public relationship liabilities due to security breaches. MFA avoids traditional password problems such as recalling several unique passwords, synchronizing password vaults between devices, availability of cloud-based solutions, unchangeable biometrics passwords where leaks and overuse can be fatal.

According to an example aspect, MFA is an authentication mechanism on a user device that is decoupled from authentication modules of service providers (e.g., applications, websites, digital destinations, etc.). The multi-factor authorization system allows the user to create an identifier code and an access code based on personalized recall tools accessible by the user. The multi-factor authorization system uses the identifier code and the access code to generate a unique destinations key for each service provider. For example, the access code can be alphanumeric, pattern, and/or visual formats. The multi-factor authorization system can operate across user devices without a common repository (e.g., without a password vault) and without requiring an internet connection to access the unique destinations key for each service provider.

According to an implementation, the identifier code is securely stored once on each user device and the access code is provided by the user at time of authentication with each service provider (e.g., applications, websites, digital destinations, etc.). The same identifier code and access code is associated with multiple different unique destination keys. Each unique destination key is used to register with a different application/website destination. The application/website destination generally grants access by matching received destinations key at time of login to the destinations key registered to the user by the destination. Accordingly, the user on a device with the stored identifier code can login into multiple destinations by entering a single access code at each time of login and each destination receives a different destinations key.

The destinations key for an application/website destination is not stored on the user side (e.g., a user device, a password vault, a user's cloud storage, a hardware key, etc.) but is rather re-generated based on the multi-factor authorization system using the identifier code and the access code. That is, the destination keys are consistently generated based and the access code and the identifier code where the destinations keys are not stored on the user side.

The identifier code can be securely stored on the user devices. The identifier code can be subject to robust minimum requirements (e.g., length requirements, complexity testing, duplication detection, etc.) and created using a memorable piece of information (e.g., a favorite movie quote or a defining moment from their life) that the user can easily recall.

For example, the identifier can be an alphanumeric passphrase or sentence, a visual access code (e.g., selecting images or hotspots via a VAI), pattern, etc. The identifier code can be entered one time on a device and is protected from being displayed or transmitted off of the device. For example, the identifier code can be stored in a secure format (e.g., encryption, hashing, etc.) and use the device's security mechanism (e.g., secure hardware space, protected memory, read-only memory, write once read many secure storage, etc.).

The access code is provided to the device by the user each time a service provider requests a secure login. A single access code can be entered in a variety of formats (e.g., alphanumeric, visual, voice, etc.) for accessing multiple different service providers and is not transmitted off of the device.

In an example implementation, different user focused authentication mechanisms such as textual passwords, visual passwords, patterns, biometrics, user behavior, etc. receive the access code that is used with the identifier code to consistently generate the destination key. The access code can require robust security requirements (e.g., length requirements, complexity testing, duplication detection, etc.) and be efficient to enter into the device.

In an example implementation, the access code is at least one of an alphanumeric string, a visual access sequence, a safe lock, a pattern, a gesture, a hidden lock, a dice word, and the access code is further encrypted using biometric information (e.g., a fingerprint, face scan, retina scan, etc.). The biometric information is stored on the device to provide an additional layer of local security that enables quick authentication to re-generate the destination key, and the biometric information does not need to be transmitted to any external service or component. Subsequent login requests from the application or service can prompt the user to provide the biometric information to decrypt the access code for re-generating the destination key.

Further, the user can be asked the enter the access code from time to time (e.g., randomly, countdown clock, every x number of logins, etc.) to confirm the user remembers the access code. Additional subsequent login requests from the application or service can prompt the user to confirm the access code by entering the access code in addition to the biometric information.

Since the access code is entered more frequently than the identifier code, the access code can be configured to be more efficiently entered than the identifier code. For example, the access code can be an alphanumeric password, a visual access code (e.g., selecting images or hotspots via a VAI), pattern, etc. and should be different from the identifier code.

The destination key is provided to the service provider (e.g., via transmitting, populating a password in the destination's password form, etc.). For example, MFA can use robust heuristics to correctly identify login fields for websites, use accessibility APIs (e.g., Open YOLO protocol), etc.

As described above, a registration process (e.g., the registration process 3500) can generate the alphanumeric password using one-way cryptographic encoding and seeding the password with a destination identifier. The MFA process generates a destination key seeded with the application/website destination name, the identifier code, and the access code. Therefore, the user's system does not need to store the passwords for each site since the access code process consistently replicates generation of the password based on the user input.

Generating the destination key on a configured device does not require network connectivity or external resources. Accordingly to an alternative examples, configuring additional devices can be completed by completing a setup process with the identifier code and access code, an authenticated export mechanism from a configured device (e.g., a matrix barcode, near-field communication, etc.), or using networking transfer techniques as understood by one of ordinary skill in the art. Example implementations are configured to prohibit networked transfer of the identifier code and/or access code for the integrity of MFA.

An example MFA method includes storing, by a device, an identifier code from a user in secure storage of the device. In response to receiving a login request from an application or service, the user is prompted to provide an access code, and the device generates a destination key based on the identifier code and the access code. The destination key is registered with application or service to authenticate the user.

In response to receiving a subsequent login request from the application or service: the user is prompted to provide the access code, and MFA re-generates the same destination key for the application or service based on the stored identifier code and the received access code. The destination key can be consistently re-generated based on the stored identifier code and the access code for accessing the application or service.

Further, in response to receiving a login request from another application or service, the user is prompted to provide the same access code, and MFA generates a different destination key based on the identifier code and the access code. The different destination key is registered with the other application or service to authenticate the user, where the different destination key can be consistently re-generated based on the stored identifier code and the access code for accessing the other application or service.

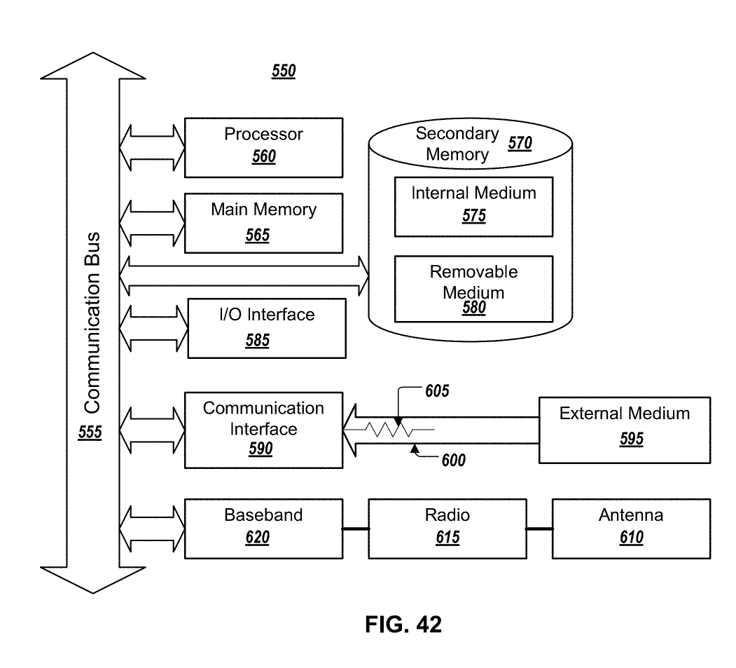

FIG. 42 is a block diagram illustrating wired or wireless system 550 according to various embodiments. Referring to FIGS. 1 and 21, the system 550 may be used to implement the media platform 120. In various embodiments, the system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, the secondary memory 570 may include other similar means for allowing computer programs or other data or instructions to be loaded into the system 550. Such means may include, for example, an external storage medium 595 and a communication interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are the removable medium 580 and a communication interface, which allow software and data to be transferred from an external storage medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g., printers, networks, information sources, etc.). For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. The electrical communication signals 605 are preferably provided to communication interface 590 via a communication channel 600. In one embodiment, the communication channel 600 may be a wired or wireless network, or any variety of other communication links. Communication channel 600 carries the electrical communication signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of the media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The processor 560 has access to one or more data storage areas including, for example, but not limited to, the main memory 565 and the secondary memory 570. The processor 560 is preferably configured to execute instructions (i.e., computer programs or software) that can be stored in the main memory 565 or in the secondary memory 570. Computer programs can also be received from the baseband processor 610 and stored in the main memory 565 or in the secondary memory 570, or executed upon receipt. Such computer programs, when executed, enable the system 550 to perform the various functions of the present invention as previously described. For example, the main memory 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

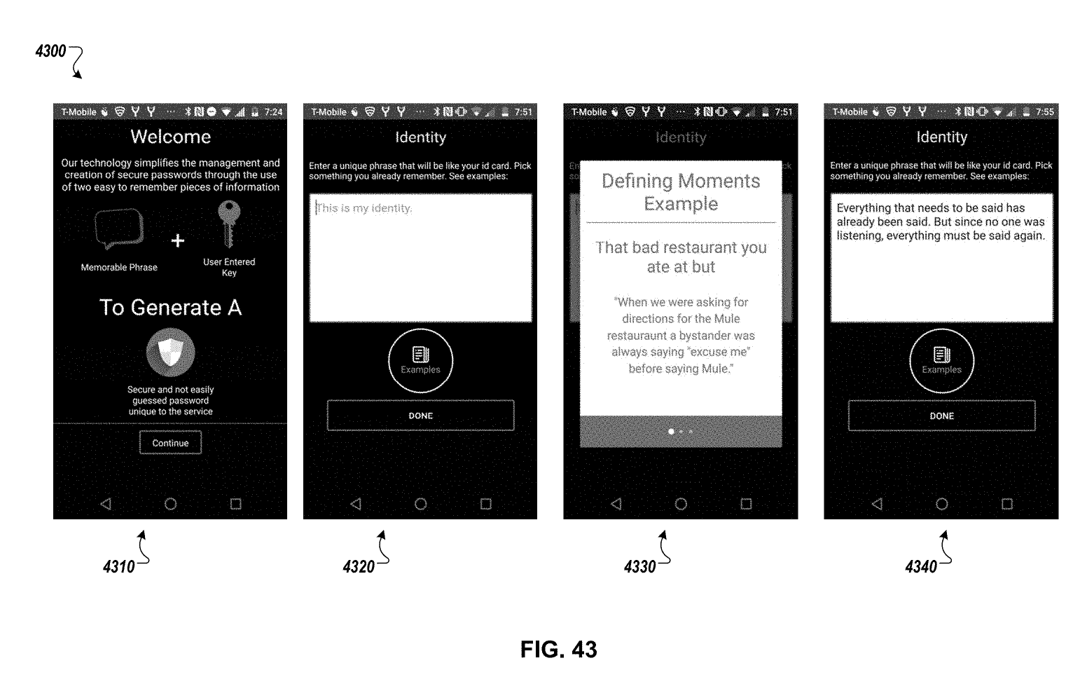

FIG. 43 illustrates example identity establishment process 4300 in accordance with various embodiments. A ghostPassword identity is established for a user to collectively interact with multiple username/password combinations across several server services or applications. The user can centrally manage username/password combinations with a single memorable identity using a defining moment. Interfaces 4310, 4320, 4330, and 4340 illustrate an example identity establishment process to set-up an identity. For example, an identity can be established by entering a unique phrase that is used as an identity card. The user can pick something easily remembered or memorable. The interface can provide examples of defining moments. For example a defining moment can be a bad restaurant. Where the user is prompts for something such as: “When we were asking for directions from the Mule restaurant a bystander was always saying excuse me before saying Mule.” Other memorable examples can include an event, a movie quote, a favorite spot, etc. It is stored in the secure area of the phone and protected by the hardware.

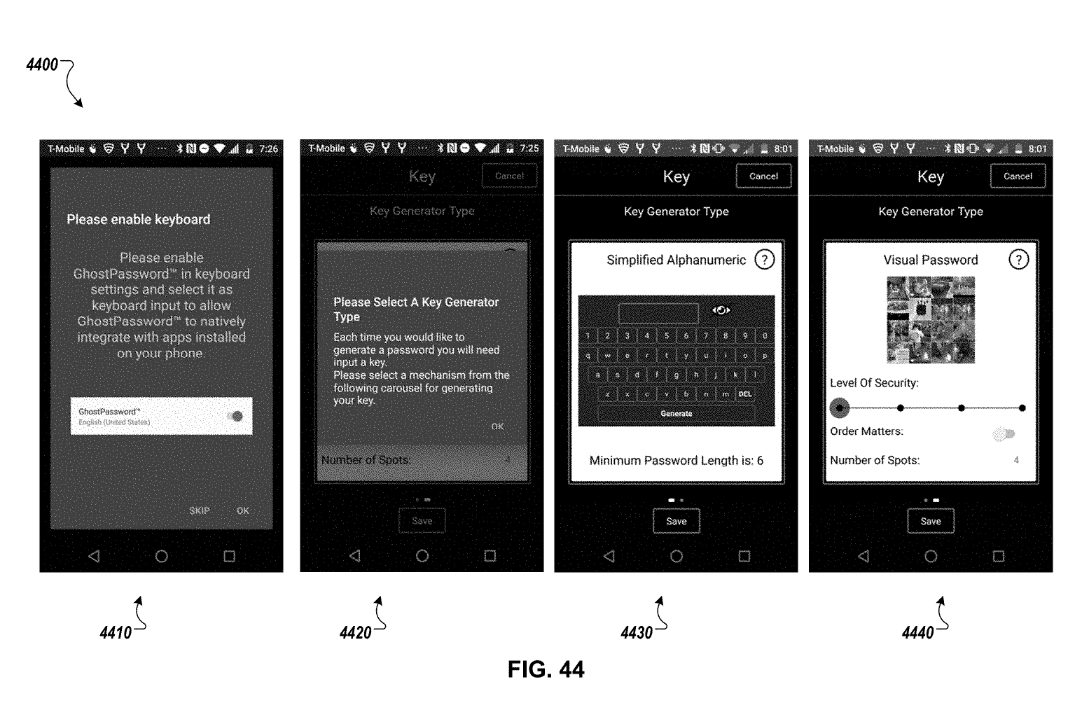

FIG. 44 illustrates example default key generator process in accordance with various embodiments. The password interface can include a keyboard add-on for generating ghostPasswords. For example, a key generator can include a keyboard for entering a master password that generates unique keys for each service or application. The key generator keyboard can be natively integrated with the applications installed on a phone. At 4420, a key generator type can be selected. Each time the user generates a password they will input a key. A variety of key entry mechanisms can be provided to the user to generate a key. At 4430, a key generator type such as simplified alphanumeric can be selected. At 4440, a key generator type for visual password can be selected.

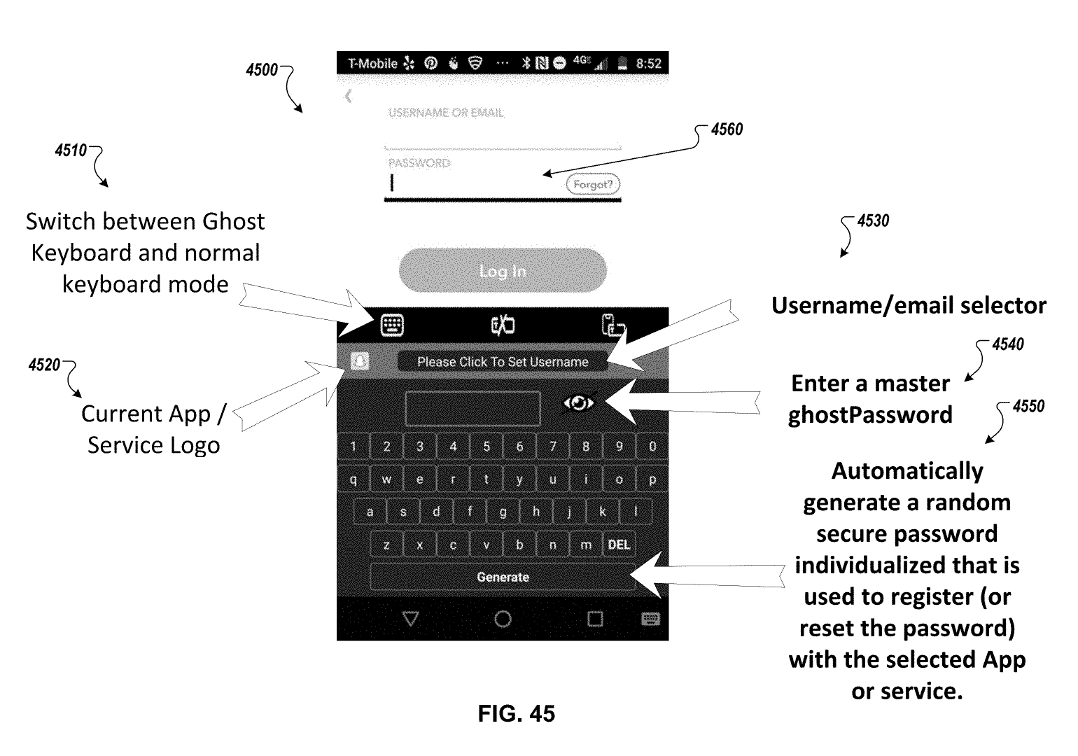

FIG. 45 illustrates example ghostPassword keyboard interface in accordance with various embodiments. At 4510, the user can switch between the ghost keyboard key generator and normal keyboard modes. At 4520, the ghost keyboard includes an icon to indicate the current app or service being used. At 4530, the user can enter or select a username used to login to the current application or service. At 4540, the user can enter a master ghostPassword associated with the identity level. At 4550, the ghost password key generator authenticates the master ghostPassword and determines the unique secure password individualized for the selected application or service. The unique secure password for the application is registered with the application and the ghost password keyboard consistently regenerates the secure password based on steps 4520, 4530, 4540 matching a previously registered secure password. At 4560, the generated secure password is populated in the password entry field for the selected application or service with the selected username. The key generator password keyboard allows the user to answer a master goes password to generate individualized secure passwords across multiple applications or services. Thus, the user does not need to memorize or recall each individualized secure password.

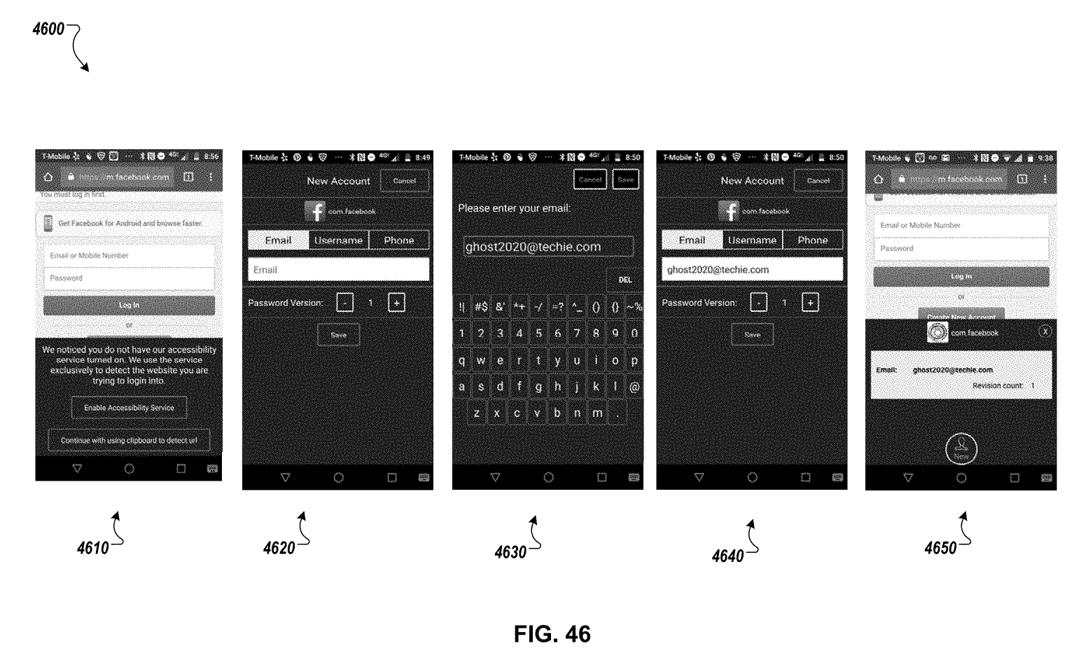

FIG. 46 illustrates example username entry process in accordance with various embodiments. In an example implementation, the user can establish and store the user name associated with a registered application or service. At 4610, the mobile device can automatically detect whether the accessibility service is activated on the device and prompt the user to enable the service or allow them to continue with using the clipboard to detect a URL. At 4620-4640, the user is able to enter their username, email address, or phone number with a password version integer. At 4650, an example interface presents the user with the previously stored user name, for example, the email address with the revision count.

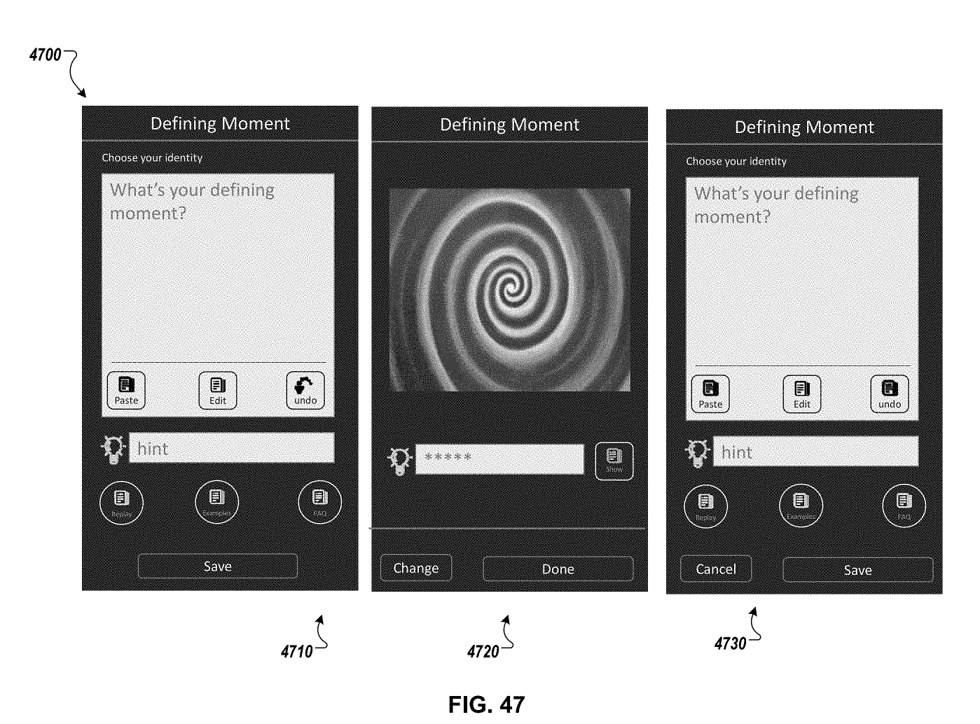

FIG. 47 illustrates example defining moments interface in accordance with various embodiments. Interfaces 4700, illustrate example defining moment entry modes. At 4710, the user can enter a defining moment with a hint. At 4720, the user can select a visual defining moment using hotspots.

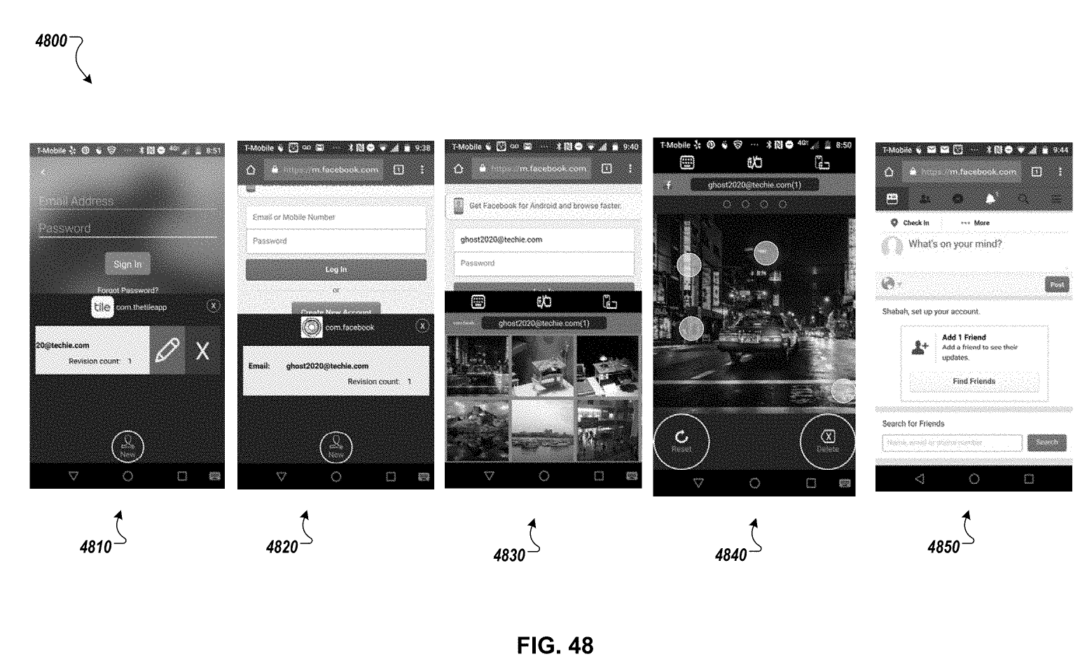

FIG. 48 illustrates example browser ghostPassword entry process in accordance with various embodiments. Process 4800 illustrates an example login process using the identity with a registered application in a browser mode. For example, the user can be presented with the user name at 4820. In response to selecting the user name, the user is presented with a first visual password screen at 4830. Using the visual password keyboard, the user selects a previously registered image out of a gallery, and at 4840 the user selects the previously registered hotspots from the proper image. Once the hotspots are properly selected, the ghostPassword generates the secure password associated with the application, populates the application login screen with the secure password information and username, and transmits the secure password and username to the application without the user entering the secure password. At 4850, the selected application authenticates the user and provides the user access to the application.

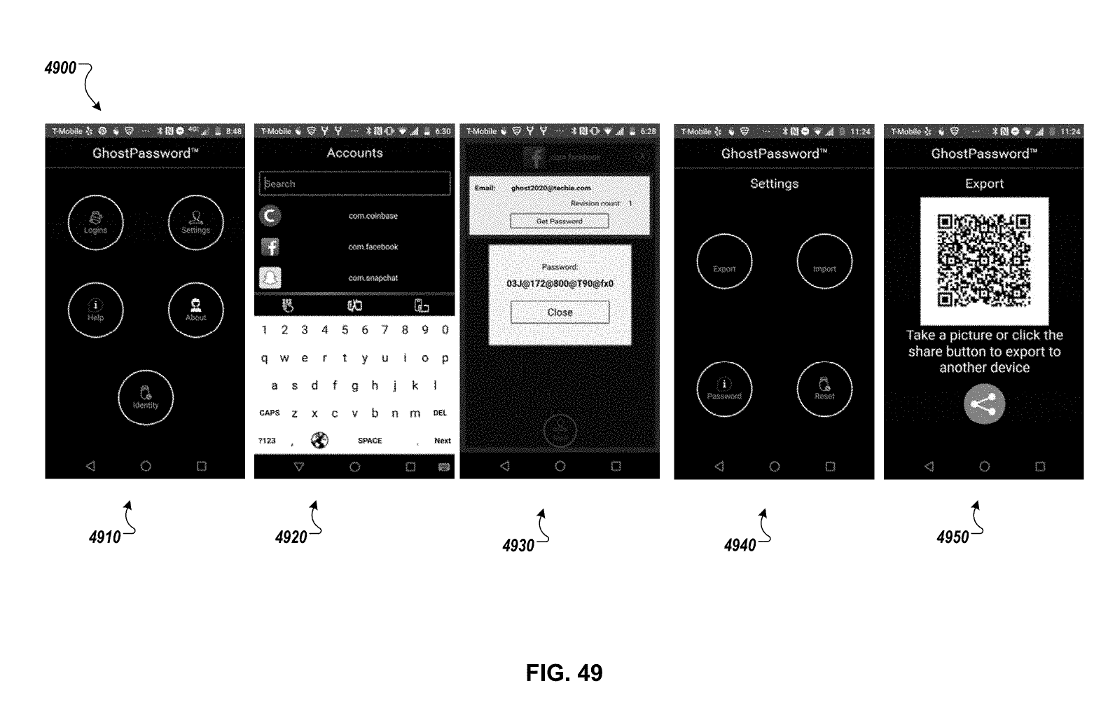

FIG. 49 illustrates example ghostPassword administration process in accordance with various embodiments. Process 4900 illustrates example administration screens for use with various embodiments. For example, interface 4910 can include logins, settings, help, about, or identity to allow the user to manage or update register secure passwords and application controls. At 4920, the user can select previously registered accounts. At 4930, the user can access the secure password associated with a particular application or service. At 4940, the user can change settings associated with the ghostPassword to, for example, export, import, change, or reset passwords. Interface 4950 illustrates an example export mode for exporting in identity and or secure password. The ghost password administration interface enables exporting via various communication means such as QR code, near field communication, sharing options, or other communication options.

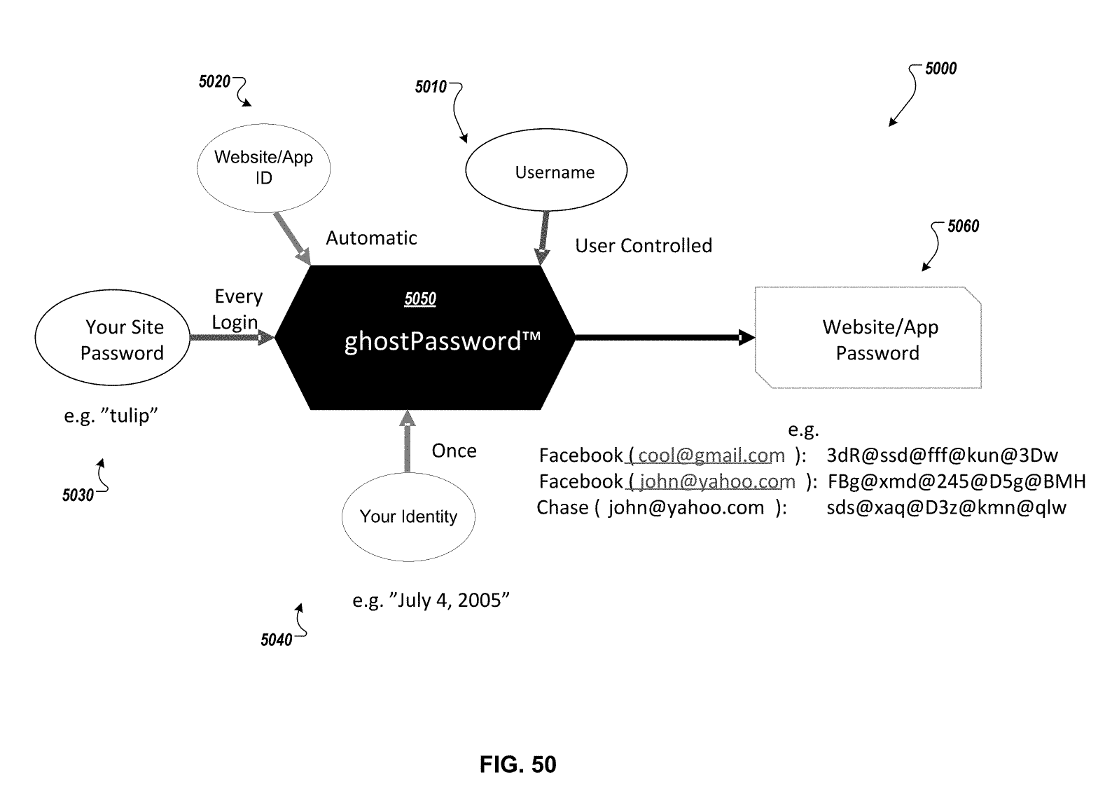

FIG. 50 illustrates example flow of the ghostPassword elements in accordance with various embodiments.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising:
storing, by a device, an identifier code from a user in secure storage of the device; in response to receiving a login request from an application or service:
prompting the user to provide an access code,
generating a destination key based on the identifier code and the access code, and
registering the destination key with application or service to authenticate the user;
in response to receiving a subsequent login request from the application or service:
prompting the user to provide the access code, and
re-generating the destination key based on the stored identifier code and the received access code.

2. The method of claim 1, wherein in response to receiving a login request from another application or service:
prompting the user to provide the access code,
generating another destination key based on the identifier code and the access code, and
registering the another destination key with the another application or service to authenticate the user;
wherein the another destination key is different from the destination key, and wherein the another destination key can be re-generated based on the stored identifier code and the access code.

3. The method of claim 1, wherein the identifier code is stored as a hashed file.

4. The method of claim 1, wherein the identifier code is not transmitted from the device.

5. The method of claim 1, wherein the identifier code is stored in write once read many secure storage of the device.

6. The method of claim 1, wherein the identifier code is stored as a hashed file.

7. The method of claim 1, wherein the access code is at least one of an alphanumeric code, a visual access code, a safe lock, a pattern, a gesture, a hidden lock, a dice word, a fingerprint, a retina scan, a face scan, or other biometric entry.

8. The method of claim 1, wherein the access code is at least one of an alphanumeric string, a visual access sequence, a safe lock, a pattern, a gesture, a hidden lock, a dice word, wherein the access code is further encrypted via biometric information, wherein the biometric information is stored on the device.

9. The method of claim 8, wherein the subsequent login request from the application or service prompts the user to provide the biometric information to decrypt the access code for re-generating the destination key.

10. The method of claim 9, wherein additional subsequent login requests from the application or service prompts the user to provide the access code by entering the access code in addition to the biometric information.

11. The method of claim 1, wherein the subsequent login request is detected by the device using heuristics.

12. A system for authenticating a user device comprising:
a memory;
a processor operatively coupled to the memory, wherein the processor is configured to:
in response to a login request for a user from a service provider, generate a destination key based on an identifier code and an access code, wherein the destination key is registered with the service provider for the user, wherein the identifier code is securely stored in the memory, wherein the user is prompted to enter the access code, and wherein a blending algorithm consistently re-creates the destination key for the service provider.
